(19) United States
(12) Patent Application Publication
(10) Pub. No.: US 2017/0230843 A1
(43) Pub. Date: Aug. 10, 2017

(54) TERMINAL APPARATUS, BASE STATION APPARATUS, AND METHOD

(71) Applicant: SHARP KABUSHIKI KAISHA, Sakai City, Osaka (JP)

(72) Inventors: Wataru OUCHI, Sakai City, Osaka (JP); Kazuyuki SHIMEZAWA, Sakai City, Osaka (JP); Toshizo NOGAMI, Sakai City, Osaka (JP); Kimihiko IMAMURA, Sakai City, Osaka (JP); Naoki KUSASHIMA, Sakai City, Osaka (JP); Alvaro RUIZ DELGADO, Sakai City, Osaka (JP); Takashi HAYASHI, Sakai City, Osaka (JP)

(73) Assignee: Sharp Kabushiki Kaisha, Sakai City, Osaka (JP)

(21) Appl. No.: 15/502,051

(22) PCT Filed: Aug. 3, 2015
(86) PCT No.: PCT/JP2015/071935

§ 371 Date: Feb. 6, 2017

(30) Foreign Application Priority Data
Aug. 8, 2014 (JP) 2014-162235

(51) Int. Cl. H04W 16/32; H04W 72/04; H04L 5/00; H04W 92/20; H04W 8/24; H04B 7/06; H04W 88/02; H04W 88/08; H04W 52/30; H04W 74/08

(52) U.S. Cl. CPC H04W 16/32; H04W 52/30; H04W 72/04; H04L 5/0048; H04W 74/08; H04W 8/24; H04B 7/0626; H04B 7/063; H04W 88/02; H04W 88/08; H04W 92/20

(57) ABSTRACT

Provided is a terminal apparatus that communicates with a base station apparatus, including: a control unit that determines a transmit power that is available for application in a first Cell Group (CG), by performing comparison with a first upper limit value and based on the smaller of the transmit power and the first upper limit value, in a case where transmission in a subframe i₁ in the first CG overlaps transmission in subframes i₂−1 and i₂ in a second CG, in which the first upper limit value includes a maximum output power among at least subframes that overlap.

### TECHNICAL FIELD

Embodiments of the present invention relate to a technology that is concerned with a terminal apparatus, a base station apparatus, and a method, in all of which efficient transmit power control and transmission control are realized.

This application claims the benefit of Japanese Priority Patent Application No. 2014-162235 filed on Aug. 8, 2014, the entire contents of which are incorporated herein by reference.

### BACKGROUND ART

In 3rd Generation Partnership Project (3GPP) that is a standardization project, a standardization process for Evolved Universal Terrestrial Radio Access (which is hereinafter referred to as EUTRA) that realizes high-speed communication has been performed by employing flexible scheduling in prescribed frequency and time units, which is referred to as an Orthogonal Frequency-Division Multiplexing (OFDM) communication scheme or a resource block.

Furthermore, in 3GPP, discussion on Advanced EUTRA that realizes higher-speed data transfer and has upper compatibility with EUTRA have taken place. In EUTRA, a communication system is available on the assumption of a network in which base station apparatuses have almost the same cell constitution (cell size). However, in Advanced EUTRA, a study on the communication system has been conducted on the assumption of a network (heterogeneous wireless network or Heterogeneous Network) in which the base station apparatuses (the cells) having different constitutions are present in a mixed manner in the same area.

A study has been conducted on a dual connectivity technology in which, like in the heterogeneous network, in the communication system in which a cell (macro cell) having a large radius and a cell (small cell) having a smaller radius than the macro cell are arranged, a terminal apparatus makes a connection to the macro cell and the small cell at the same time and thus performs communication (NPL 1).

In NPL 1, a study has been conducted on a network in which, when the terminal apparatus is assumed to make an attempt to realize the dual connectivity between the cell (the macro cell) having a large radius (cell size) and the cell (the small cell (or a pico cell)) having a small radius, low speed is caused and delay occurs in a backbone (backhaul) line between the macro cell and the small cell. That is, there is a likelihood of delay in giving and taking control information or user information between the macro cell and the small cell will make it difficult or hard to realize a function that can be realized in the related art.

Furthermore, in NPL 2, a method is disclosed in which, when the terminal apparatus makes connections at the same time to multiple cells that are connected to one another with high-speed backhaul, channel state information in a cell is fed back.

### CITATION LIST

### Non-Patent Literature

NPL 1: R2-130444, NTT DOCOMO, 3GPP TSG RAN2#81, Jan. 28th-Feb. 1, 2013
NPL 2: 3rd Generation Partnership Project; Technical Specification Group Radio Access Network; Evolved Universal Terrestrial Radio Access (E-UTRA); Physical layer procedures (Release 10), February 2013, 3GPP TS 36.213 V11.2.0 (2013-2).

### DISCLOSURE OF THE INVENTION

### Problems to be Solved by the Invention

However, in a case where sharing of information among cells is limited, a transmit power control method and a transmission control method in the related art, as they are, is difficult to use.

An object of the invention, which is made in view of the problems described above is to provide a terminal apparatus, a base station apparatus, and a method, in all of which transmit power control and transmission control can be efficiently performed.

### Means for Solving the Problems

(1) In order to accomplish the object described above, the present invention is contrived to provide the following means. That is, according to an aspect of the present invention, there is a terminal apparatus that communicates with a base station apparatus, including a control unit that determines a transmit power that is available for application in a first Cell Group (CG), by performing comparison with a first upper limit value and based on the smaller of the transmit power and the first upper limit value, in a case where transmission in a subframe i₁ in the first CG overlaps transmission in subframes i₂−1 and i₂ in a second CG, in which the first upper limit value includes a maximum output power among at least subframes that overlap.

(2) Furthermore, according to an aspect of the present invention, there is provided a method in a terminal apparatus that communicates with a base station apparatus, including a step of determining a transmit power that is available for application in a first Cell Group (CG), by performing comparison with a first upper limit value and based on the smaller of the transmit power and the first upper limit value, in a case where transmission in the subframe i₁ in the first CG overlaps transmission in subframes i₂−1 and i₂ in a second CG, in which the first upper limit value includes a maximum output power among at least subframes that overlap.

(3) According to an aspect of the present invention, there is provided a base station apparatus that communicates with a terminal apparatus, including a transmission unit that transmits a configuration of a second Cell Group (CG) using a higher layer signal, in which the configuration includes a parameter relating to a maximum output power for the second CG.

(4) According to an aspect of the present invention, there is provided a method in a base station apparatus that communicates with a terminal apparatus, including a step of transmitting a configuration of a second Cell Group (CG) using a higher layer signal, in which the configuration includes a parameter relating to a maximum output power for the second CG.

### Effects of the Invention

According to the present invention, in a wireless communication system in which a base station apparatus and a terminal apparatus communicate with each other, transfer efficiency can be improved.

### BRIEF DESCRIPTION OF THE DRAWINGS

FIG. 1 is a diagram illustrating an example of a constitution of a downlink radio frame according to a first embodiment.

FIG. 2 is a diagram illustrating an example of a constitution of an uplink radio frame according to the first embodiment.

FIG. 3 is a diagram illustrating a basic architecture of dual connectivity according to the first embodiment.

FIG. 4 is a diagram illustrating the basic architecture of the dual connectivity according to the first embodiment.

FIG. 5 is a diagram illustrating an example of a block constitution of a base station apparatus according to the first embodiment.

FIG. 6 is a diagram illustrating an example of a block constitution of a terminal apparatus according to the first embodiment.

FIG. 7 is a diagram illustrating an example of a connectivity group according to the first embodiment.

FIG. 8 is a diagram illustrating an example of generation and report of CSI in the connectivity group according to the first embodiment.

FIG. 9 is a diagram illustrating an example of a periodic CSI report according to the first embodiment.

FIG. 10 is a diagram illustrating an example of a subframe for uplink transmission in the dual connectivity.

FIG. 11 is a diagram illustrating an example of a block constitution of a base station apparatus according to a second embodiment.

FIG. 12 is a diagram illustrating an example of a block constitution of a terminal apparatus according to the second embodiment.

### MODE FOR CARRYING OUT THE INVENTION

### First Embodiment

A first embodiment of the present invention will be described below. A base station apparatus (a base station, a NodeB, or an eNodeB (eNB)) and a terminal apparatus (a terminal, a mobile station, a user apparatus, or a user equipment (UE)) are described referring to a communication system (a cellular system) that performs communication in a cell.

Main physical channels and physical signals that are used in EUTRA and Advanced EUTRA are described. A channel means a medium that is used for signal transmission, and a physical channel means a physical medium that is used for the signal transmission. According to the present invention, the physical channel and the signal can be used synonymously. There is a likelihood that in EUTRA and Advanced EUTRA, the physical channel will be added in future or an architecture or format type thereof will be changed or added, but this change or addition does not have any influence on a description of the present embodiment.

In EUTRA and Advanced EUTRA, scheduling of the physical channel or the physical signal is managed using a radio frame. 1 radio frame is 10 ms, and 1 radio frame is constituted from 10 subframes. In addition, one subframe is constituted from two slots (that is, one subframe is 1 ms and one slot is 0.5 ms). Furthermore, management is performed using a resource block as a minimum unit for scheduling for allocating the physical channel. The resource block is stipulated with a fixed frequency domain that is constituted from a set of multiple subcarriers (for example, 12 subcarriers) along a frequency axis, and a domain that is constituted from a fixed transmission time interval (one slot).

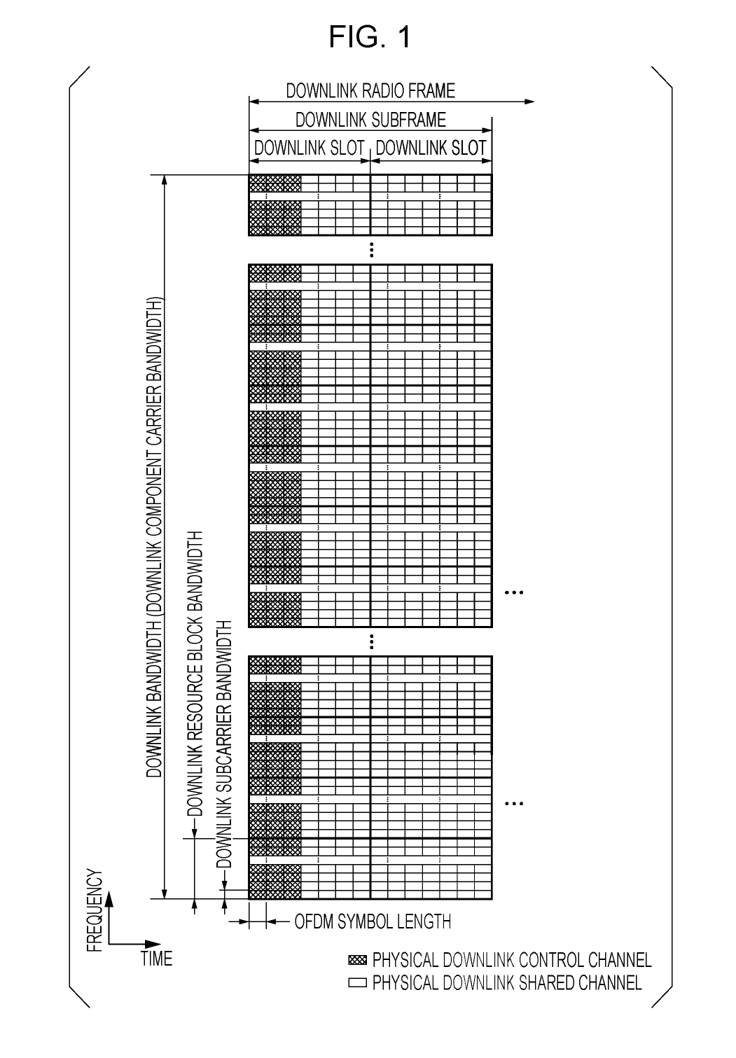

FIG. 1 is a diagram illustrating an example of a constitution of a downlink radio frame according to the present embodiment. In a downlink, an OFDM access scheme is used. In the downlink, a PDCCH, an EPDCCH, a Physical Downlink Shared CHannel (PDSCH), and the like are allocated. The downlink radio frame is constituted from a downlink Resource Block (RB) pair. The downlink RB pair is a unit of allocation or the like of a downlink radio resource and is made from a frequency band (RB bandwidth) with a predetermined width and a time span (2 slots=1 subframe). One downlink RB pair is configured from 2 downlink RBs (RB bandwidth×slot) that are contiguous in a time domain. One downlink RB is constituted from 12 subcarriers in the frequency domain. Furthermore, in the time domain, in a case where a normal cyclic prefix is attached, one downlink RB is constituted from seven OFDM symbols, and, in a case where a cyclic prefix that is longer than usual is attached, is constituted from six OFDM symbols. A domain that is stipulated with one subcarrier in the frequency domain and one OFDM symbol in the time domain is referred to as a Resource Element (RE). The Physical Downlink Control Channel is a physical channel on which downlink control information is transmitted such as a terminal apparatus identifier, scheduling information of the Physical Downlink Shared Channel, scheduling information of a Physical Uplink Shared Channel, a modulation scheme, a coding rate, or a retransmission parameter. Moreover, at this point, a downlink subframe is imposed on one Component Carrier (CC). However, a downlink subframe is stipulated for every CC and the downlink subframe is mostly synchronized between CCs.

Moreover, although not illustrated here, Synchronization Signals, a Physical Broadcast Channel, or a downlink reference signal (Reference Signal (RS)) may be allocated to the downlink subframe. As downlink reference signals, there are a cell-specific reference signal (Cell-specific RS (CRS)) that is transmitted at the same transmission port as the PDCCH, a channel state information reference signal (CSI-RS) that is used for measurement of Channel State Information (CSI), a terminal-specific reference signal (UE-specific RS (URS)) that is transmitted at the same port as one portion of the PDSCH, a demodulation reference signal (Demodulation RS (DMRS)) that is transmitted at the same transmission port as the EPDCCH, and the like. Furthermore, a carrier to which the CRS is not mapped may be satisfactory. At this time, a signal (which is referred to as an extended synchronization signal) that is the same as a signal that corresponds to one or several transmission ports (for example, only a transmission port 0) or all transmission ports for the CRS can be inserted, as a signal for tracking a time and/or a frequency, into one or several subframes (for example, first and sixth subframes of a radio frame).

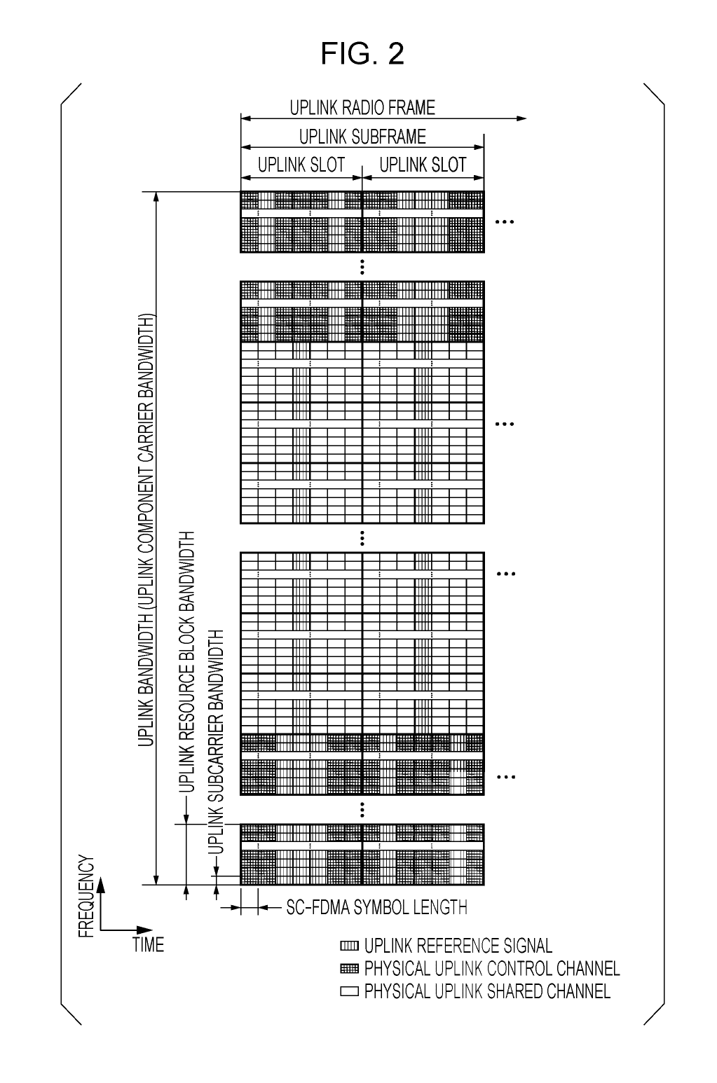

FIG. 2 is a diagram illustrating an example of a constitution of an uplink radio frame according to the present embodiment. In an uplink, an SC-FDMA scheme is used. In the uplink, the Physical Uplink Shared Channel (PUSCH), a PUCCH, and the like are assigned. Furthermore, an Uplink Reference Signal is allocated to a portion of the PUSCH or of the PUCCH. The uplink radio frame is constituted from an uplink RB pair. The uplink RB pair is a unit for assignment or the like of an uplink radio resource and is constructed from a frequency band (an RB bandwidth), which has a width that is determined in advance, and a time span (two slots=one subframe). One uplink RB pair is constituted from two uplink RBs (RB bandwidth×slot) that is continuous in the time domain. One uplink RB is constituted from 12 subcarriers in the frequency domain. In the time domain, in a case where a normal cyclic prefix is attached, one uplink RB is constituted from 7 SC-FDMA symbols, and in a case where a cyclic prefix that is longer than usual, one uplink RB is configured from 6 SC-FDMA symbols. Moreover, at this point, an uplink subframe is imposed on one CC, but the uplink subframe is stipulated for every CC.

The synchronization signal is constituted from 3 types of primary synchronization signals and a secondary synchronization signal that is constituted from 31 types of codes which are alternately arranged in the frequency domain. With a combination of these signals, the primary synchronization signal and the secondary synchronization signal, 504 cell identifiers (Physical Cell Identity (Physical Cell ID) (PCI)) for identifying a base station apparatus and a frame timing for wireless synchronization are indicated. A terminal apparatus specifies a physical cell ID of the synchronization signal that is received through cell search.

The Physical Broadcast Channel (PBCH) is transmitted for the purpose of notifying (configuring) a control parameter (broadcast information (system information)) that is used in a shared manner in terminal apparatuses within a cell. A radio resource with which broadcast information is transmitted on the Physical Downlink Control Channel is notified to the terminal apparatus within the cell, and for the broadcast information that is not notified on the Physical Broadcast Channel, in the notified radio resource, a layer 3 message (the system information) that notifies the broadcast information on the Physical Downlink Shared Channel is transmitted.

As pieces of broadcast information, a Cell Global Identifier (CGI) indicating a cell-specific identifier, a Tracking Area Identifier (TAI) for managing a waiting area by paging, random access configuration information, transmission timing adjustment information (a transmission timing or the like), shared radio resource configuration information in the cell, neighboring cell information, uplink access limitation information, and the like are notified.

Downlink reference signals are categorized by their usage into multiple types. For example, the cell-specific RS (Cell-specific reference signals) is a pilot signal that is transmitted with a prescribed power for every cell, and is a downlink reference signal that is periodically iterated in the frequency domain and the time domain based on a prescribed rule. The terminal apparatus measures reception quality for every cell by receiving the cell-specific RS. Furthermore, the terminal apparatus uses the cell-specific RS also as a reference signal for demodulation of the Physical Downlink Control Channel that is transmitted at the same time as the cell-specific RS, or of the Physical Downlink Shared Channel. As a sequence that is used for the cell-specific RS, a sequence that is identifiable for every cell is used.

Furthermore, the downlink reference signal is used also for estimation of propagation fluctuation in the downlink. The downlink reference signal that is used for the estimation of the propagation fluctuation is referred to as Channel State Information Reference Signals (CSI-RS). Furthermore, the downlink reference signal that is configured, in a dedicated manner, for the terminal apparatus is referred to as the UE-specific Reference Signals (URS), the Demodulation Reference Signal (DMRS), or a Dedicated RS (DRS), and is referred to for channel compensation processing of a channel, which is to be performed when demodulating the Enhanced Physical Downlink Control Channel or the Physical Downlink Shared Channel.

The Physical Downlink Control Channel (PDCCH) is transmitted in several OFDM symbols (for example, 1 to 4 OFDM symbols) starting from the head of each subframe. The Enhanced Physical Downlink Control Channel (EPDCCH) is the Physical Downlink Control Channel that is allocated to the OFDM symbols to which the Physical Downlink Shared Channel (PDSCH) is allocated. The PDCCH or the EPDCCH is used for the purpose of notifying radio resource allocation information in accordance with the scheduling of the terminal apparatus by the base station apparatus, or information indicating an amount of adjustment for an increase or decrease in transmit power. Unless otherwise specified, the Physical Downlink Control Channel (PDCCH) that will be described simply below means both of the physical channels, the PDCCH and the EPDCCH.

The terminal apparatus monitors the Physical Downlink Control Channel that is destined for the terminal apparatus itself before transmitting and receiving a layer 2 message and the layer 3 message (paging, a handover command, or the like) that are downlink data or higher layer control information, and receives the Physical Downlink Control Channel that is destined for the terminal apparatus itself. Thus, the terminal apparatus needs to acquire from the Physical Downlink Control Channel the radio resource allocation information that is referred to as an uplink grant at the time of the transmission and as a downlink grant (downlink assignment) at the time of the reception. Moreover, it is also possible that, in addition to being transmitted in the OFDM symbol described above, the Physical Downlink Control Channel is constituted to be transmitted in a region of a resource block that is allocated in a dedicated manner from the base station apparatus to the terminal apparatus.

The Physical Uplink Control Channel (PUCCH) is used for an acknowledgement response (Hybrid Automatic Repeat reQuest-Acknowledgement (HARQ-ACK) or Acknowledgement/Negative Acknowledgement (ACK/NACK)) for reception of the downlink data that is transmitted on the Physical Downlink Shared Channel, for downlink channel (channel state) information (Channel State Information (CSI)), or for making an uplink radio resource allocation request (a radio resource request or a Scheduling Request (SR)).

Pieces of CSI includes a reception quality indicator (a Channel Quality Indicator (CQI)), a Precoding Matrix Indicator (PMI), a Precoding Type Indicator (PTI), and a Rank indicator (RI), which can be used for designating (expressing) a suitable modulation scheme and coding rate, a suitable precoding matrix, a type of suitable PMI, and a suitable rank, respectively. Each indicator may be expressed as indication. Furthermore, CQIs and PMIs are categorized into wideband CQIs and PMIs on the presumption of the transmission that uses all resources within one cell, and subband CQIs and PMIs on the assumption of the transmission that uses some contiguous resource blocks (subbands) within one cell. Furthermore, when it comes to the PMI, a PMI of type that expresses one suitable precoding matrix using two types of PMIs, that is, a first PMI and a second PMI, as well as a PMI of normal type that expresses one suitable precoding matrix using one PMI, is present.

The Physical Downlink Shared Channel (PDSCH) is used also for notifying the terminal apparatus of the broadcast information (the system information) that is not notified by the paging or on the physical broadcast channel, as the layer 3 message, in addition to the downlink data. The radio resource allocation information of the Physical Downlink Shared Channel is indicated with the Physical Downlink Control Channel. The Physical Downlink Shared Channel is transmitted in a state of being allocated to OFDM symbols other than the OFDM symbols in which the Physical Downlink Control Channel is transmitted. That is, the Physical Downlink Shared Channel and the Physical Downlink Control Channel are time-multiplexed within one subframe.

It is also possible that uplink data and uplink control information are mainly transmitted on the Physical Uplink Shared Channel (PUSCH), and that the PUSCH includes uplink control information, such as the CSI or the ACK/NACK. Furthermore, the PUSCH is used also for the terminal apparatus to notify the base station apparatus of the layer 2 message and the layer 3 message that are the higher layer control information, in addition to the uplink data. Furthermore, as is the case in the downlink, the radio resource allocation information of the Physical Uplink Shared Channel is indicated with the Physical Downlink Control Channel.

Included in the Uplink Reference Signal (which is also referred to as an uplink pilot signal, or an uplink pilot channel) are the Demodulation Reference Signal (DMRS) that is used for the base station apparatus to demodulate the Physical Uplink Control Channel (PUCCH) and/or the Physical Uplink Shared Channel (PUSCH) and a Sounding Reference Signal (SRS) that is used for the base station apparatus mainly to mainly estimate an uplink channel state. Furthermore, as Sounding Reference Signals, there are a periodic Sounding Reference Signal (Periodic SRS) that is periodically transmitted and an aperiodic Sounding Reference Signal (Aperiodic SRS) that is transmitted when there is an instruction to transmit the Aperiodic SRS from the base station apparatus.

A Physical Random Access Channel (PRACH) is a channel that is used for notifying (configuring) a preamble sequence, and has a guard time. The preamble sequence is constituted in such a manner that information is notified to the base station apparatus with multiple sequences. For example, in a case where 64 types of sequences are prepared, 6-bit information can be indicated to the base station apparatus. The Physical Random Access Channel is used as means by which the terminal apparatus has access to the base station apparatus.

The terminal apparatus uses the Physical Random Access Channel in order to make the radio resource request in the uplink when the Physical Uplink Control Channel is not configured for the SR, to make a request to the base station apparatus for transmission timing adjustment information (which is also referred to as a Timing Advance (TA) command) indispensable for adjusting an uplink transmission timing to a reception timing window of the base station apparatus, or so on. Furthermore, the base station apparatus can also make a request to the terminal apparatus for starting of a random access procedure using the Physical Downlink Control Channel.

The layer 3 message is a message that is handled with a protocol of a control plane (CP) (Control-plane (C-Plane)) that is exchanged in radio resource control (RRC) layers of the terminal apparatus and the base station apparatus. RRC signaling or an RRC message can be used synonymously. Moreover, in contrast with the control plane, a protocol that is used to handle user data (the uplink data and the downlink data) is referred to as a user plane (UP) (User-plane (U-Plane)). At this point, a transport block that is transmission data in a physical layer includes a C-plane message and U-plane data in a higher layer. Moreover, detailed descriptions of other physical channels are omitted.

A range (a communication area) in which each frequency is available for communication, which is controlled by the base station apparatus, is regarded as a cell. At this time, the communication area that is covered by the base station apparatus may vary in size and shape from one frequency to another. Furthermore, the area that is covered may vary from one frequency to another. When cells that are covered by different types of base station apparatuses or that have different radii are present in a mixed manner in an area where the same frequencies and/or different frequencies are available and one communication system is formed, this wireless network is referred to as a heterogeneous network.

The terminal apparatus regards the inside of the cell as the communication area, and as such operates. When the terminal apparatus moves from a certain cell to a different cell, the terminal apparatus moves to a separate suitable cell according to a cell re-selection procedure at the time of a non-wireless connection (during non-communication) and according to a handover procedure at the time of a wireless connection (during communication). The suitable cell refers to a cell in which it is determined that, generally, the access by the terminal apparatus is not disallowed based on information that is designated from the base station apparatus, and in which downlink reception quality satisfies a prescribed condition.

Furthermore, a technology in which frequencies (component carriers or frequency bands) in multiple different frequency bands are aggregated by carrier aggregation and are handled as if they were one frequency (frequency band) may apply to the terminal apparatus and the base station apparatus. As component carriers, there are an uplink component carrier that corresponds to the uplink and a downlink component carrier that corresponds to the downlink. In the present specification, the frequency and the frequency band can be used synonymously.

For example, in a case where, with the carrier aggregation, component carriers in a frequency bandwidth of 20 MHz are aggregated into 5 component carriers, the terminal apparatus that has the capability to enable the carrier aggregation performs transmission and reception with the 5 component carriers being regarded as a frequency bandwidth of 100 MHz. Moreover, although the component carries to be aggregated are contiguous frequencies, some or all of the component carriers may be non-contiguous frequencies. For example, in a case where available frequency bands are an 800 MHz band, a 2 GHz band, and a 3.5 GHz band, one component carrier may be transmitted in the 800 MHz band, another component in the 2 GHz band, and a third component in the 3.5 GHz band.

Furthermore, it is also possible that multiple component carriers in the same frequency band that are contiguous or non-contiguous are aggregated. A frequency bandwidth of each component carrier may be a frequency bandwidth (for example, 5 MHz or 10 MHz) narrower than a frequency bandwidth (for example, 20 MHz) in which the terminal apparatus is capable of performing reception, and the frequency bandwidths to be aggregated may be different from each other. It is desirable that the frequency bandwidth is equal to any one of the frequency bandwidths in a cell in the related art, considering backward compatibility, but although the frequency bandwidth is a frequency bandwidth that is different from the frequency band in the cell in the related art, this does not pose a problem.

Furthermore, component carriers (career types) may be aggregated that do not have the backward compatibility. Moreover, it is desirable that the number of uplink component carriers that are allocated to (configured for or added to) the terminal apparatus by the base station apparatus be equal to or smaller than the number of downlink component carriers.

A cell that is constituted from an uplink component carrier on which configuration of an uplink control channel for the radio resource request is performed, and a downlink component carrier that is connected, in a cell-specific manner, to the uplink component carrier is referred to a primary cell (PCell). Furthermore, a cell that is constituted from component carriers other than those from which the primary cell is constituted is referred to as a secondary cell (SCell). The terminal apparatus may perform reception of a paging message, detection of update of the broadcast information, an initial access procedure, configuration of security information, and the like, in the primary cell, and on the other hand, may not perform these operations in the secondary cell.

The primary cell is other than a target for control of activation and deactivation (more precisely, the primary cell is regarded as being necessarily activated). In contrast, the secondary cell retains a state of being activated and a state of being deactivated. A change of these states is explicitly designated from the base station apparatus, but the state is changed based on a timer that is configured for the terminal apparatus for every component carrier. The primary cell and the secondary cell are collectively referred to as a serving cell.

Moreover, the carrier aggregation is for communication in multiple cells that use multiple component carriers (frequency bands), and is also referred to as cell aggregation. Moreover, the terminal apparatus may be wirelessly connected to the base station apparatus through a relay station apparatus (or a repeater) at every frequency. That is, the base station apparatus according to the present embodiment can also be replaced with the relay station apparatus.

The base station apparatus manages a certain cell that is an area where it is possible that the terminal apparatus communicates with the base station apparatus itself, from one frequency to another. One base station apparatus may manage multiple cells. Cells are categorized into multiple types according to the size (cell size) of an area where communication with the terminal apparatus is possible. For example, cells are categorized into macro cells and small cells. Additionally, the small cells are categorized into femto cells, pico cells, and nano cells according to their coverage areas. Furthermore, when it is possible that the terminal apparatus communicates with a certain base station apparatus, among cells that are covered by the certain base station apparatus, a cell that is configured in such a manner that the cell is used for communication with the terminal apparatus is referred to as a serving cell, and the other cells that are not used for the communication are referred to as neighboring cells.

In other words, in the carrier aggregation, multiple serving cells that are configured include one primary cell and one or multiple secondary cells.

The primary cell is a serving cell in which an initial connection establishment procedure is performed, a serving cell in which a connection re-establishment procedure is started, or a cell that is designated as a primary cell during a handover procedure. The primary cell operates at a primary frequency. At a point of time at which a connection is (re-) established, or thereafter, the secondary cell may be configured. The secondary cell operates at a secondary frequency. Moreover, the connection may be referred to as an RRC connection. Aggregation is performed for the terminal apparatus that supports the CA, in one primary cell and one or more secondary cells.

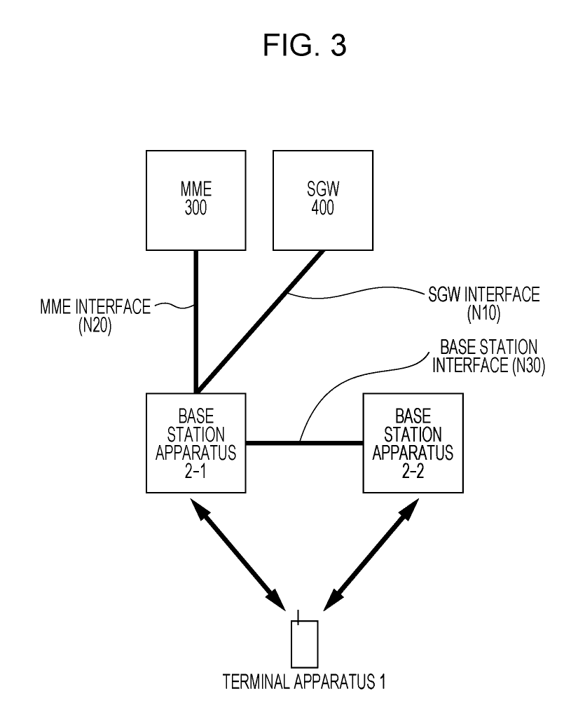

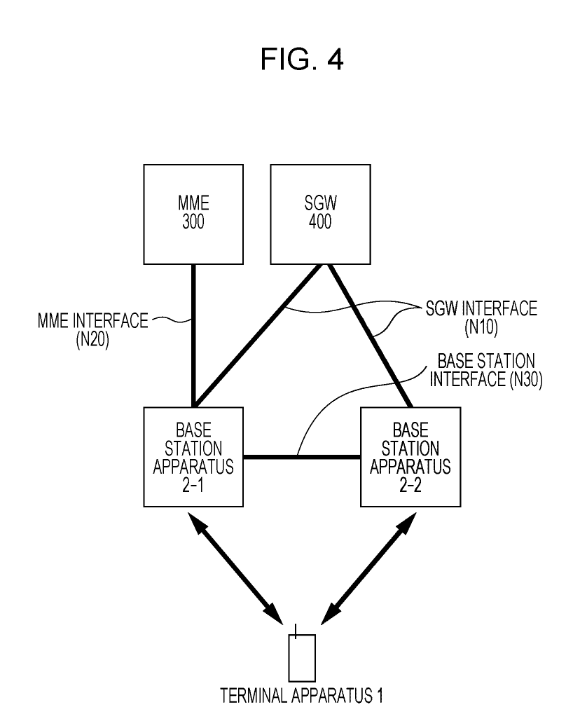

A basic architecture of dual connectivity is described withe reference to FIGS. 3 and 4. FIGS. 3 and 4 illustrate that a terminal apparatus 1 makes connections to multiple base station apparatuses 2 (which are indicated as a base station apparatus 2-1 and a base station apparatus 2-2 in FIGS. 3 and 4) at the same time. The base station apparatus 2-1 is assumed to be a base station apparatus that constitutes a macro cell, and the base station apparatus 2-2 is assumed to be a base station apparatus that constitutes a small cell. In this manner, connections that are made by the terminal apparatus 1 at the same time using multiple cells that belong to multiple base station apparatuses 2 is referred to as dual connectivity. The cells that belong to each base station apparatus 2 may be managed with the same frequency, and may be managed with different frequencies.

Moreover, the carrier aggregation is different from the dual connectivity in that one base station apparatus 2 manages multiple cells and a frequency differs from one cell to another. In other words, the carrier aggregation is a technology that connects one terminal apparatus 1 and one base station apparatus 2 through multiple cells that differ in frequency, and in contrast with this, the dual connectivity is a technology that connects one terminal apparatus 1 and multiple base station apparatus 2 through multiple cells that are the same in frequency or differ in frequency.

In the terminal apparatus 1 and the base station apparatus 2, a technology that applies to the carrier aggregation can apply to the dual connectivity. For example, in the terminal apparatus 1 and the base station apparatus 2, technologies, such as allocation of the primary cell and the secondary cell and activation/deactivation, may apply to a cell that is connected using the dual connectivity.

In FIGS. 3 and 4, the base station apparatus 2-1 or the base station apparatus 2-2 makes a connection to an MME 300 and an SGW 400 through a backbone line. The MME 300 is a high-level control station apparatus that corresponds to a Mobility Management Entity (MME), and assumes the role of performing mobility management or authentication control (security control) of the terminal apparatus 1 and configuring a user data path to the base station apparatus 2, and the like. The SGW 400 is a higher-level control station apparatus that corresponds to a Serving Gateway (S-GW), and assumes the role of transferring user data along the user data path to the terminal apparatus 1 that is configured by the MME 300, and the like.

Furthermore, in FIGS. 3 and 4, a connection path between the base station apparatus 2-1 or the base station apparatus 2-2, and the SGW 400 is referred to as an SGW interface N10. Furthermore, a connection path between the base station apparatus 2-1 or the base station apparatus 2-2, and the MME 300 is referred to as an MME interface N20. Furthermore, a connection path between the base station apparatus 2-1 and the base station apparatus 2-2 is referred to as a base station interface N30. The SGW interface N10 is also referred to as an S1-U interface in the EUTRA. Furthermore, the MME interface N20 is also referred to as an S1-MME interface in the EUTRA. Furthermore, the base station interference N30 is also referred to as an X2 interface in the EUTRA.

A constitution as illustrated in FIG. 3 can be employed as an architecture that realizes the dual connectivity. In FIG. 3, a connection is made between the base station apparatus 2-1 and the MME 300 using the MME interface N20. Furthermore, a connection is made between the base station apparatus 2-1 and the SGW 400 using the SGW interface N10. Furthermore, the base station apparatus 2-1 provides a communication path to the MME 300 and/or the SGW 400 to the base station apparatus 2-2 through the base station interface N30. In other words, the base station apparatus 2-2 makes a connection to the MME 300 and/or the SGW 400 through the base station apparatus 2-1.

Furthermore, a constitution as illustrated in FIG. 4 can be employed as a different architecture that realizes the dual connectivity. In FIG. 4, the connection is made between the base station apparatus 2-1 and the MME 300 using the MME interface N20. Furthermore, the connection is made between the base station apparatus 2-1 and the SGW 400 using the SGW interface N10. The base station apparatus 2-1 provides a communication path to the MME 300 to the base station apparatus 2-2 through the base station interface N30. In other words, the base station apparatus 2-2 makes a connection to the MME 300 through the base station apparatus 2-1. Furthermore, the base station apparatus 2-2 makes a connection to the SGW 400 through the SGW interface N10.

Moreover, a constitution may be employed in which a direct connection is made between the base station apparatus 2-2 and the MME 300 using the MME interface N20.

From a different point of view, the dual connectivity is described as an operation in which a prescribed terminal apparatus consumes radio resources which are provided by at least two different network points (a master base station apparatus (Master eNB (MeNB) and a secondary base station apparatus (Secondary eNB (SeNB)). In other words, with the dual connectivity, the terminal apparatus performs an RRC connection through at least two network points. In the dual connectivity, the terminal apparatus may make a connection in an RRC connection (RRC_CONNECTED) state and with non-ideal backhaul.

In the dual connectivity, the base station apparatus that makes a connection at least to an S1-MME and that plays the role of a mobility anchor of a core network is referred to as the master base station apparatus. Furthermore, the base station apparatus that is not the master base station apparatus that provides an additional radio resource to the terminal apparatus is referred to as the secondary base station apparatus. In some cases, a group of serving cells that are associated with the master base station apparatus and a group of serving cells that are associated with the secondary base station apparatus are also referred to as a Master Cell Group (MCG) and a Secondary Cell Group (SCG), respectively. Moreover, the cell group may be a serving cell group.

In the dual connectivity, the primary cell belongs to the MCG Furthermore, in the SCG, the secondary cell that is equivalent to the primary cell is referred to as a Primary Secondary Cell (pSCell). Moreover, in some cases, the pSCell is referred to as a special cell or a Special Secondary Cell (Special SCell). In the Special SCell (the base station apparatus that constitutes the Special SCell), one or several of the functions (for example, a function of transmitting and receiving the PUCCH and the like) of the PCell (the base station apparatus that constitute the PCell) may be supported. Furthermore, in the pSCell, only one or several of the functions of the PCell may be supported. For example, in the pSCell, a function of transmitting the PDCCH may be supported. Furthermore, in the pSCell, a function of performing PDCCH transmission may be supported using a search space that is different from a CSS or a USS. For example, as search spaces that are different from the USS, there are a search space that is determined based on a value that is stipulated in a specification, a search space that is determined based on an RNTI which is different from a C-RNTI, a search space that is determined based on a value that is configured in a higher layer, which is different from the RNTI, and the like. Furthermore, the pSCell may be at all times in an activated state. Furthermore, the pSCell may be a cell that can receive the PUCCH.

In the dual connectivity, a Date Radio Bearer (DRB) may be allocated in a dedicated manner in the MeNB and the SeNB. On the other hand, a Signalling Radio Bearer (SRB) may be allocated only to the MeNB. In the dual connectivity, in the MCG and the SCG or in the PCell or the pSCell, a duplex mode may be configured in a dedicated manner for each. In the dual connectivity, in the MCG and the SCG or in the PCell or the pSCell, synchronization may not be established. In the dual connectivity, multiple parameters (a Timing Advance Group (TAG)) for timing adjustment are configured for each of the MCG and SCG More precisely, it is possible that the terminal apparatus performs uplink transmission at multiple different timings within each CG.

In the dual connectivity, the terminal apparatus can transmit UCI that corresponds to a cell within the MCG, only to the MeNB (the PCell) and can transmit UCI that corresponds to a cell within the SCG, only to the SeNB (the pSCell). For example, the UCI is the SR, the HARQ-ACK, and/or the CSI. Furthermore, each time the UCI is transmitted, a transmission method that uses the PUCCH and/or the PUSCH applies to each of the cell groups.

In the primary cell, it is possible that all signals are transmitted and received, but in the secondary cell, there is a signal that is difficult to transmit and receive. For example, the Physical Uplink Control Channel (PUCCH) is transmitted only in the primary cell. Furthermore, the Physical Random Access Channel (PRACH) is transmitted only in the primary cell as long as multiple Timing Advance Groups (TAG) are not configured. Furthermore, the Physical Broadcast Channel (PBCH) is transmitted only in the primary cell. Furthermore, a Master Information Block (MIB) is transmitted only in the primary cell. In the primary secondary cell, a signal that is possible to transmit and receive in the primary cell is transmitted and received. For example, the PUCCH may be transmitted in the primary secondary cell. Furthermore, regardless of whether or not multiple TAGs are configured, the PRACH may be transmitted in the primary secondary cell. Furthermore, the PBCH or the MIB may be transmitted in the primary secondary cell.

In the primary cell, a Radio Link Failure (RLF) is detected. In the secondary cell, although a condition for detecting the RLF is set up, it is not recognized that the RLF is detected. In the primary secondary cell, if the condition is satisfied, the RLF is detected. In the primary secondary cell, in a case where the RLF is detected, a higher layer of the primary secondary cell notifies a higher layer of the primary cell that the RLF is detected. In the primary cell, Semi-Persistent Scheduling (SPS) or Discontinuous Transmission (DRX) may be performed. In the secondary cell, the DRX may be performed in the manner as in the primary cell. In the secondary cell, basically, a parameter/information relating to a MAC configuration is used in a shared manner in the primary cell/primary secondary cell in the same cell group. One or several parameters (for example, sTAG-Id) may be configured for every secondary cell. One or several timers or counters may apply only to the primary cell and/or the primary secondary cell. The timer or counter that is to apply may apply only to the secondary cell.

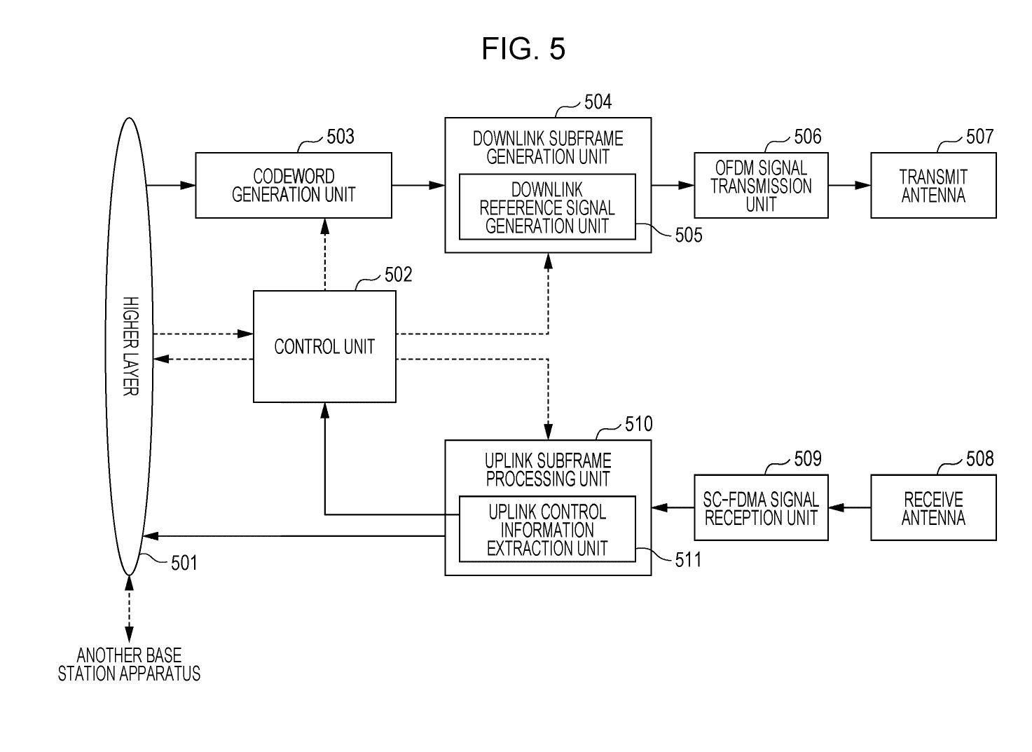

FIG. 5 is a schematic diagram illustrating an example of block constitutions of the base station apparatus 2-1 and the base station apparatus 2-2 according to the present embodiment. The base station apparatus 2-1 and the base station apparatus 2-2 each have a higher layer (a higher layer control information notification unit) 501, a control unit (a base station control unit) 502, a codeword generation unit 503, a downlink subframe generation unit 504, an OFDM signal transmission unit (a downlink transmission unit) 506, a transmit antenna (a base station transmit antenna) 507, a receive antenna (a base station receive antenna) 508, an SC-FDMA signal reception unit (a CSI reception unit) 509, and an uplink subframe processing unit 510. The downlink subframe generation unit 504 has a downlink reference signal generation unit 505. Furthermore, the uplink subframe processing unit 510 has an uplink control information extraction unit (a CSI acquisition unit) 511.

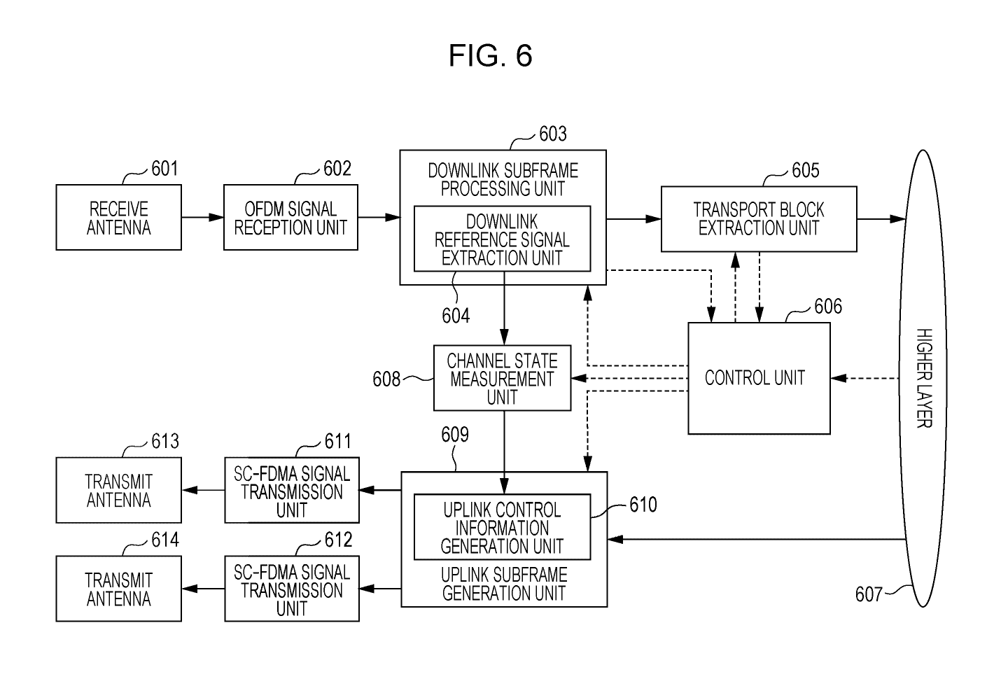

FIG. 6 is a schematic diagram illustrating an example of a block constitution of the terminal apparatus 1 according to the present embodiment. The terminal apparatus 1 has a receive antenna (a terminal receive antenna) 601, an OFDM signal reception unit (a downlink reception unit) 602, a downlink subframe processing unit 603, a transport block extraction unit (a data extraction unit) 605, a control unit (a terminal control unit) 606, a higher layer (a higher layer control information acquisition unit) 607, a channel state measurement unit (a CSI generation unit) 608, an uplink subframe generation unit 609, SC-FDMA signal transmission units (UCI transmission units) 611 and 612, and transmit antennas (terminal transmission antennas) 613 and 614. The downlink subframe processing unit 603 has a downlink reference signal extraction unit 604. Furthermore, the uplink subframe generation unit 609 has an uplink control information generation unit (a UCI generation unit) 610.

First, a flow of transmission and reception of the downlink data is described with reference to referring FIGS. 5 and 6. In the base station apparatus 2-1 or the base station apparatus 2-2, the control unit 502 retains a Modulation and Coding Scheme (MCS) indicating a modulation scheme, a coding rate, and the like in the downlink, downlink resource assignment indicating an RB which is used for data transmission, and information (a redundancy version, a HARQ process number, or a new data indicator) that is used for HARQ control, and, based on these, controls the codeword generation unit 503 or the downlink subframe generation unit 504. Error correction coding processing, rate matching processing, and the like are performed on the downlink data (which is also referred to as a downlink transport block) that is sent from the higher layer 501, in the codeword generation unit 503 under the control of the control unit 502, and a codeword is generated. Two codewords at the maximum are transmitted at the same time in one subframe in one cell. In the downlink subframe generation unit 504, the downlink subframe is generated according to an instruction of the control unit 502. First, modulation processing, such as Phase Shift Keying (PSK) modulation or Quadrature Amplitude Modulation (QAM) modulation is performed on the codeword that is generated in the codeword generation unit 503, and the resulting codeword is converted into a sequence of modulation symbols. Furthermore, the sequence of modulation symbols is mapped onto REs within one or several RBs, and the downlink subframe is generated for every antenna port by performing precoding processing. At this time, a sequence of pieces of transmission data that is sent from the higher layer 501 includes higher layer control information (for example, exclusive (dedicated) Radio Resource Control (RRC) signaling) that is control information in the higher layer. Furthermore, in the downlink reference signal generation unit 505, the downlink reference signal is generated. According to the instruction of the control unit 502, the downlink subframe generation unit 504 maps the downlink reference signal onto REs within the downlink subframe. The downlink subframe that is generated in the downlink subframe generation unit 504 is modulated into an OFDM signal in the OFDM signal transmission unit 506, and the resulting OFDM signal is transmitted through the transmit antenna 507. Moreover, at this point, a constitution that includes one OFDM signal transmission unit 506 and one transmit antenna 507 is illustrated, but in a case where the downlink subframe is transmitted using multiple antenna ports, a constitution that includes multiple OFDM signal transmission units 506 and multiple transmit antennas 507 may be employed. Furthermore, the downlink subframe generation unit 504 can also have the capability to generate the downlink control channel of the physical layer, such as the PDCCH or the EPDCCH and to map the generated downlink control channel onto the REs within the downlink subframe. Multiple base station apparatuses (the base station apparatus 2-1 and the base station apparatus 2-2) transmit their respective dedicated downlink subframes.

In the terminal apparatus 1, the OFDM signal is received in the OFDM signal reception unit 602 through the receive antenna 601, and OFDM demodulation processing is performed. The downlink subframe processing unit 603 first detects the downlink control channel of the physical layer, such as the PDCCH or the EPDCCH. More specifically, the downlink subframe processing unit 603 performs decoding, with the PDCCH or the EPDCCH as being transmitted in a region to which the PDCCH or the EPDCCH can be allocated, and checks for a Cyclic Redundancy Check (CRC) bit that is attached in advance (blind decoding). That is, the downlink subframe processing unit 603 monitors the PDCCH or the EPDCCH. In a case where the CRC bit is consistent with an ID (one terminal-specific identifier that is assigned to one terminal, such as a Cell-Radio Network Temporary Identifier (C-RNTI) or a Semi Persistent Scheduling-C-RNTI (SPS-C-RNTI), or a Temporaly C-RNTI), which is allocated in advance by the base station apparatus, the downlink subframe processing unit 603 recognizes that the PDCCH or the EPDCCH can be detected and takes out the PDSCH using the control information that is included in the PDCCH or the EPDCCH that is detected. The control unit 606 retains the MCS indicating the modulation scheme, the coding rate, and the like in the downlink, which is based on the control information, the downlink resource assignment indicating an RB that is used for downlink data transmission, and the information that is used for the HARQ control, and, based on these, controls the downlink subframe processing unit 603, the transport block extraction unit 605, or the like. More specifically, the control unit 606 performs control in such a manner that RE demapping processing or demodulation processing that corresponds to RE mapping processing or modulation processing, respectively, in the downlink subframe generation unit 504 is performed. The PDSCH that is taken out of the received downlink subframe is sent to the transport block extraction unit 605. Furthermore, the downlink reference signal extraction unit 604 within the downlink subframe processing unit 603 takes the downlink reference signal out of the downlink subframe. In the transport block extraction unit 605, the rate matching processing and the error correction coding that correspond to the rate matching processing and the error correction coding, respectively, in the codeword generation unit 503 are performed, the transport block is extracted, and the extracted transport block is sent to the higher layer 607. The higher layer control information is included in the transport block, and, based on the higher layer control information, the higher layer 607 informs the control unit 606 of an indispensable physical layer parameter. Moreover, multiple base station apparatuses 2 (the base station apparatus 2-1 and base station apparatus 2-2) transmit their respective dedicated downlink subframes. In order to receive these downlink subframes, the terminal apparatus 1 may perform the processing described above on the downlink subframe that is transmitted by each of the multiple base station apparatuses 2. At this time, the terminal apparatus 1 may recognize or may not recognize that multiple downlink subframes are transmitted from multiple base station apparatuses 2, respectively. If not, the terminal apparatus 1 may recognize simply only that multiple downlink subframes are transmitted in multiple cells, respectively. Furthermore, in the transport block extraction unit 605, it is determined whether or not the transport block can correctly be detected, and a result of the determination is sent to the control unit 606.

Next, a flow of transmission and reception of an uplink signal is described. In the terminal apparatus 1, under the instruction of the control unit 606, the downlink reference signal that is extracted in the downlink reference signal extraction unit 604 is sent to the channel state measurement unit 608. In the channel state measurement unit 608, a channel state and/or interference is measured, and, based on the channel state and/or the interference that is measured, the CSI is calculated. Furthermore, based on a result of determining whether or not the transport block can be correctly detected, the control unit 606 instructs the uplink control information generation unit 610 to generate a HARQ-ACK (DTX (not transmitted), an ACK (detection success) or a NACK (detection failure)) and to perform the mapping of the generated HARQ-ACK onto the downlink subframe. The terminal apparatus 1 performs these processing operations on the downlink subframe in each of the multiple cells. In the uplink control information generation unit 610, the PUCCH is generated that includes the calculated CSI and/or the HARQ-ACK. In the uplink subframe generation unit 609, the PUSCH that includes the uplink data which is sent from the higher layer 607, and the PUCCH that is generated in the uplink control information generation unit 610 are mapped onto RBs within an uplink subframe, and the uplink subframe is generated. At this point, the PUCCH and the uplink subframe that includes the PUCCH are generated for every connectivity group (which is also referred to as a serving cell group or a cell group). Moreover, the connectivity group will be described in detail below. At this point, two connectivity groups are assumed, and are assumed to correspond to the base station apparatus 2-1 and the base station apparatus 2-2, respectively. When it comes to one uplink subframe (for example, the uplink subframe that is transmitted to the base station apparatus 2-1) in one connectivity group, in the SC-FDMA signal transmission unit 611, an SC-FDMA signal on which the SC-FDMA modulation is performed is generated, and the generated SC-FDMA signal is transmitted through the transmit antenna 613. When it comes to the other uplink subframe (for example, the uplink subframe that is transmitted to the base station apparatus 2-2) in one other connectivity group, in the SC-FDMA signal transmission unit 612, an SC-FDMA signal on which the SC-FDMA modulation is performed is generated, and the generated SC-FDMA signal is transmitted through the transmit antenna 614. Furthermore, the uplink subframes in two or more connectivity groups can also be transmitted at the same time using one subframe.

In each of the base station apparatus 2-1 and the base station apparatus 2-2, the uplink subframe in one connectivity group is received. Specifically, the SC-FDMA signal is received in the SC-FDMA signal reception unit 509 through the receive antenna 508, and SC-FDMA demodulation processing is performed. In the uplink subframe processing unit 510, according to the instruction of the control unit 502, the RB onto which the PUCCH is mapped is extracted, and the CSI that is included in the PUCCH is extracted in the uplink control information extraction unit 511. The extracted CSI is sent to the control unit 502. The CSI is used for the control of a downlink transmission parameter (the MCS, the downlink resource assignment, the HARQ, or the like) by the control unit 502.

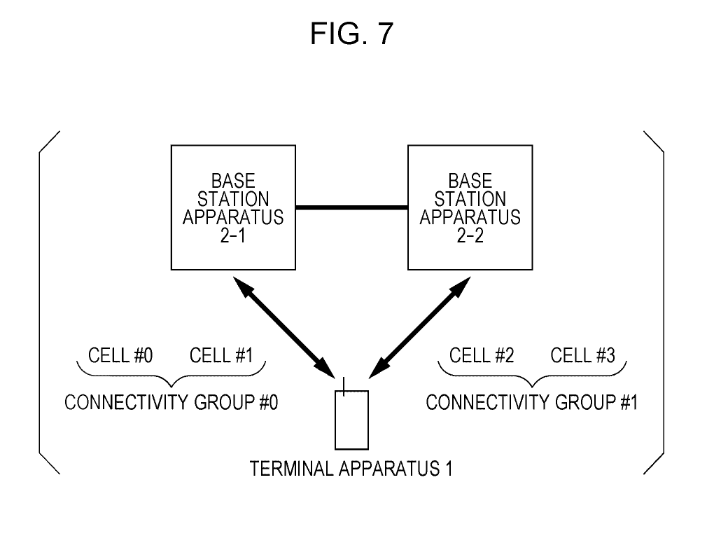

FIG. 7 illustrates an example of the connectivity group (the cell group). The base station apparatus 2-1 and the base station apparatus 2-2, and the terminal apparatus 1 perform communication in multiple serving cells (cell #0, cell #1, cell #2, and cell #3). Cell #0 is a primary cell, and the other cells, that is, cell #1, cell #2, and cell #3, are secondary cells. Four cells are actually covered (provided) by two different base station apparatuses, that is, the base station apparatus 2-1, and the base station apparatus 2-2. Cell #0 and cell #1 are covered by the base station apparatus 2-1, and cell #2 and cell #3 are covered by the base station apparatus 2-2. Serving cells are divided into multiple groups, and each group is referred to as a connectivity group. At this point, serving cells that straddle low-speed backhaul may be grouped into different groups, and serving cells that can use high-speed backhaul, or serving cells that do not need to use backhaul because they are provided using the same apparatus may be grouped into the same group. A serving cell in a connectivity group to which the primary cell belongs can be referred to as a master cell, and a serving cell in the other connectivity groups can be referred to as an assistant cell. Furthermore, one serving cell (for example, a serving cell that has the smallest cell index in the connectivity group) can be referred to as a primary secondary cell or as a PS cell (which is also expressed to as a pSCell) for short. Moreover, each serving cell within the connectivity has component carriers at different carrier frequencies. On the other hand, serving cells in different connectivity groups can also have component carriers at different carrier frequencies, and can also have component carriers at the same carrier frequency (the same carrier frequency is configurable). For example, carrier frequencies of a downlink component carrier and an uplink component carrier that cell #1 has are different from those in cell #0. On the other hand, carrier frequencies of an uplink component carrier and a downlink component carrier that cell #2 includes may be different from those in cell #0 or may be the same as those in cell #0. Furthermore, it is preferable that a SR is transmitted to every connectivity group. A serving cell group that includes the primary cell can be referred to as the Master Cell Group and a serving cell group that does not include the primary cell (that includes the primary secondary cell) can be referred to as a secondary group.

Moreover, the terminal apparatus 1 and the base station apparatus 2, for example, can use any one of the following methods (1) to (5), as a method of grouping serving cells. Moreover, the connectivity group may be configured using methods other than the methods (1) to (5).

(1) A value of a connectivity identifier is configured for each serving cell, and the serving cells for which the same value of the connectivity identifier is configured are regarded as being in a group. Moreover, a value of a connectivity identifier of the primary cell may be set to a prescribed value (for example, 0), without being configured.

(2) The value of the connectivity identifier is configured for each serving cell, and the secondary cells for which the same value of the connectivity identifier is configured are regarded as being in a group. Furthermore, the secondary cells for which the value of the connectivity identifier is not configured are regarded as being in the same group as the primary cells.

(3) A value of an SCell Timing Advanced Group (STAG) identifier is configured for each secondary cell, and the secondary cells for which the same value of the STAG identifier is configured are regarded as being in a group. Furthermore, the secondary cell for which the STAG identifier is not configured is regarded as being in the same group as the primary cell. Moreover, this group and a group for making a timing adjustment of the uplink transmission with respect to downlink reception are used in a shared manner.

(4) In each secondary cell, any value among 1 to 7 is configured as the secondary cell index (the serving cell index). The serving cell index is assumed to be 0 for the primary cell. Group division is performed based on these serving cell indexes. For example, in a case where the secondary cell indexes range from 1 to 4, the secondary cells can be regarded as being in the same group as the primary cell, and on the other hand, in a case where the secondary cell indexes range from 5 to 7, the secondary cells can be regarded as being in a group different from the group to which the primary cell belongs.

(5) In each secondary cell, any value among 1 to 7 is configured as the secondary cell index (the serving cell index). The serving cell index is assumed to be 0 for the primary cell. Furthermore, the serving cell index of the cell that belongs to each group is notified by the base station apparatus 2. At this point, the connectivity identifier, the STAG identifier, or the secondary cell index may be configured, by the base station apparatus 2-1 or the base station apparatus 2-2, for terminal apparatus 1, using dedicated RRC signaling.

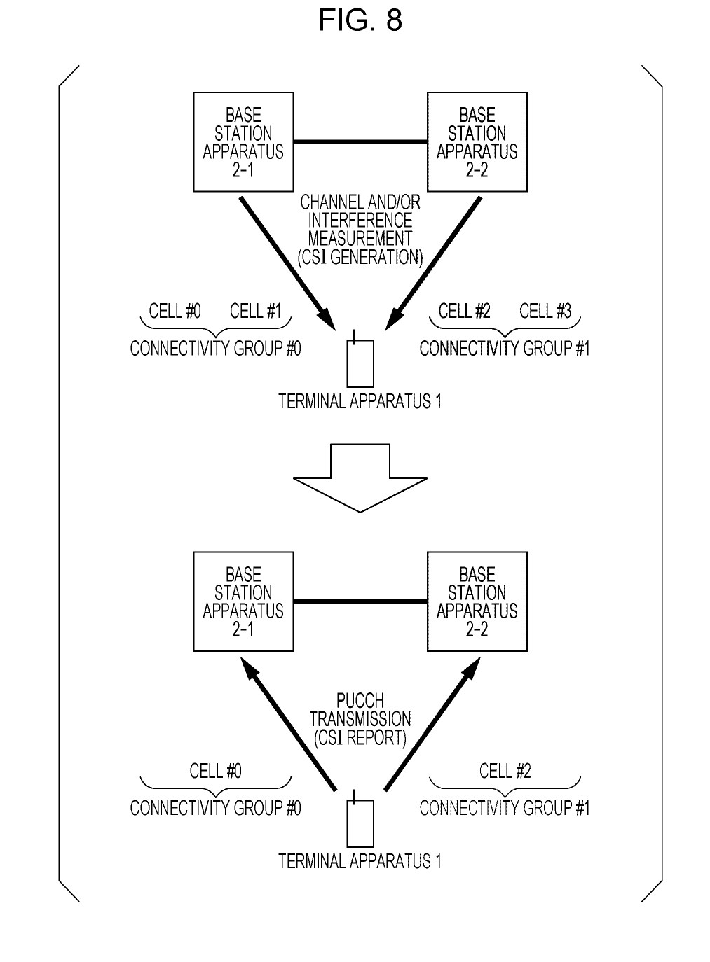

FIG. 8 illustrates an example of generation and report of the CSI in the connectivity group for the terminal apparatus 1. The base station apparatus 2-1 and/or the base station apparatus 2-2 configures a parameter of the downlink reference signal for the terminal apparatus 1 in each serving cell, and transmits the downlink reference signal in each serving cell that is provided. The terminal apparatus 1 receives the downlink reference signal in each serving cell, and performs channel measurement and/or an interference measurement. Moreover, the downlink reference signal here can include a CRS, a non-zero power CSI-RS, and a zero power CSI-RS. Preferably, the terminal apparatus 1 performs the channel measurement using the non-zero power CSI-RS, and performs the interference measurement using the zero power CSI-RS. Additionally, based on a result of the channel measurement and a result of the interference measurement, the RI indicating a suitable rank, the TI indicating a suitable rank, the PMI indicating a suitable precoding matrix, or the CQI that has the highest index which corresponds to a modulation scheme and a coding rate which satisfy demanded quality (which, for example, means that a transport block error rate does not exceed 0.1) in a reference resource is calculated.

Next, the terminal apparatus 1 reports the CSI. At this time, the CSI of each serving cell that belongs to the connectivity group is reported using an uplink resource (a PUCCH resource or a PUSCH resource) in the cell in this connectivity group. Specifically, in a certain subframe, the CSI of cell #0 and the CSI of cell #1 are transmitted using the PUCCH of cell #0 that is not only the PS cell in connectivity group #0, but also the primary cell. Furthermore, in a certain subframe, the CSI of cell #0 and the CSI of cell #1 are transmitted using the PUSCH of any one cell that belongs to connectivity group #0. Furthermore, in a certain subframe, the CSI of cell #2 and the CSI of cell #3 are transmitted using the PUCCH of cell #2 that is the PS cell in connectivity group #1. Furthermore, in a certain subframe, the CSI of cell #2 and the CSI of cell #3 are transmitted using the PUSCH of any one cell that belongs to connectivity group #1. In a sense, each PS cell can perform a portion (for example, transmission of the CSI that uses the PUCCH) of a primary cell function in the carrier aggregation in the related art. A CSI report on the serving cell within each connectivity group is conducted in the same manner as a CSI report on the serving cell in the carrier aggregation.

The PUCCH resource for a periodic CSI of the serving cell that belongs to a certain connectivity group is configured for the PS cell in the same connectivity group. The base station apparatus 2 transmits information for configuring the PUCCH resource for the periodic CSI in the PS cell to the terminal apparatus 1. In a case where the information for configuring the PUCCH resource for the periodic CSI in the PS cell is received, the terminal apparatus 1 performs reporting of the periodic CSI using this PUCCH resource. The base station apparatus 2 does not transmit information for configuring the PUCCH resource for the periodic CSI in the PS cell to the terminal apparatus 1. In a case where the information for configuring the PUCCH resource for the periodic CSI in a cell other than the PS cell is received, the terminal apparatus 1 performs error handling and does not perform the reporting of the periodic CSI using this PUCCH resource.

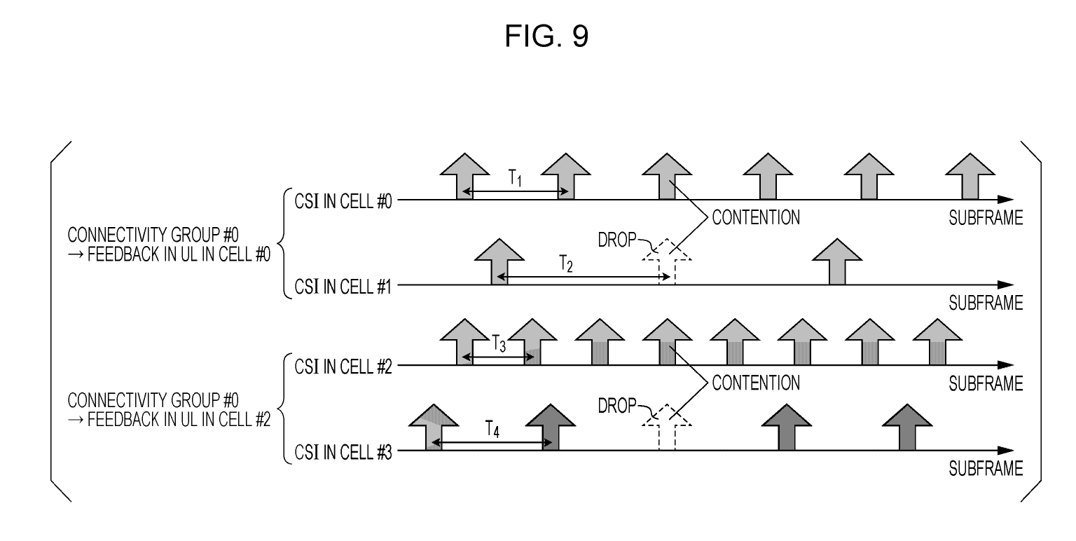

FIG. 9 illustrates an example of the periodic CSI reporting. The periodic CSI is periodically fed back from the terminal apparatus 1 to the base station apparatus 2 in a subframe with a periodicity that is configured with the dedicated RRC signaling. Furthermore, normally, the periodic CSI is transmitted using the PUCCH. Parameters (a periodicity of the subframe, an offset from a reference subframe to a start subframe, and a report mode) of the periodic CSI can be configured in a dedicated manner for every serving cell. An index of the PUCCH resource for the periodic CSI can be configured for every connectivity group. At this point, periodicities in cells #0, #1, #2, and #3 are assumed to be configured to be T1, T2, T3, and T4, respectively. Using the PUCCH resource of cell #0 that is not only the PS cell in the connectivity group #0, but also the primary cell, the terminal apparatus 1 performs uplink transmission of the periodic CSI of cell #0 in a subframe with a periodicity of T1 and performs the uplink transmission of the periodic CSI of cell #1 in a subframe with a periodicity of T2. Using the PUCCH resource of cell #2 that is the PS cell in the connectivity group #1, the terminal apparatus 1 performs the uplink transmission of the periodic CSI of cell #2 in a subframe with a periodicity of T3 and performs the uplink transmission of the periodic CSI of cell #3 in a subframe with a periodicity of T4. In a case where the periodic CSI reports are in contention between multiple servings within one connectivity group (multiple periodic CSI reports take place in one subframe), only one periodic CSI report is transmitted, and the other periodic CSI reports are dropped (are not transmitted).

Furthermore, as a method of determining which uplink resource (the PUCCH resource or the PUSCH resource) are used to transmit the periodic CSI report and/or the HARQ-ACK, the terminal apparatus 1 can use a method that is next described. That is, the terminal apparatus 1 determines the uplink resource (the PUCCH resource or the PUSCH resource) that is used to transmit the periodic CSI report and/or the HARQ-ACK, according to any one of (D1) to (D6) that will be described below, in each of the connectivity groups.

(D1) In a case where one or more serving cells are configured for the terminal apparatus 1 and concurrent transmission of the PUSCH and the PUCCH is not configured, if in a subframe n, the uplink control information on a certain connectivity group includes only the periodic CSI and the PUSCH is not transmitted within the connectivity group, the uplink control information is transmitted on the PUCCH of the PS cell within this connectivity group.

(D2) In the case where one or more serving cells are configured for the terminal apparatus 1 and the concurrent transmission of the PUSCH and the PUCCH is not configured, if in the subframe n, the uplink control information on a certain connectivity group includes the periodic CSI and/or the HARQ-ACK and the PUSCH is transmitted in the PS cell within the connectivity group, the uplink control information is transmitted on the PUSCH of the PS cell within this connectivity group.

(D3) In the case where one or more serving cells are configured for the terminal apparatus 1 and the concurrent transmission of the PUSCH and the PUCCH is not configured, if in the subframe n, the uplink control information on a certain connectivity group includes the periodic CSI and/or the HARQ-ACK, the PUSCH is not transmitted in the PS cell within the connectivity group, and the PUSCH is transmitted in at least one secondary cell other than the PS cell within this connectivity group, the uplink control information is transmitted on the PUSCH of the secondary cell with the lowest cell index within this connectivity group.

(D4) In a case where one or more serving cells are configured for the terminal apparatus 1 and the concurrent transmission of the PUSCH and the PUCCH is configured, if in the subframe n, the uplink control information on a certain connectivity group includes only the periodic CSI, the uplink control information is transmitted on the PUCCH of the PS cell within this connectivity group.

(D5) In the case where one or more serving cells are configured for the terminal apparatus 1 and the concurrent transmission of the PUSCH and the PUCCH is configured, if in the subframe n, the uplink control information on a certain connectivity group includes the periodic CSI and the HARQ-ACK and the PUSCH is transmitted in the PS cell within this connectivity group, the HARQ-ACK is transmitted on the PUCCH of the PS cell within this connectivity group, and the periodic CSI is transmitted on the PUSCH of the PS cell within this connectivity group.

(D6) In the case where more than one serving cell is configured for the terminal apparatus 1 and the concurrent transmission of the PUSCH and the PUCCH is configured, if in the subframe n, the uplink control information on a certain connectivity group includes the periodic CSI and the HARQ-ACK, the PUSCH is not transmitted in the PS cell within this connectivity group, and the PUSCH is transmitted in at least one other secondary cell within the same connectivity group, the HARQ-ACK is transmitted on the PUCCH of the PS cell within this connectivity group, and the periodic CSI is transmitted on the PUSCH of the secondary cell with the lowest secondary cell index within this connectivity group.

In this manner, in a communication system that has the terminal apparatus 1 and multiple base station apparatuses 2, each of which performs communication using one or more serving cells, the terminal apparatus 1 configures the connectivity identifier of every serving cell in the higher layer control information acquisition unit and calculates the periodic channel state information of every serving cell in a channel state information generation unit. In a case where in one subframe, the reporting of the periodic channel state information of the serving cell of which the connectivity identifier has the same value is in contention, pieces of periodic channel state information other than one piece of periodic channel state information are dropped and the uplink control information is generated, in the uplink control information generation unit, and the uplink subframe that includes the uplink control information is transmitted in an uplink control information transmission unit. At least any one of the base station apparatus 2-1 and the base station apparatus 2-2 configures values (for example, a first value for the serving cell of the base station apparatus 2-1, a second value for the serving cell of the base station apparatus 2-2, and the like) that correspond multiple base station apparatuses, respectively, as the connectivity identifier of every serving cell, in the higher layer control information notification unit. Furthermore, each of the base station apparatus 2-1 and the base station apparatus 2-2 receives the uplink subframe in an uplink control information reception unit. In a case where in one uplink subframe, the reporting of one or more pieces of the periodic channel state information of the serving cell, which take a value of the connectivity identifier that corresponds to a first base station apparatus, is in contention, each of the base station apparatus 2-1 and the base station apparatus 2-1 extracts the uplink control information that includes only one piece of periodic channel state information, among the pieces of periodic channel state information in contention, in the uplink control information extraction unit. Preferably, the CSI of the serving cell in each connectivity group is transmitted and received in the uplink subframe in the PS cell in each connectivity group.

At this point, both of, or only one of the base station apparatus 2-1 and the base station apparatus 2-2 may be equipped with a function of the higher layer control information notification unit. Moreover, in the dual connectivity, only one of the base station apparatus 2-1 and the base station apparatus 2-2 being equipped with such a function means that the higher layer control information is transmitted from any one of the base station apparatus 2-1 and the base station apparatus 2-2 and does not mean that the base station apparatus 2-1 or the base station apparatus 2-2 is configured not to have the higher layer control information itself. In a case where the base station apparatus 2-1 and the base station apparatus 2-2 have a backhaul transmission and reception mechanism and the base station apparatus 2-2 performs a configuration (which includes a connectivity group configuration of each of these serving cells) that is associated with each of the serving cells that are provided by the base station apparatus 2-1, the base station apparatus 2-1 transmits information indicating this configuration to the base station apparatus 2-2 through backhaul, and, based on the information that is received through the backhaul, the base station apparatus 2-2 performs a configuration (configuration within the base station apparatus 2-2 or signaling to the terminal apparatus 1). Conversely, in a case where configuration that is associated with the serving cell which is provided by the base station apparatus 2-2 is performed by the base station apparatus 2-1, the base station apparatus 2-2 transmits information indicating this configuration to the base station apparatus 2-1 through the backhaul, and, based on the information that is received through the backhaul, the base station apparatus 2-1 performs a configuration (configuration within the base station apparatus 2-1 or signaling to the terminal apparatus 1). Alternatively, the base station apparatus 2-2 may be responsible for one or several of the functions of the higher layer control information notification unit, and the base station apparatus 2-1 may be responsible for the other functions. In this case, the base station apparatus 2-1 can be referred to as the master base station apparatus, and the base station apparatus 2-2 can be referred to as an assistance base station apparatus. The assistance base station apparatus can provide a configuration (which includes the connectivity group configuration of each of these serving cells) that is associated with each of the serving cells which are provided by the assistance base station apparatus, to the terminal apparatus 1. On the other hand, the master base station apparatus can provide a configuration (which includes the connectivity group configuration of each of these serving cells) that is associated with each of the serving cells which are provided by the master base station apparatus, to the terminal apparatus 1.

The terminal apparatus 1 can recognize that the communication only with the base station apparatus 2-1 is performed. That is, the higher layer control information acquisition unit can acquire pieces of higher layer control information that are notified by the base station apparatus 2-1 and the base station apparatus 2-2, as the high layer control information that is notified by the base station apparatus 2-1. Alternatively, the terminal apparatus 1 can recognize that the communication with two base station apparatuses, that is, the base station apparatus 2-1 and the base station apparatus 2-1, is performed. That is, the higher layer control information acquisition unit can acquire the high layer control information that is notified by the base station apparatus 2-1 and the higher layer control information that is notified by the base station apparatus 2-2 and can combine (merge) these pieces of higher layer control information.

Accordingly, each of the base station apparatuses 2 can receive a desired periodic CSI report directly from the terminal apparatus 1 without involving the other base station apparatuses 2 in between. For this reason, although the base station apparatuses 2 are connected to one another in the low-speed back haul, scheduling can be performed using a timely periodic CSI report.

Next, an aperiodic CSI report is described. An instruction to perform the aperiodic CSI report is provided using a CSI request field in the uplink grant that is transmitted on the PDCCH or the EPDCCH, and is transmitted using the PUSCH. More specifically, the base station apparatus 2-1 or the base station apparatus 2-2 first configures combinations (or combinations of CSI processes) of n (n is a natural number) types of serving cells for the terminal apparatus 1 using the dedicated RRC signaling. The CSI request field can express states of n+2 types. States illustrate that each of the aperiodic CSI reports is not fed back, that the CSI report in the serving cell that is allocated with the uplink grant (or in the CSI process of the serving cell that is allocated with the uplink grant) is fed back, and that the CSI report in the combinations (or the combinations of CSI processes) of the n (n is a natural number) types of serving cells that are configured in advance is fed back. The base station apparatus 2-1 or the base station apparatus 2-2 configures a value of the CSI request field based on a desired CSI report. The terminal apparatus 1 determines which CSI report is performed, based on the value of the CSI request field, and performs the CSI report. The base station apparatus 2-1 or the base station apparatus 2-2 receives the desired CSI report.

As an example of the aperiodic CSI report at the time of the dual connectivity, the combinations (or the combinations of CSI processes) of the n (n is a natural number) types of serving cells are configured for every connectivity group. For example, the base station apparatus 2-1 or the base station apparatus 2-2 configures for the terminal apparatus 1 the combinations (or the combinations of CSI processes within connectivity group #0) of the n (n is a natural number) types of the serving cells within the connectivity group #0, and the combinations (or the combinations of CSI processes within connectivity group #0) of the n (n is a natural number) types of serving cell within the connectivity group #1. The base station apparatus 2-1 or the base station apparatus 2-2 configures the CSI request field based on the desired CSI report. The terminal apparatus 1 determines which connectivity group the serving cell to which the PUSCH resource is allocated with the uplink grant which requests the aperiodic CSI report belongs to, determines which CSI report is performed, using the combinations (or the combinations of CSI processes) of the n (n is a natural number) types of serving cells that correspond to the connectivity group to which the serving cell to which the PUSCH resource is allocated with the uplink grant which requests the aperiodic CSI report belongs, and performs the aperiodic CSI report on the PUSCH that is allocated with the uplink grant which requests the aperiodic CSI report. The base station apparatus 2-1 or the base station apparatus 2-2 receives the desired CSI report.

As another example of the aperiodic CSI report at the time of the dual connectivity, one combination (or one combination of CSI processes) of the n (n is a natural number) types of serving cells is configured. Each of the combinations (or the combinations of CSI processes) of the n (n is a natural number) types of serving cells is limited to a combination of serving cells (or a combination of CSI processes of the serving cells that belong to any connectivity group) that belong to any connectivity group. The base station apparatus 2-1 or the base station apparatus 2-2 configures a value of the CSI request field based on a desired aperiodic CSI report. The terminal apparatus 1 determines which aperiodic CSI report is performed, based on the value of the CSI request field, and performs the aperiodic CSI report. The base station apparatus 2-1 or the base station apparatus 2-2 receives the desired aperiodic CSI report.

Accordingly, each of the base station apparatuses 2 can receive the desired aperiodic CSI report directly from the terminal apparatus 1 without involving the other base station apparatuses 2 in between. Furthermore, each PUSCH can include only the aperiodic CSI report in the serving cell (or the CSI process of the serving cell that belongs to one connectivity group) that belongs to one connectivity group, and, because of this, can receive the aperiodic CSI report that does not depend on the configuration by another base station apparatus 2, from the terminal apparatus 1. For this reason, although the base station apparatuses 2 are connected to one another in the low-speed back haul, the scheduling can be performed using a timely aperiodic CSI report.

Next, uplink power control by the terminal apparatus 1 in the dual connectivity is described. At this point, the uplink power control includes power control in the uplink transmission. The uplink transmission includes transmission of the uplink signal/uplink physical channel, such as the PUSCH, the PUCCH, the PRACH, and the SRS. Moreover, as will be described below, the MeNB may collectively notify (configure) parameters that are associated with both of the MeNB and the SeNB. The SeNB may collectively notify (configure) the parameters that are associated with both of the MeNB and the SeNB. The MeNB and SeNB may notify (configure) the parameter that is associated with each of the MeNB and the SeNB in a dedicated manner.

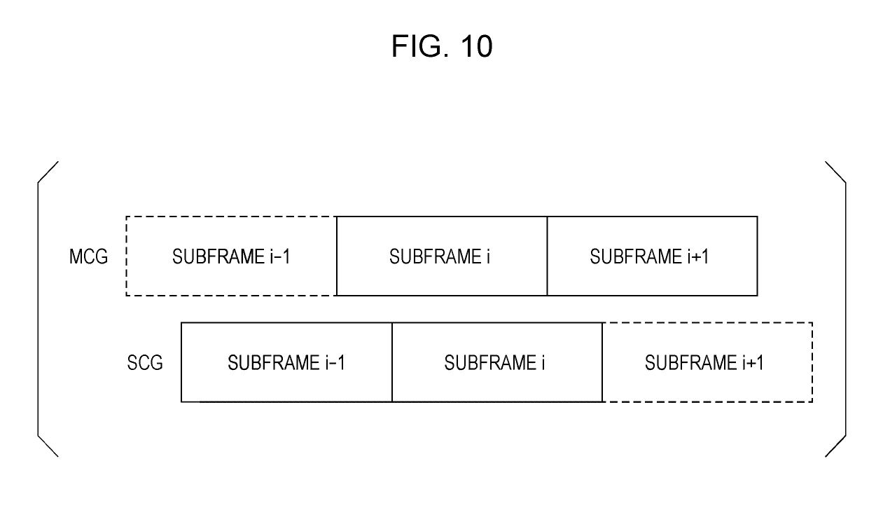

FIG. 10 is a diagram illustrating an example of the subframe for the uplink transmission in the dual connectivity. In this example, a timing of the uplink transmission in the MCG and a timing of the uplink transmission in the MCG are different from each other. For example, a subframe i in the MCG overlaps a subframe i−1 in the SCG and a subframe i in the SCG The subframe i in the SCG overlaps the subframe i in the MCG and a subframe i+1 in the MCG For this reason, in the dual connectivity, when it comes to transmit power control for the uplink transmission in a certain cell group, it is desirable that transmit power for two subframes that overlap in a different cell group is considered.

The terminal apparatus 1 may perform the uplink power control in a dedicated manner, in the MCG that includes the primary cell and the SCG that includes the primary secondary cell. Moreover, the uplink power control includes the transmit power control for the uplink transmission. The uplink power control includes the transmit power control by the terminal apparatus 1.

For the terminal apparatus 1, a maximum permission output power P_{EMAX} of terminal apparatus 1 is configured using dedicated signaling of the higher layer and/or common signaling (for example, a System Information Block (SIB)) of the higher layer. Moreover, this maximum permission output power may be referred to as a maximum output power of the higher layer. For example, P_{EMAX, c} that is a maximum permission output power in a serving cell c is given by P-Max that is configured for the serving cell c. More precisely, in the serving cell c, P_{EMAX, c} is the same value as P-Max.

For the terminal apparatus 1, a power class P_{PowerClass} of the terminal apparatus 1 is stipulated in advance for every frequency band. The power class is a maximum output power that is stipulated without considering an allowable error that is stipulated in advance. For example, the power class is stipulated as 23 dBm. Based on the power class that is stipulated in advance, the maximum output power may be configured in a dedicated manner in the MCG and the SCG Moreover, the power class may be stipulated independently of the MCG and the SCG

A configuration maximum output power is configured for the terminal apparatus 1 for every serving cell. The configuration maximum output power P_{CMAX, c} is configured for the terminal apparatus 1 for the serving cell c. P_{CMAX} is a sum of P_{CMAX, c}'s. Moreover, the configuration maximum output power may be referred to as a maximum output power of the physical layer.

P_{CMAX, c} is a value that is equal to or greater than P_{CMAX}_{_}_{L, c} and is equal to or smaller than P_{CMAX}_{_}_{H, c}. For example, the terminal apparatus 1 sets P_{CMAX, c} within this range. P_{CMAX}_{_}_{H, c} is the smallest of values, that is, P_{EMAX, c} and P_{PowerClass}. P_{CMAX}_{_}_{L, c} is the smallest of a value that is based on P_{EMAX, c} and a value that is based on P_{PowerClass}. A value that is based on P_{PowerClass} is a value that results from subtracting from P_{PowerClass} a value that is based on a maximum power reduction (MPR). The MPR is a maximum power reduction for the maximum output power, and is determined based on configuration of a modulation scheme and a transmission bandwidth for the uplink channel and/or the uplink signal that is to be transmitted. In each of the subframes, the MPR is evaluated for every slot, and is given by a maximum value that is obtained over transmission within this slot. A maximum MPR in two slots within the subframe applies for this entire subframe. That is, because in some cases, the MPR differs from one subframe to another, there is likelihood that P_{CMAX}_{_}_{L, c} will differ from one subframe to another as well. As a result, there is likelihood that P_{CMAX, c} will differ from one subframe to another as well.

The terminal apparatus 1 can configure or determine P_{CMAX} for each of the MeNB (MCG) and the SeNB (SCG). That is, a sum of power allocations can be configured or determined for every cell group. A sum of configuration maximum output powers for the MeNB is defined as P_{CMAX, MeNB}, and the sum of power allocations for the MeNB is defined as P_{alloc}_{_}_{MeNB}. The sum of configuration maximum output powers for the SeNB is defined as P_{CMAX, SeNB}, and the sum of power allocations for the SeNB is defined as P_{alloc}_{_}_{SeNB}. P_{CMAX, MeNB} and P_{alloc}_{_}_{MeNB} can be the same value. P_{CMAX, SeNB} and P_{alloc}_{_}_{SeNB} can be the same value. That is, the terminal apparatus 1 performs the transmit power control in such a manner that a sum of output powers (allocation powers) of the cell which is associated with the MeNB is equal to or smaller than P_{CMAX, MeNB} or P_{alloc}_{_}_{MeNB} and the sum of output powers (allocation powers) of the cell which is associated with the SeNB is equal to or smaller than P_{CMAX, SeNB} or P_{alloc}_{_}_{SeNB}. Specifically, the terminal apparatus 1 performs scaling on the transmit power for the uplink transmission for every cell group in such a manner that a value which is configured for every cell group is not exceeded. At this point, the scaling is to perform transmission stopping of or the transmit power reduction for the uplink transmission that has a low priority level, based on priority levels of the uplink transmissions that are performed at the same time in each cell group and on the configuration maximum output power for this cell group. Moreover, in a case where the transmit power control is performed on each of the uplink transmissions in a dedicated manner, the method that is described according to the present embodiment can apply to each of the uplink transmissions in a dedicated manner.

P_{CMAX, MeNB} and/or P_{CMAX, SeNB} is configured based on a minimum guarantee power that is configured through higher layer signaling. The minimum guarantee power will be described in detail below.

The minimum guarantee power is configured for every cell group in a dedicated manner. In a case where the minimum guarantee power is not configured with the higher layer signaling, the terminal apparatus 1 can assume the minimum guarantee power to be a value (for example, 0) that is stipulated in advance. The configuration maximum output power for the MeNB is defined as P_{MeNB}. The configuration maximum output power for the SeNB is defined as P_{SeNB}. For example, P_{MeNB} and P_{SeNB} may be used as a minimum power that is guaranteed for retaining minimum communication quality, for the uplink transmission for the MeNB and the SeNB. The minimum guarantee power is also referred to as a guarantee power, a retention power, or a demanded power.

Moreover, in a case where a sum of the transmit powers for the uplink transmission for the MeNB and the transmit power for the uplink transmission for the SeNB exceeds P_{CMAX}, the guarantee power may be used for transmission of a channel or a signal that has a high priority level, or for retention of transmission quality of this channel or this signal, based on priority ranking and the like that are stipulated in advance. Moreover, P_{MeNb} and P_{SeNB} can be used as a minimum indispensable power (more precisely, a guarantee power) that is used for communication and, when calculating power allocation in each of the CGs, can be used as a power value that is reserved for a CG other than a calculation target CG.

P_{MeNB} and P_{SeNB} can be stipulated an absolute power value (which, for example, is expressed in a dBm unit). In the case of the absolute power value, P_{MeNB} and P_{SeNB} are configured. A value of a sum of P_{MeNB} and P_{SeNB} is preferably equal to or smaller than P_{CMAX}, but is not limited to this. In a case where the value of the sum of P_{MeNB} and P_{SeNB} is greater than P_{CMAX}, processing that reduces a total power to P_{CMAX} or less by performing scaling is further indispensable. For example, this scaling is to multiply a total power value of the MCG and a total power value of the SCG by one efficiency that is a value which is smaller than 1.

P_{MeNB} and P_{SeNB} may be stipulated as a ratio (a rate or a relative value) that is with respect to P_{CMAX}. For example, P_{MeNB} and P_{SeNB} may be expressed in a dB unit with respect to a decibel value of P_{CMAX}, and may be expressed as a ratio that is with respect to a true value of P_{CMAX}. A ratio relating to P_{MeNB} and a ratio relating to PSeNB are configured, and, based on these ratios, P_{MeNB} and P_{SeNB} are determined. In the case of the ratio expression, it is preferable that a value of a sum of the ratio relating to the P_{MeNB} and the ratio relating to P_{SeNB} is equal to or smaller than 100%.

What is described above, in other words, is as follows. P_{MeNB} and/or P_{SeNB} can be configured in a shared manner or independently as a parameter for the uplink transmission, through the higher layer signaling. In a cell that belongs to the MeNB, P_{MeNB} indicates a minimum endorsement power with respect to the sum of transmit powers that are allocated to each of or all of the uplink transmissions. In a cell that belongs to the SeNB, P_{SeNB} indicates a minimum endorsement power with respect to the sum of transmit powers that are allocated to each of or all of the uplink transmissions. Each of P_{MeNB} and P_{SeNB} is a value that is equal to or greater than 0. The sum of P_{MeNB} and P_{SeNB} may be configured in such a manner as not to exceed P_{CMAX} or a prescribed maximum transmit power. As will be described below, the minimum endorsement power is also referred to as an endorsement power or a guarantee power.

Moreover, the guarantee power may be configured for every serving cell. Furthermore, the guarantee power may be configured for every cell group. Furthermore, the guarantee power may be configured for every base station apparatus (the MeNB and the SeNB). Furthermore, the guarantee power may be configured for every uplink signal. Furthermore, the guarantee power may be configured for a higher layer parameter. Furthermore, only P_{MeNB} may be configured with the RRC message, and P_{SeNB} may not be configured with the RRC message. At this time, a value (a remaining power) that is obtained by subtracting configured P_{MeNB} from P_{CMAX} may be set as P_{SeNB}.

The guarantee power may be set for every subframe regardless of the presence or absence of the uplink transmission. Furthermore, the guarantee power may not be applied in the subframe (for example, a downlink subframe in a TDD UL-DL configuration) in which the uplink transmission is not expected (in which, the terminal apparatus recognizes, the uplink transmission is not performed). That is, after a transmit power for a certain CG is determined, a guarantee power for another CG may not be reserved. Furthermore, the guarantee power may be applied in a subframe in which periodic uplink transmission (for example, RACH transmission or the like using P-CSI, a trigger type 0 SRS, TTI bundling, the SPS, and the higher layer signaling) takes place. Information indicating whether the guarantee power is enabled or disabled in all subframes may be notified through the higher layer.

A subframe set to which the guarantee power is applied may be notified as the higher layer parameter. Moreover, the subframe set to which the guarantee power is applied may be configured for every serving cell. Furthermore, the subframe set to which the guarantee power is applied may be configured for every cell group. Furthermore, the subframe set to which the guarantee power is applied may be configured for every uplink signal. Furthermore, the subframe set to which the guarantee power is applied may be configured for every base station apparatus (the MeNB and SeNB). Furthermore, the subframe set to which the guarantee power is applied may be common to the base station apparatuses (the MeNB and SeNB). At that time, the MeNB and the SeNB may be synchronized. Furthermore, in a case where the MeNB and the SeNB are asynchronous, the subframe set to which the guarantee power is applied may be set in a dedicated manner.

In a case where the guarantee power is configured for each of the MeNB (the MCG and a serving cell that belongs to the MCG) and the SeNB (the SCG and a serving cell that belongs to the SCG), it may be determined at all times whether or not the guarantee power is set in all the subframes, based on a frame structure type that is set for the MeNB (the MCG and the serving cell that belongs to the MCG) and the SeNB (the SCG and the serving cell that belongs to the SCG). For example, in a case where the MeNB and the SeNB are different from each other in the frame structure type, the guarantee power may be set in all the subframes. At that time, the MeNB and the SeNB may not be asynchronous. In a case where the MeNB and the SeNB (the subframes and radio frames of the MeNB and the SeNB) are synchronous, the guarantee power may not be considered in a FDD uplink subframe (an uplink cell subframe) that overlaps the downlink subframe in the TDD UL-DL configuration. More precisely, at that time, a maximum value of an uplink power for the uplink transmission in the FDD uplink subframe may be P_{UE}_{_}_{MAX} or P_{UE}_{_}_{MAX, c}.

A method of configuring (a method of determining) P_{alloc, MeNB} and/or P_{alloc, SeNB} will be described in detail below.

An example of the determination of P_{alloc, MeNB} and/or P_{alloc, SeNB} is a determination that is made in the following steps. In the first step, in the MCG and the SCG, Pₚᵣₑ_{_}_{MeNB} and Pₚᵣₑ_{_}_{SeNB} each are obtained. In each of the cell groups, Pₚᵣₑ_{_}_{MeNB} and Pₚᵣₑ_{_}_{SeNB} are given by the smallest of values, that is, a sum of powers that are requested for actual uplink transmission, and the guarantee power (that is, P_{MeNB} and P_{SeNB}) that is configured for each of the cell groups. In the second step, the residual power is allocated (added) to Pₚᵣₑ_{_}_{MeNB} and/or Pₚᵣₑ_{_}_{SeNB}, based on a prescribed method. The residual power is a power that results from subtracting Pₚᵣₑ_{_}_{MeNB} and Pₚᵣₑ_{_}_{SeNB} from P_{CMAX}. A portion or all portions of the residual power can be used. The powers that are determined based on these steps are used as P_{alloc, MeNB} and P_{alloc, SeNB}.

An example of the power that is requested for the actual uplink transmission is a power that is determined based on allocation of the actual uplink transmission and the transmit power control for this uplink transmission. For example, in a case where the uplink transmission is for the PUSCH, the power for this is determined based on the number of RBs to which at least the PUSCH is allocated, estimation of a downlink path loss that is calculated in the terminal apparatus 1, a value that is referred to for a transmit power control command, and a parameter that is configured with the higher layer signaling. In the case where the uplink transmission is for the PUCCH, the power for this is determined based on a value that depends on at least a PUCCH format, the value that is referred to for the transmit power control command, and the estimation of the downlink path loss that is calculated in the terminal apparatus 1. In a case where the uplink transmission is for the SRS, the power for this is determined based on the number of RBs for transmitting at least the SRS, and a state that is adjusted for the power control for the PUSCH.

An example of the power that is requested for the actual uplink transmission is the smallest of values, that is, the power that is determined based on the allocation of the actual uplink transmission and the transmit power control for this uplink transmission, and the configuration maximum output power (that is, P_{CMAX, c}) in the cell to which this uplink transmission is allocated. Specifically, a request power (a power that is requested for the actual uplink transmission) in a certain cell group is given by Σ(min(P_{CMAX, j}, P_{PUCCH}+P_{PUSCH, j}). However, j indicates a serving cell associated with this cell group. In a case where this serving cell is a PCell or a pSCell and there is no PUCCH transmission in this serving cell, P_{PUCCH} is assumed to be 0. In a case where this serving cell is a SCell, (more precisely, in a case where this serving cell is neither a PCell nor a pSCell), P_{PUCCH} is assumed to be 0. In a case where there is no PUSCH transmission in this serving cell, P_{PUSCH, j} is assumed to be 0. Moreover, as a method of calculating the request power, a method can be used that is described with reference with steps (t1) to (t9) that will be described below.

An example of the determination of P_{alloc, MeNB} and/or P_{alloc, SeNB} is the determination that is made in the following steps. In the first step, in the MCG and the SCG, Pₚᵣₑ_{_}_{MeNB} and Pₚᵣₑ_{_}_{SeNB} each are obtained. In each of the cell groups, Pₚᵣₑ_{_}_{MeNB} and Pₚᵣₑ_{_}_{SeNB} are given by the guarantee power (that is, P_{MeNB} and P_{SeNB}) that is configured for each of the cell groups. In the second step, the residual power is allocated (added) to Pₚᵣₑ_{_}_{MeNB} and/or Pₚᵣₑ_{_}_{SeNB}, based on a prescribed method. For example, a priority level of the cell group that is previously transmitted is regarded as being high, and thus the residual power is allocated. For example, the residual power is allocated to the cell group that is previously transmitted without considering the cell group that has the likelihood of being transmitted later. The residual power is the power that results from subtracting Pₚᵣₑ_{_}_{MeNB} and Pₚᵣₑ_{_}_{SeNB} from P_{CMAX}. A portion or all portions of the residual power can be used. The powers that are determined based on these steps are used as P_{alloc, MeNB} and P_{alloc, SeNB}.

The residual power can be allocated for the uplink channel and/or the uplink signal that does not satisfy P_{MeNB} or P_{SeNB}. The allocation of the residual power is performed based on a priority level of a type of uplink transmission. The type of uplink transmission is a type of uplink channel, uplink signal and/or UCI. This priority level is given in such a manner as to exceed a priority level of the cell group. This priority level may be stipulated in advance, and may be configured with the higher layer signaling.

An example of a case where the priority level is stipulated in advance is a case where the priority level is based on the cell group and the uplink channel. For example, it is stipulated that the priority level of the type of uplink transmission decreases in this sequence: the PUCCH for the MCG, the PUCCH for the SCG, the PUSCH that includes the UCI in the MCG, the PUSCH that includes the UCI in the SCG, the PUSCH that does not include the UCI in the MCG, the PUSCH that does not include the UCI in the SCG

An example of a case where the priority level is stipulated in advance is a case where the priority level is based on the cell group, and the type of uplink channel and/or UCI. For example, it is stipulated that the priority level of the type of uplink transmission decreases in this sequence: the PUCCH or the PUSCH that includes the UCI which includes at least the HARQ-ACK and/or the SR in the MCG, the PUCCH or the PUSCH that includes the UCI which includes at least the HARQ-ACK and/or SR in the SCG, the PUCCH or the PUSCH that includes the UCI which includes only the CSI in the MCG, the PUCCH or the PUSCH that includes the UCI which includes only the CSI in the SCG, the PUSCH that does not include the UCI in the MCG, the PUSCH that does not include the UCI in the SCG

In an example of a case where the priority level is configured with the higher layer signaling, the priority level is configured for the cell group, and the type of uplink channel and/or UCI. For example, the priority level of the type of uplink transmission is configured for each of the PUCCH for the MCG, the PUCCH for the SCG, the PUSCH that includes the UCI in the MCG, the PUSCH that includes the UCI in the SCG, the PUSCH that does not include the UCI in the MCG, and the PUSCH that does not include the UCI in the SCG

In an example of allocation of the residual power that is based on the priority level. The residual power is allocated to the cell group that includes a type of uplink transmission that has the highest priority level in each of the cell groups. Moreover, the power that is left after the allocation to the cell group that includes the type of uplink transmission which has the highest priority level is allocated to another cell group. Specific operation of the terminal apparatus 1 is as follows.

In an example of the allocation of the residual power that is based on the priority level, the residual power is allocated to the cell group that has the largest sum of parameters (points) which are based on the priority level.

In the example of the allocation of the residual power that is based on the priority level, the residual power is allocated to each of the cell groups according to a ratio that is determined based on a sum of parameters (points) that are based on the priority level. For example, when the sums of parameters (points) that are based on the priority level in the MCG and the SCG, respectively, are 15 and 5, 75% of the residual power is allocated to the MCG, and the 25% of the residual power is allocated to the SCG The parameters that are based on the priority level may be further determined based on the number of resource blocks that are allocated to the uplink transmission.

In the example of the allocation of the residual power that is based on the priority level, the residual power is allocated in order of decreasing the priority level of the type of uplink transmission. According to the priority level of the type of uplink transmission, this allocation is performed in such a manner as to exceed the priority level of the cell group. Specifically, the residual power is allocated in such a manner as to satisfy the request power for the type uplink transmission, in order of decreasing the priority level of the type of uplink transmission. Additionally, this allocation is performed on the presumption that in each of the cell groups, Pₚᵣₑ_{_}_{MeNB} and Pₚᵣₑ_{_}_{SeNB} are allocated to the type of uplink transmission which has a high priority level. Based on this presumption, the residual power is allocated to the type of uplink transmission that does not satisfy the request power, and then is allocated to the type of uplink transmission that has a high priority level.

In the example of the allocation of the residual power that is based on the priority level, the residual power is allocated in order of decreasing the priority level of the type of uplink transmission. According to the priority level of the type of uplink transmission, this allocation is performed in such a manner as to exceed the priority level of the cell group. Specifically, the residual power is allocated in such a manner as to satisfy the request power for the type uplink transmission, in order of decreasing the priority level of the type of uplink transmission. Additionally, this allocation is performed on the presumption that in each of the cell groups, Pₚᵣₑ_{_}_{MeNB} and Pₚᵣₑ_{_}_{SeNB} are allocated to the type of uplink transmission which has a low priority level. Based on this presumption, the residual power is allocated to the type of uplink transmission that does not satisfy the request power, and then is allocated to the type of uplink transmission that has a high priority level.

A different example of the allocation of the residual power that is based on the priority level is as follows. The terminal apparatus that communicates with the base station apparatus using a first cell group and a second cell group includes a transmission unit that transmits a channel and/or a signal based on a maximum output power in the first cell group in a certain subframe. In a case where information relating to the uplink transmission in the second cell group is recognized, the residual power is allocated based on the priority level of the type of uplink transmission. The residual power is given by subtracting the power that is determined based on the uplink transmission in the first cell group and the power that is determined based on the uplink transmission in the second cell group from a sum of the maximum output powers of the terminal apparatus. The maximum output power is a sum of the power that is determined based on the uplink transmission in the first cell group and the power that is allocated to the first cell group, of the residual power.

Furthermore, the residual power is allocated to cell groups, starting from the cell group in which the type of uplink transmission which is a high priority level is performed.

Furthermore, the residual power is allocated on the following presumption. The power that is determined based on the uplink transmission in the first cell group is allocated to the type of uplink transmission that has a high priority level within the first cell group. The power that is determined based on the uplink transmission in the second cell group is allocated to the type of uplink transmission that has a high priority level within the second cell group.

Furthermore, the residual power is allocated on the following presumption. The power that is determined based on the uplink transmission in the first cell group is allocated to the type of uplink transmission that has a low priority level within the first cell group. The power that is determined based on the uplink transmission in the second cell group is allocated to the type of uplink transmission that has a low priority level within the second cell group.

Furthermore, the residual power is allocated based on the sum of parameters that are determined based on the priority level of the type of uplink transmission in each of the cell groups.

An example of a specific method of allocating the guarantee power and the residual power (the remaining power) among cell groups (CGs) is as follows. When it comes to the power allocation among the CGs, the allocation of the guarantee power is performed in the first step, and the allocation of the remaining power is performed in the second step. The powers that are allocated in the first step are Pₚᵣₑ_{_}_{MeNB} and Pₚᵣₑ_{_}_{SeNB}. Sums of the power that is allocated in the first step and the power that is allocated in the second step are P_{alloc}_{_}_{MeNB} and P_{alloc}_{_}_{SeNB}. Moreover, the guarantee power is also referred to as a first reservation power, the power that is allocated in the first step, or a first allocation power. The remaining power is also referred to as a second reservation power, the power that is allocated in the second step, or a second allocation power.

An example of the allocation of the guarantee power follows the following rules.

(G1) For a certain CG (a first CG) (when determining the power that is allocated to a certain CG (the first CG)), if the terminal apparatus recognizes that the uplink transmission in another CG (a second CG) is not performed in a subframe that overlaps a subframe in this CG (the first CG)), at that time, the terminal apparatus does not reserve (does not allocate) the guarantee power for the allocation power in the other CG (the second CG).

(G2) In other cases, the terminal apparatus reserves (allocates) the guarantee power for the allocation power in the other CG (the second CG).

An example of the allocation of the remaining power follows the following rules.

(R1) For a certain CG (the first CG) (when determining the power that is allocated to a certain CG (the first CG)), if the terminal apparatus recognizes that the uplink transmission that has a higher priority level than the uplink transmission in the CG (the first CG) is performed in the other CG (the second CG), in the subframe that overlaps the subframe in the CG (the first CG), at that time, the terminal apparatus reserves the remaining power for the allocation power in the other CG (the second CG).

(R2) In other cases, the terminal apparatus allocates the remaining power to the CG (the first CG) and does not reserve the remaining power for the allocation power in the other CG (the second CG).

An example of the allocation of the guarantee power follows the following rules.

(G1) For a certain CG (the first CG) (when determining the power that is allocated to a certain CG (the first CG)), if the terminal apparatus does not recognize information relating to the uplink transmission in the other CG (the second CG), in the subframe that overlaps the subframe in the CG (the first CG), the terminal apparatus performs the following operations. Based on the information relating to the uplink transmission in the CG (the first CG), the terminal apparatus allocates the power (Pₚᵣₑ_{_}_{MeNB} or Pₚᵣₑ_{_}_{SeNB}) that is requested for the allocation power in the CG (the first CG). The terminal apparatus allocates the guarantee power (P_{MeNB} or P_{SeNB}) for the allocation power in the other CG (the second CG).

(G2) In other cases, the terminal apparatus performs the following operations. Based on the information relating to the uplink transmission in the CG (the first CG), the terminal apparatus allocates the power (Pₚᵣₑ_{_}_{MeNB} or Pₚᵣₑ_{_}_{SeNB}) that is requested for the allocation power in the CG (the first CG). Based on the information relating to the uplink transmission in the different CG (the second CG), the terminal apparatus allocates the power (Pₚᵣₑ_{_}_{MeNB} or Pₚᵣₑ_{_}_{SeNB}) that is requested for the allocation power in the other CG (the second CG).

An example of the allocation of the remaining power follows the following rules.

(R1) For a certain CG (the first CG) (when determining the power that is allocated to a certain CG (the first CG)), if the terminal apparatus does not recognize information relating to the uplink transmission in the other CG (the second CG), in the subframe that overlaps the subframe in the CG (the first CG), the terminal apparatus performs the following operations. The terminal apparatus allocates the remaining power to the allocation power in the CG (the first CG).

(R2) In other cases, the terminal apparatus allocates the remaining power to the allocation power in the CG (the first CG) and the allocation power in the other CG (the second CG), based on a prescribed method. As a specific method, the method that is described according to the present embodiment can be used.

An example of a definition (a calculation method) of the residual power is as follows. This example is a case where the terminal apparatus 1 recognizes the allocation of the uplink transmission to the subframe that overlaps in a different cell group.

In the subframe i that is illustrated in FIG. 10, the residual power that is calculated in a case where the allocation power (P_{alloc}_{_}_{MeNB}) for the MCG is computed is given by subtracting from P_{CMAX} the power (Pₚᵣₑ_{_}_{MeNB}) that is allocated in the first step in the subframe i in the MCG and the power relating to the subframe in the SCG that overlaps the subframe i in the MCG In FIG. 10, the overlapping subframes in the SCG are the subframe i−1 and the subframe i in the SCG The power relating to the subframe in the SCG is the largest of values, that is, the transmit power for the actual uplink transmission in the subframe i−1 in the SCG, and the power (Pₚᵣₑ_{_}_{SeNB}) that is allocated in the first step in the subframe i in the SCG

In the subframe i that is illustrated in FIG. 10, the residual power that is calculated in a case where the allocation power (P_{alloc}_{_}_{SeNB}) for the SCG is computed is given by subtracting from P_{CMAX} the power (Pₚᵣₑ_{_}_{SeNB}) that is allocated in the first step in the subframe i in the SCG and the power relating to the subframe in the MCG that overlaps the subframe i in the SCG In FIG. 10, the overlapping subframes in the MCG are the subframe i and the subframe i+1 in the MCG The power relating to the subframe in the MCG is the largest of values, that is, the transmit power for the actual uplink transmission in the subframe i in the MCG, and the power (Pₚᵣₑ_{_}_{MeNB}) that is allocated in the first step in the subframe i+1 in the MCG

A different example of the definition (the calculation method) of the residual power is as follows. This example is a case where the terminal apparatus 1 does not recognize the allocation of the uplink transmission to the subframe that overlaps in a different cell group.

In the subframe i that is illustrated in FIG. 10, the residual power that is calculated in a case where the allocation power (P_{alloc}_{_}_{MeNB}) for the MCG is computed is given by subtracting from P_{CMAX} the power (Pₚᵣₑ_{_}_{MeNB}) that is allocated in the first step in the subframe i in the MCG and the power relating to the subframe in the SCG that overlaps the subframe i in the MCG In FIG. 10, the overlapping subframes in the SCG are the subframe i−1 and the subframe i in the SCG The power relating to the subframe in the SCG is the largest of values, that is, the transmit power for the actual uplink transmission in the subframe i−1 in the SCG, and the guarantee power (P_{SeNB}) in the subframe i in the SCG

In the subframe i that is illustrated in FIG. 10, the residual power that is calculated in a case where the allocation power (P_{alloc}_{_}_{SeNB}) for the SCG is computed is given by subtracting from P_{CMAX} the power (Pₚᵣₑ_{_}_{SeNB}) that is allocated in the first step in the subframe i in the SCG and the power relating to the subframe in the MCG that overlaps the subframe i in the SCG In FIG. 10, the overlapping subframes in the MCG are the subframe i and the subframe i+1 in the MCG The power relating to the subframe in the MCG is the largest of values, that is, the transmit power for the actual uplink transmission in the subframe i in the MCG, and the guarantee power (P MeNB) in the subframe i+1 in the MCG

A different example of the definition (the calculation method) of the residual power is as follows. The terminal apparatus that communicates with the base station apparatus using the first cell group and the second cell group includes the transmission unit that transmits a channel and/or a signal based on the maximum output power in the first cell group in a certain subframe. In a case where information relating to uplink transmission in the second cell group in a rear subframe that overlaps the certain subframe is recognized, a maximum output power in the first cell group is a sum of a power that is determined based on the uplink transmission in the first cell group in the certain subframe and a power that is allocated to the first cell group, of a residual power. The residual power is given by subtracting the power that is determined based on the uplink transmission in the first cell group in the certain subframe and a power for the second cell group from a sum of maximum output powers of the terminal apparatus. The power for the second cell group is the largest of values, that is, an output power in the second cell group in a front subframe that overlaps the certain subframe, and a power that is determined based on the uplink transmission in the second cell group in the rear subframe that overlaps the certain subframe.

A different example of the definition (the calculation method) of the residual power is as follows. The terminal apparatus that communicates with the base station apparatus using the first cell group and the second cell group includes the transmission unit that transmits a channel and/or a signal based on the maximum output power in the first cell group in a certain subframe. In a case where information relating to uplink transmission in the second cell group in a rear subframe that overlaps the certain subframe is not recognized, the maximum output power in the first cell group is a sum of a power that is determined based on the uplink transmission in the first cell group in the certain subframe and a power that is allocated to the first cell group, of a residual power. The residual power is given by subtracting the power that is determined based on the uplink transmission in the first cell group in the certain subframe and a power for the second cell group from a sum of maximum output powers of the terminal apparatus. The power for the second cell group is the largest of values, that is, an output power in the second cell group in a front subframe that overlaps the certain subframe, and a guarantee power in the second cell group in the rear subframe that overlaps the certain subframe.

A different example of the definition (the calculation method) of the residual power is as follows. The terminal apparatus that communicates with the base station apparatus using the first cell group and the second cell group includes the transmission unit that transmits a channel and/or a signal based on the maximum output power in the first cell group in a certain subframe. In a case where information relating to uplink transmission in the second cell group in a rear subframe that overlaps the certain subframe is not recognized, the maximum output power in the first cell group is given by subtracting a power for the second cell group from a sum of maximum output powers of the terminal apparatus. The power for the second cell group is the largest of values, that is, an output power in the second cell group in a front subframe that overlaps the certain subframe, and a guarantee power in the second cell group in the rear subframe that overlaps the certain subframe.

Another method of allocating the guarantee power and the remaining power will be described below.

First, as a step (s1), a power value of the MCG and a power value of the SCG are initialized and the residual power (an unallocated residual power) is calculated. Furthermore, a residual guarantee power (the unallocated guarantee power) is initialized. More specifically, it is assumed that P_{MCG}=0, P_{SCG}=0, and P_{Remaining}=P_{CMAX}−P_{MeNB}−P_{SeNB}. Furthermore, it is assumed that P_{MeNB, Remaining}=P_{MeNB} and P_{SeNB, Remaining}=P_{SeNB}. At this point, P_{MCG} and P_{SCG} are the power value of the MCG and the power value of the SCG, respectively, and P_{Remaining} is a residual power value. P_{CMAX}, P_{MeNB}, and P_{SeNB} are the parameters described above. Furthermore, P_{MeNB, Remaining} and P_{SeNB, Remaining} are a value of a residual guarantee power of the MCG and a value of a residual guarantee power of the SCG, respectively. Moreover, at this point, each power value is linear.

Next, the residual power and the residual guarantee power are sequentially allocated to each CG, in this sequence: the PUCCH for the MCG, the PUCCH for the SCG, the PUSCH that includes the UCI in the MCG, the PUSCH that does not include the UCI in the MCG, the PUSCH that does not include the UCI in the SCG. At this time, in a case where the residual guarantee power is present, the residual guarantee power is previously allocated and after the residual guarantee power is absent, the residual guarantee power is allocated. Furthermore, an amount of power that is sequentially allocated to each CG is basically a power value (a power value that is based on a Transmit Power Control (TPC) command, a resource assignment, or the like) that is requested for each channel. However, in a case where the residual power or the residual guarantee power does not satisfy the power value that is requested, the entire residual power or the entire residual guarantee power is allocated. When the power is allocated to the CG, as much residual or residual guarantee power as the allocated power is reduced. Moreover, the allocation of the residual power or the residual guarantee power that has a value of 0 means that the residual power or the residual guarantee power is not allocated. As more specific steps of calculating the power value of every CG, (s2) to (s8) will be described below.

As a step (s2), the following arithmetic operation is performed. If there is the PUCCH transmission in the MCG (or if the terminal apparatus 1 recognizes that there is the PUCCH transmission in the MCG), the arithmetic operations, that is, P_{MCG}=P_{MCG}+δ₁+δ₂, P_{MeNB, Remaining}=P_{MeNB, Remaining}−δ₁, and P_{Remaining}=P_{Remaining}−δ₂, are performed. At this point, δ₁=min(P_{PUCCH, MCG}, P_{MeNB, Remaining}), and δ₂=min(P_{PUCCH, MCG}−δ₁, P_{Remaining}). That is, a power value that is requested for the PUCCH transmission is allocated from the residual guarantee power in the MCG to the MCG. At this time, in a case where the residual guarantee power in the MCG falls short of the power that is requested for the PUCCH transmission, the entire residual guarantee power is allocated to the MCG and then as much power as a power shortage is allocated from the residual power to the MCG. At this point, additionally, in the case where the residual power insufficiently falls short, the entire residual power is allocated to the MCG. The value of as much power as is allocated from the residual guarantee power or the residual power is added to the power value of the MCG The value of as much power as is allocated to the MCG is subtracted from the residual guarantee power or the residual power. Moreover, P_{PUCCH, MCG} is a power value that is requested for the PUCCH transmission in the MCG, and is calculated based on the parameter that is configured by the higher layer, the downlink path loss, the adjustment value that is determined by the UCI which is transmitted over the PUCCH, the adjustment value that is determined by the PUCCH format, the adjustment value that is determined by the number of antenna ports which are used for the PUCCH transmission, the value that is based on the TPC command, or the like.

As a step (s3), the following arithmetic operation is performed. If there is the PUCCH transmission in the SCG (or if the terminal apparatus 1 recognizes that there is the PUCCH transmission in the SCG), the arithmetic operations, that is, P_{SCG}=P_{SCG}+δ₁+δ₂, P_{SeNB, Remaining}=P_{SeNB, Remaining}−δ₁, and P_{Remaining}−P_{Remaining}−δ₂, are performed. At this point, δ₁=min(P_{PUCCH, SCG}, P_{SeNB, Remaining}), and δ2=min(P_{PUCCH, SCG}−δ₁, P_{Remaining}). That is, a power value that is requested for the PUCCH transmission is allocated from the residual guarantee power in the SCG to the SCG. At this time, in a case where the residual guarantee power in the SCG falls short of the power that is requested for the PUCCH transmission, the entire residual guarantee power is allocated to the SCG, and as much power as a power shortage is allocated from the residual power to the SCG. At this point, additionally, in the case where the residual power insufficiently falls short, the entire residual power is allocated to the SCG The value of as much power as is allocated from the residual guarantee power or the residual power is added to the power value of the SCG The value of as much power as is allocated to the SCG is subtracted from the residual guarantee power or the residual power. Moreover, P_{PUCCH, SCG} is a power value that is requested for the PUCCH transmission in the SCG, and is calculated based on the parameter that is configured by the higher layer, the downlink path loss, the adjustment value that is determined by the UCI which is transmitted over the PUCCH, the adjustment value that is determined by the PUCCH format, the adjustment value that is determined by the number of antenna ports which are used for the PUCCH transmission, the value that is based on the TPC command, or the like.

As a step (s4), the following arithmetic operation is performed. If there is the PUSCH transmission that includes the UCI in the MCG (or if the terminal apparatus 1 recognizes that there is the PUSCH transmission which includes the UCI in the MCG), the arithmetic operations, that is, P_{MCG}=P_{MCG}+δ₁+δ₂, P_{MeNB, Remaining}=P_{MeNB, Remaining}−δ₁, and P_{Remaining}=P_{Remaining}−δ₂, are performed. At this point, δ₁=min(P_{PUSCH, j, MCG}, P_{MeNB, Remaining}), and δ₂=min(P_{PUCCH, j, MCG}−δ1, P_{Remaining}). That is, a power value that is requested for the PUSCH transmission which includes the UCI is allocated from the residual guarantee power in the MCG to the MCG. At this time, in a case where the residual guarantee power in the MCG falls short of the power that is requested for the PUSCH transmission which includes the UCI, the entire residual guarantee power is allocated to the MCG and then as much power as a power shortage is allocated from the residual power to the MCG. At this point, additionally, in the case where the residual power insufficiently falls short, the entire residual power is allocated to the MCG The value of as much power as is allocated from the residual guarantee power or the residual power is added to the power value of the MCG The value of as much power as is allocated to the MCG is subtracted from the residual guarantee power or the residual power. Moreover, P_{PUSCH, j, MCG} is a power value that is requested for the PUSCH transmission which includes the UCI in the MCG, and is configured based on the parameter that is configured by the higher layer, an adjustment value that is determined by the number of PRBs which are allocated, by the resource assignment, for the PUSCH transmission, a downlink path loss and a coefficient by which the downlink path loss is multiplied, an adjustment value that is determined by a parameter which indicates an offset of the MCS, which is applied to the UCI, the value that is based on the TPC command, or the like.

As a step (s5), the following arithmetic operation is performed. If there is the PUSCH transmission that includes the UCI in the SCG (or if the terminal apparatus 1 recognizes that there is the PUSCH transmission which includes the UCI in the SCG), the arithmetic operations, that is, P_{SCG}=P_{SCG}+δ₁+δ₂, P_{SeNB, Remaining}=P_{SeNB, Remaining}−δ₁, and P_{Remaining}=P_{Remaining}−δ₂, are performed. At this point, δ₁=min(P_{PUSCH, j, SCG}, P_{SeNB, Remaining}), and δ2=min(P_{PUSCH, j, SCG}−δ₁, P_{Remaining}). That is, the power value that is requested for the PUSCH transmission which includes the UCI is allocated from the residual guarantee power in the SCG to the SCG. At this time, in a case where the residual guarantee power in the SCG falls short of the power that is requested for the PUSCH transmission which includes the UCI, the entire residual guarantee power is allocated to the SCG and then as much power as a power shortage is allocated from the residual power to the SCG. At this point, additionally, in the case where the residual power insufficiently falls short, the entire residual power is allocated to the SCG The value of as much power as is allocated from the residual guarantee power or the residual power is added to the power value of the SCG The value of as much power as is allocated to the SCG is subtracted from the residual guarantee power or the residual power. Moreover, P_{PUSCH, j, SCG} is a power value that is requested for the PUSCH transmission which includes the UCI in the SCG, and is configured based on the parameter that is configured by the higher layer, the adjustment value that is determined by the number of PRBs which are allocated, by the resource assignment, for the PUSCH transmission, the downlink path loss and the coefficient by which the downlink path loss is multiplied, the adjustment value that is determined by the parameter which indicates the offset of the MCS, which is applied to the UCI, the value that is based on the TPC command, or the like.

As a step (s6), the following arithmetic operation is performed. If there are one or more PUSCH transmissions (the PUSCH transmissions that do not include the UCI) in the MCG (or if the terminal apparatus 1 recognizes that there is the PUSCH transmission in the MCG), the arithmetic operations, that is, P_{MCG}=P_{MCG}+δ₁+δ₂, P^{MeNB, Remaining}=P_{MeNB, Remaining}−δ₁, and P_{Remaining}=P_{Remaining}−δ₂, are performed. At this point, δ₁=min (ΣP_{PUSCH, c, MCG}, P_{MeNB, Remaining}) and δ₂=min (ΣP_{PUSCH, c, MCG}−δ₁, P_{Remaining}). That is, a value of a sum of the power values that are requested for the PUSCH transmission is allocated from the residual guarantee power in the MCG to the MCG. At this time, in a case where the residual guarantee power in the MCG falls short of the value of a sum of the powers that are requested for the PUSCH transmission, the entire residual guarantee power is allocated to the MCG and then as much power as a power shortage is allocated from the residual power to the MCG. At this point, additionally, in the case where the residual power insufficiently falls short, the entire residual power is allocated to the MCG The value of as much power as is allocated from the residual guarantee power or the residual power is added to the power value of the MCG The value of as much power as is allocated to the MCG is subtracted from the residual guarantee power or the residual power. Moreover, P_{PUSCH, c, MCG} is a power value that is requested for the PUSCH transmission in the serving cell c that belongs to the MCG, and is calculated based on the parameter that is configured by the higher layer, the adjustment value that is determined by the number of PRBs which are allocated, by the resource assignment, for the PUSCH transmission, the downlink path loss and the coefficient by which the downlink path loss is multiplied, the value that is based on the TPC command, or the like. Furthermore, Σ means the sum, and ΣP_{PUSCH, c, MCG} indicates a sum value of P_{PUSCH, c, MCG} in a certain serving cell c, in which c≠j.

As a step (s7), the following arithmetic operation is performed. If there are one or more PUSCH transmissions (the PUSCH transmissions that do not include the UCI) in the SCG (or if the terminal apparatus 1 recognizes that there is the PUSCH transmission in the SCG), the arithmetic operations, that is, P_{SCG}=P_{SCG}+δ₁+δ₂, P_{SeNB, Remaining}=P_{SeNB, Remaining}−δ₁, and P_{Remaining}=P_{Remaining}−δ₂, are performed. At this point, δ₁=min (ΣP_{PUSCH, c, SCG}, P_{SeNB, Remaining}) and δ₂=min (ΣP_{PUSCH, c, SCG}−δ₁, P_{Remaining}). That is, the value of the sum of the power values that are requested for the PUSCH transmission is allocated from the residual guarantee power in the SCG to the SCG. At this time, in a case where the residual guarantee power in the SCG falls short of the value of the sum of the powers that are requested for the PUSCH transmission, the entire residual guarantee power is allocated to the SCG and then as much power as a power shortage is allocated from the residual power to the SCG. At this point, additionally, in the case where the residual power insufficiently falls short, the entire residual power is allocated to the SCG The value of as much power as is allocated from the residual guarantee power or the residual power is added to the power value of the SCG The value of as much power as is allocated to the SCG is subtracted from the residual guarantee power or the residual power. Moreover, P_{PUSCH, c, SCG} is a power value that is requested for the PUSCH transmission in the serving cell c that belongs to the SCG, and is calculated based on the parameter that is configured by the higher layer, the adjustment value that is determined by the number of PRBs which are allocated, by the resource assignment, for the PUSCH transmission, the downlink path loss and the coefficient by which the downlink path loss is multiplied, the value that is based on the TPC command, or the like. Furthermore, Σ means the sum, and ΣP_{PUSCH, c, SCG} indicates a sum value of P_{PUSCH, e, SCG} in the certain serving cell c, in which c≠j.

As a step (s8), the following arithmetic operation is performed. If the subframe that is the power calculation target is the subframe in the MCG, P_{CMAX, CG} that is the maximum output power value for the CG that is a target is set to P_{CMAX, CG}=P_{MCG}. In other cases, more precisely, if the subframe that is the power calculation target is the subframe in the SCG, P_{CMAX, CG} that is the maximum output power value for the CG that is a target is set to P_{CMAX, CG}=P_{SCG}.

In this manner, the maximum output power value in the CG that is a target can be calculated from the guarantee power and the residual power. Moreover, as initial values of the power value of the MCG, the power value of the SCG, the residual power, and the residual guarantee power in each of the steps described above, their respective final in the immediately preceding step are used.

Moreover, at this point, as the priority ranking for allocation, this sequence: the PUCCH for the MCG, the PUCCH for the SCG, the PUSCH that includes the UCI in the MCG, the PUSCH that does not include the UCI in the MCG, the PUSCH that does not include the UCI in the SCG is used, but no limitation this is imposed. Other priority ranking can be used. For example, this sequence: a channel in the MCG, which includes the HARQ-ACK, a channel in the SCG, which includes the HARQ-ACK, the PUSCH (which does not the HARQ-ACK) in the MCG, the PUSCH (which does not include the HARQ-ACK) in the SCG may be used. Furthermore, this sequence: a channel that includes the SR, the channel (which does not include the SR) that includes the HARQ-ACK, a channel (which does not include the SR or the HARQ-ACK) that includes the CSI, a channel (which does not include the UCI) that includes data may be used without a distinction between the MCG and the SCG In these cases, request power values may be replaced in step s2 to step s7, which are described above. In a case where multiple channels are targets in one step, a value of a sum of request powers for these channels may be used as in step s6 or step s7. Alternatively, a method such as one in which some of the steps described above are not performed can be used. Furthermore, in addition to the channels described above, the priority ranking may be performed considering the PRACH, the SRS, or the like. At this time, the PRACH may have a higher priority level than the PUCCH, and the SRS may have a lower priority level than the PUSCH (which does not include the UCI).

Another method of allocating the guarantee power and the remaining power will be described below.

First, as a step (t1), the power value of the MCG, the power value in the SCG, the residual power (the unallocated residual power), a total request power in the MCG, and a total request power in the SCG are initialized. More specifically, it is assumed that P_{MCG}=0, P_{SCG}=0, and P_{Remaining}=P_{c}. Furthermore, it is assumed that P_{MCG, Required}=0, and P_{SCG, Required}=P_{Required}=0. At this point, P_{MCG} and P_{SCG} are the power value of the MCG and the power value of the SCG, respectively, and P_{Remaining} is the residual power value. P_{CMAX}, P_{MeNB}, and P_{SeNB} are the parameters described above. Furthermore, P_{MCG, Required} and P_{SCG, Required} are a total request power value that is requested for transmitting a channel within the MCG and a total request power value that is requested for transmitting a channel within the SCG, respectively. Moreover, at this point, each power value is linear.

Next, the residual power is sequentially allocated to each CG, in this sequence: the PUCCH for the MCG, the PUCCH for the SCG, the PUSCH that includes the UCI in the MCG, the PUSCH that does not include the UCI in the MCG, the PUSCH that does not include the UCI in the SCG. At this time, the amount of power that is sequentially allocated to each CG is basically the power value (the power value that is based on the Transmit Power Control (TPC) command, the resource assignment, or the like) that is requested for each channel. However, in a case where the residual power does not satisfy the power value that is requested, the entire residual power is allocated. When the power is allocated to the CG, as much residual power as the allocated power is decreased. Furthermore, the power value that is requested for the channel is added to the total request power in this CG Moreover, the power value that is requested is added without depending on whether or not the residual power falls short of the power value that is requested. As more specific steps of calculating the power value of every CG, (t2) to (t9) will be described below.

As a step (t2), the following arithmetic operation is performed. If there is the PUCCH transmission in the MCG, the arithmetic operations, that is, P_{MCG}=P_{MCG}+δ, P_{MCG, Required}=P_{MCG, Required}−P_{PUCCH, MCG}, and P_{Remaining}=P_{Remaining}−δ, are performed. At this point, δ=min(P_{PUCCH, MCG}, P_{Remaining}). That is, the power value that is requested for the PUCCH transmission is allocated from the residual power to the MCG. At this time, in a case where the residual power falls short of the power that is requested for the PUCCH transmission, the entire residual power is allocated to the MCG The power value that is requested for the PUCCH transmission is added to a total request power value of the MCG The value of as much power as is allocated to the MCG is subtracted from the residual power.

As a step (t3), the following arithmetic operation is performed. If there is the PUCCH transmission in the SCG, the arithmetic operations, that is, P_{SCG}=P_{SCG}+δ, P_{SCG, Required}=P_{SCG, Required}−P_{PUCCH, SCG}, and P_{Remaining}=P_{Remaining}−δ, are performed. At this point, δ=min(P_{PUCCH, SCG}, P_{Remaining}). That is, the power value that is requested for the PUCCH transmission is allocated from the residual power to the SCG. At this time, in the case where the residual power falls short of the power that is requested for the PUCCH transmission, the entire residual power is allocated to the SCG The power value that is requested for the PUCCH transmission is added to a total request power value of the SCG The value of as much power as is allocated to the SCG is subtracted from the residual power.

As a step (t4), the following arithmetic operation is performed. If there is the PUSCH transmission that includes the UCI in the MCG, the arithmetic operations, that is, P_{MCG}=P_{MCG}+δ, P_{MCG, Required}=P_{MCG, Required}−P_{PUSCH, j, MCG}, and P_{Remaining}=P_{Remaining}−δ, are performed. At this point, δ=min(P_{PUSCH, j, MCG}, P_{Remaining}). That is, the power value that is requested for the PUSCH transmission which includes the UCI is allocated from the residual power to the MCG. At this time, in a case where the residual power falls short of the power that is requested for the PUSCH transmission which includes the UCI, the entire residual power is allocated to the MCG The power value that is requested for the PUSCH transmission that includes the UCI is added to the total request power value of the MCG The value of as much power as is allocated to the MCG is subtracted from the residual power.

As a step (t5), the following arithmetic operation is performed. If there is the PUSCH transmission that includes the UCI in the SCG, the arithmetic operations, that is, P_{SCG}=P_{SCG}+δ, P_{SCG, Required}=P_{SCG, Required}−P_{PUSCH, j, SCG}, and P_{Remaining}=P_{Remaining}−δ, are performed. At this point, 6=min(P_{PUSCH, j, SCG}, P_{Remaining}). That is, the power value that is requested for the PUSCH transmission which includes the UCI is allocated from the residual power to the SCG. At this time, in the case where the residual power falls short of the power that is requested for the PUSCH transmission which includes the UCI, the entire residual power is allocated to the SCG The power value that is requested for the PUSCH transmission that includes the UCI is added to the total request power value of the SCG The value of as much power as is allocated to the SCG is subtracted from the residual power.

As a step (t6), the following arithmetic operation is performed. If there are one or more PUSCH transmissions (one or more PUSCH transmissions that do not include the UCI) in the MCG, the arithmetic operations, that is, P_{MCG}=P_{MCG}+δ, P_{MCG, Required}=P_{MCG, Required}−ΣP_{PUSCH, c, MCG}, and P_{Remaining}=P_{Remaining}−δ, are performed. At this point, δ=min (ΣP_{PUSCH, c, MCG}, P_{Remaining}). That is, the value of the sum of the power values that are requested for the PUSCH transmission is allocated from the residual power to the MCG. At this time, in a case where the residual power falls short of the value of the sum of the powers that are requested for the PUSCH transmission, the entire residual power is allocated to the MCG The value of as much power as is allocated from the residual power is added to the power value of the MCG The value of the sum of the power values that are requested for the PUSCH transmission is added to the total request power value of the MCG The value of as much power as is allocated to the MCG is subtracted from the residual power.

As a step (t7), the following arithmetic operation is performed. If there are one or more PUSCH transmissions (one or more PUSCH transmissions that do not include the UCI) in the SCG, the arithmetic operations, that is, P_{SCG}=P_{SCG}+δ, P_{SCG, Required}=P_{SCG, Required}−ΣP_{PUSCH, c, SCG}, and P_{Remaining}=P_{Remaining}−δ, are performed. At this point, δ=min (ΣP_{PUSCH, c, SCG}, P_{Remaining}). That is, the value of the sum of the power values that are requested for the PUSCH transmission is allocated from the residual power to the SCG. At this time, in the case where the residual power falls short of the value of the sum of the powers that are requested for the PUSCH transmission, the entire residual power is allocated to the SCG The value of as much power as is allocated from the residual power is added to the power value of the SCG The value of the sum of the power values that are requested for the PUSCH transmission is added to the total request power value of the SCG The value of as much power as is allocated to the SCG is subtracted from the residual power.

As a step (t8), it is checked whether or not a power value that is allocated to each CG is equal to or greater than (falls below) the guarantee power. Furthermore, it is checked whether or not the power value that is allocated to each CG is consistent with (does not fall below) the total request power value (that is, whether or not a channel, the residual power value for which does not satisfy the request power value, is present within the channel within the CG). In a case where the power value is neither equal to nor greater than the guarantee power (falls below the guarantee power) in a certain CG (the CG1) and in a case where the power value is not consistent with the total request power value (falls below the total request power value), as much power as a power shortage is allocated from the power value that is allocated to a different CG (a CG2) to the CG (the CG1) that lacks the power. As much power as the power shortage is subtracted from the final power value of the different CG (CG2), and as a result, the final power value is a value that results from subtracting the guarantee power in the CG 1 from P_{CMAX}. Accordingly, in a case where the request power is satisfied in a certain CG, because the guarantee power may not be satisfied, the power can be efficiently used. As a more specific example, the arithmetic operations as in a step (t8-1) and a step (t8-2) are performed. As the step (t8-1), if P_{MCG}<P_{MeNB} and P_{MCG}<P_{MCG, Required}, setting to P_{MCG}=P_{MeNB} is accomplished, and setting to P_{SCG}=P_{CMAX}−P_{MCG} (more precisely, P_{SCG}=P_{CMAX}−P_{MeNB}) is accomplished. As the step (t8-2), if P_{SCG}<P_{SeNB} and P_{SCG}<P_{SCG} Required (alternatively, without a condition in the step (t8-1) being satisfied, if P_{SCG}<P_{SeNB} and P_{SCG}<P_{SCG, Required}), setting to P_{SCG}=P_{SeNB} is accomplished, and setting to P_{MCG}=P_{CMAX}−P_{SCG} (more precisely, P_{MCG}=P_{CMAX}−P_{SeNB}) is accomplished.

As a step (t9), the following arithmetic operation is performed. If the subframe that is the power calculation target is the subframe in the MCG, P_{CMAX, CG} that is the maximum output power value for the CG that is a target is set to P_{CMAX, CG}=P_{MCG}. In other cases, more precisely, if the subframe that is the power calculation target is the subframe in the SCG, P_{CMAX, CG} that is the maximum output power value for the CG that is a target is set to P_{CMAX, CG}=P_{SCG}.

In this manner, the maximum output power value in the CG that is a target can be calculated from the guarantee power and the residual power. Moreover, as initial values of the power value of the MCG, the power value of the SCG, the residual power, the total request power in the MCG, and the total request power in the SCG in each of the steps described above, their final values in the immediately preceding step are used.

Furthermore, instead of the step (t8), the following step (a step (t10)) may be performed. That is, it is checked whether or not the power value that is allocated to each CG is equal to or greater than (does not fall below) the guarantee power. In the case where the power value is neither equal to nor greater than the guarantee power (falls below the guarantee power) in a certain CG (the CG1), as much power as a power shortage is allocated from the power value that is allocated to a different CG (the CG2) to the CG (the CG1) that lacks the power. As much power as the power shortage is subtracted from the final power value of the different CG (CG2), and as a result, the final power value is the smaller of the value that results from subtracting the guarantee power in the CG 1 from P_{CMAX} and the total request power value of the CG 2. Accordingly, in each CG, because the guarantee power can be necessarily secured, stable communication can be performed. As a more specific example, the arithmetic operations as in a step (t10-1) and a step (t10-2) are performed. As the step (t10-1), if P_{MCG}<P_{MeNB}, setting to P_{MCG}=P_{MeNB} is accomplished, and setting to P_{SCG}=min(P_{SCG, Required}, P_{CMAX}−P_{MeNB}) is accomplished. As the step (t10-2), if P_{SCG}<P_{SeNB}, setting to P_{SCG}=P_{SeNB} is accomplished, and setting to P_{MCG}=min(P_{MCG, Required}, P_{CMAX}−P_{SeNB}) is accomplished.

Moreover, at this point, as the priority ranking for allocation, this sequence: the PUCCH for the MCG, the PUCCH for the SCG, the PUSCH that includes the UCI in the MCG, the PUSCH that does not include the UCI in the MCG, the PUSCH that does not include the UCI in the SCG is used, but no limitation this is imposed. Other priority ranking (for example, the priority ranking described above and the like) can be used.

The method of allocating the guarantee power and the remaining power for determining the maximum output power value of every CG has been described so far. Power distribution within the CG at less than the maximum output power value of every CG will be described below.

First, power distribution within the CG in a case where the dual connectivity is not configured is described.

In a case where it is thought that a total transmit power in the terminal apparatus 1 exceeds P_{CMAX}, the terminal apparatus 1 scales P_{PUSCH, c} in the serving cell c in a case where the condition that Σ(wP_{PUSCH, c}) (P_{CMAX}−P_{PUCCH}), is satisfied. At this point, w is a scaling factor (a coefficient by which the power value is multiplied) for the serving cell c, and is a value that is equal to or greater than 0 and equal to or smaller than 1. In a case where there is no PUCCH transmission, it is assumed that P_{PUCCH}=0.

In a case where the terminal apparatus 1 performs the PUSCH transmission that includes the UCI in a certain serving cell j and performs the PUSCH transmission that does not include the UCI in any one of the remaining serving cells, and in a case where it is thought that the total transmit power in the terminal apparatus 1 exceeds P_{CMAX}, the terminal apparatus 1 scales P_{PUSCH, c} in the serving cell c that does not include the UCI, in such a manner that the condition that Σ(wP_{PUSCH, c}) (P_{CMAX}−P_{PUSCH, j}) is satisfied. However, the left side is a total in the serving cell c other than the serving cell j. At this point, w is the scaling factor for the serving cell c that does not include the UCI. At this point, as long as a case where Σ(wP_{PUSCH, c})=0 and the total transmit power in the terminal apparatus 1 still exceeds P_{CMAX} does not take place, power scaling does not apply to the PUSCH that includes the UCI. However, w is a value that is common to each of the serving cells when w>0, but w may be 0 for a certain serving cell. At this time, this means that channel transmission in this serving cell is dropped.

In a case where the terminal apparatus 1 performs the concurrent transmission of the PUCCH and the PUSCH that includes the UCI in the certain serving cell j and performs the PUSCH transmission that does not include the UCI in any one of the remaining serving cells and in a case where it is thought that the total transmit power in the terminal apparatus 1 exceeds P_{CMAX}, the terminal apparatus 1 obtains P_{PUSCH, c} based on P_{PUSCH, j}=min(P_{PUSCH, j}, (P_{CMAX}−P_{PUCCH})) and Σ(wP_{PUSCH, c})≦(P_{CMAX}−P_{PUCCH}−P_{PUSCH, j}). That is, a power for the PUCCH is first reserved, and then a power for the PUSCH that includes the UCI is calculated from the remaining power. At this time, in a case where the remaining power is greater than a request power (P_{PUSCH, j} on the right side of the first equation) for the PUSCH that includes the UCI, the request power for the PUSCH that includes the UCI is assumed to be a power (P_{PUSCH, j} on the left side of the first equation, that is, an actual power value of the PUSCH that includes the UCI) for the PUSCH that includes the UCI, and in a case where the remaining power is smaller than or equal to the request power for the PUSCH that includes the UCI, the entire remaining power is assumed to be the power for the PUSCH that includes the UCI. The remaining power that results from deducting the power for the PUCCH and the power for the PUSCH that includes the UCI is allocated to the PUSCH that does not include the UCI.

At this time, the scaling is performed if need arises.

If multiple Timing Advance Groups (TAGs) are configured for the terminal apparatus 1 and the PUCCH/PUSCH transmission by the terminal apparatus 1 in the subframe i for a certain serving cell in one TAG overlaps some of the initial symbols for the PUSCH transmission in the subframe i+1 for a different serving cell in another TAG, the terminal apparatus 1 adjusts the total transmit power in the terminal apparatus 1 in such a manner that P_{CMAX} is not exceeded in any overlapping portion. At this point, the TAG is a group of serving cells for adjustment of an uplink transmission timing with respect to a downlink reception timing. One or more serving cells belong to one TAG, and a common adjustment is made to the one or more serving cells in the one TAG

If multiple TAGs are configured for the terminal apparatus 1 and the PUSCH transmission by the terminal apparatus 1 in the subframe i for a certain serving cell in one TAG overlaps some of the initial symbols for the PUCCH transmission in the subframe i+1 for a different serving cell in another TAG, the terminal apparatus 1 adjusts the total transmit power in the terminal apparatus 1 in such a manner that P_{CMAX} is not exceeded in any overlapping portion.

If multiple TAGs are configured for the terminal apparatus 1 and SRS transmission by the terminal apparatus 1 in one symbol in the subframe i for a certain serving cell in one TAG overlaps the PUCCH/PUSCH transmission in the subframe i or the subframe i+1 for a different serving cell in another TAG, the terminal apparatus 1 drops the SRS transmission if the total transmit power in the terminal apparatus 1 exceeds P_{CMAX} in any overlapping portion of the symbol.

If multiple TAGs and more than two serving cells are configured for the terminal apparatus 1 and the SRS transmission by the terminal apparatus 1 in one symbol in the subframe i for a certain serving cell overlaps the SRS transmission in the subframe i for a different serving cell and the PUCCH/PUSCH transmission in the subframe i or the subframe i+1 for a different serving cell, the terminal apparatus 1 drops the SRS transmission if the total transmit power in the terminal apparatus 1 exceeds P_{CMAX} in any overlapping portion of the symbol.

If multiple TAGs are configured for terminal apparatus 1, when performance of PRACH transmission in the secondary serving cell concurrently with the SRS transmission in a symbol in a subframe in a different serving cell that belongs to a different TAG is requested by the higher layer, the terminal apparatus 1 drops the SRS transmission if the total transmit power in the terminal apparatus 1 exceeds P_{CMAX} in any overlapping portion of the symbol. At this point, the PRACH transmission may have the same meaning as preamble communication, preamble sequence communication, and the random access preamble communication. More precisely, the preamble communication may be referred to as the PRACH transmission.

If multiple TAGs are configured for terminal apparatus 1, when the performance of the PRACH transmission in the secondary serving cell concurrently with the PUSCH/PUCCH transmission in a subframe in a different serving cell that belongs to a different TAG is requested by the higher layer, the terminal apparatus 1 adjusts the transmit power for the PUSCH/PUCCH in such a manner that the total transmit power in the terminal apparatus 1 does not exceed P_{CMAX} in any overlapping portion.

Next, power distribution within the CG in a case where the dual connectivity is configured is described.

In a case where it is thought that the total transmit power in the terminal apparatus 1 in a certain CG exceeds P_{CMAX}, CG, the terminal apparatus 1 scales P_{PUSCH, c} in the serving cell c in the CG, in such a manner that the condition that P_{PUCCH}=min (P_{PUCCH}, P_{CMAX, CG}) and Σ(wP_{PUSCH, c})≦(P_{CMAX, CG}−P_{PUCCH}) is satisfied. That is, in a case where the maximum output power value of the CG is greater than a request power (P_{PUCCH} on the right side of the first equation) for the PUCCH, the request power for the PUCCH is set as the power (P_{PUCCH} on the left side of the first equation, that is, an actual power value of the PUCCH) for the PUCCH, and in a case where the maximum output power value of the CG is smaller than or equal to the request power for the PUCCH, all maximum output power values of the CG are set as the power for the PUCCH. A power that results from deducting the power for the PUCCH from P_{CMAX, CG} is allocated to the PUSCH. At this time, the scaling is performed if need arises. In a case where there is no PUCCH transmission in the CG, it is assumed that P_{PUCCH}=0. Moreover, P_{PUCCH} on the right side of the second equation is P_{PUCCH} that is calculated in the first equation.

In a case where the terminal apparatus 1 performs the PUSCH transmission that includes the UCI in the certain serving cell j in a certain CG and performs the PUSCH transmission that does not include the UCI in any one of the remaining serving cells in the CG, and in a case where it is thought that the total transmit power in the terminal apparatus 1 in the CG exceeds P_{CMAX, CG}, the terminal apparatus 1 scales P_{PUSCH, c} in the serving cell c that does not include the UCI, in such a manner that the condition that P_{PUSCH, j}=min(P_{PUSCH, j}, (P_{CMAX, CG}−P_{PUCCH})) and Σ(wP_{PUSCH, c})≦(P_{CMAX, CG}−P_{PUSCH},j) is satisfied. However, the left side of the second equation is a total in the serving cell c other than the serving cell j. Moreover, P_{PUSCH,j} on the right side of the second equation is P_{PUSCH, j} that is calculated in the first equation.

In a case where in a certain CG, the terminal apparatus 1 performs the concurrent transmission of the PUCCH and the PUSCH that includes the UCI in the certain serving cell j and performs the PUSCH transmission that does not include the UCI in any one of the remaining serving cells and in a case where it is thought that the total transmit power in the terminal apparatus 1 in the CG exceeds P_{CMAX, CG}, the terminal apparatus 1 obtains P_{PUSCH, c} based on P_{PUCCH}=min(P_{PUCCH}, P_{CMAX, CG}), P_{PUSCH, j},=min(P_{PUSCH, j}, (P_{CMAX, CG}−P_{PUCCH})), and Σ(wP_{PUSCH, c})≦(P_{CMAX, CG}−P_{PUCCH}−P_{PUSCH, j}). That is, the power for the PUCCH is first reserved from the maximum output power in the CG, and then the power for the PUSCH that includes the UCI is calculated from the remaining power. At this time, in a case where the maximum output power the CG is greater than the request power for the PUCCH, the request power for the PUCCH is set as the transmit power for the PUCCH, and in a case where the maximum output power value of the CG is smaller than or equal to the request power for the PUCCH, the maximum output power in the CG is set as the transmit power for the PUCCH. In the same time, in the case where the remaining power is greater than the request power for the PUSCH that includes the UCI, the request power for the PUSCH that includes the UCI is assumed to be the transmit power for the PUSCH that includes the UCI, and in the case where the remaining power is smaller than or equal to the request power for the PUSCH that includes the UCI, the entire remaining power is assumed to be the transmit power for the PUSCH that includes the UCI. The remaining power that results from deducting the power for the PUCCH and the power for the PUSCH that includes the UCI is allocated to the PUSCH that does not include the UCI. At this time, the scaling is performed if need arises.

With regard to the power adjustment or the dropping of the SRS in a case where multiple TAGs are configured, the same processing as in a case where the dual connectivity is not configured may be performed. In this case, it is preferable that the same processing is performed on multiple TAGs within the CG and the same processing is performed on multiple TAGs in a different CG as well. Alternatively, processing that will be described below may be performed. Furthermore, both of these may be performed.

If multiple TAGs within one CG are configured for the terminal apparatus 1 and the PUCCH/PUSCH transmission by the terminal apparatus 1 in the subframe i for a certain serving cell in one TAG within the CG overlaps some of the initial symbols for the PUSCH transmission in the subframe i+1 for a different serving cell in another TAG within the CG, the terminal apparatus 1 adjusts the total transmit power in the terminal apparatus 1 in such a manner that P_{CMAX, CG} of the CG is not exceeded in any overlapping portion.

If multiple TAGs within one CG are configured for the terminal apparatus 1 and the PUSCH transmission by the terminal apparatus 1 in the subframe i for a certain serving cell in one TAG within the CG overlaps some of the initial symbols for the PUCCH transmission in the subframe i+1 for a different serving cell in another TAG within the CG, the terminal apparatus 1 adjusts the total transmit power in the terminal apparatus 1 in such a manner that P_{CMAX, CG} of the CG is not exceeded in any overlapping portion.

If multiple TAGs within one CG are configured for the terminal apparatus 1 and the SRS transmission by the terminal apparatus 1 in one symbol in the subframe i for a certain serving cell in one TAG within the CG overlaps the PUCCH/PUSCH transmission in the subframe i or the subframe i+1 for a different serving cell in another TAG within the CG, the terminal apparatus 1 drops the SRS transmission if the total transmit power in the terminal apparatus 1 exceeds P_{CMAX, CG} of the CG in any overlapping portion of the symbol.

If multiple TAGs and more than two serving cells within one CG are configured for the terminal apparatus 1 and the SRS transmission by the terminal apparatus 1 in one symbol in the subframe i for a certain serving cell within the CG overlaps the SRS transmission in the subframe i for a different serving cell within the CG and the PUCCH/PUSCH transmission in the subframe i or the subframe i+1 for a different serving cell within the CG, the terminal apparatus 1 drops the SRS transmission if the total transmit power in the terminal apparatus 1 exceeds P_{CMAX, CG} of the CG in any overlapping portion of the symbol.

If multiple TAGs within one CG are configured for terminal apparatus 1, when performance of the PRACH transmission in the secondary serving cell within the CG concurrently with the SRS transmission in a symbol in a subframe in a different serving cell that belongs to a different TAG within the CG is requested by the higher layer, the terminal apparatus 1 drops the SRS transmission if the total transmit power in the terminal apparatus 1 exceeds P_{CMAX, CG} of the CG in any overlapping portion of the symbol.

If multiple TAGs within one CG are configured for terminal apparatus 1, when the performance of the PRACH transmission in the secondary serving cell within the CG concurrently with the PUSCH/PUCCH transmission in a subframe in a different serving cell that belongs to a different TAG within the CG is requested by the higher layer, the terminal apparatus 1 adjusts the transmit power for the PUSCH/PUCCH in such a manner that the total transmit power in the terminal apparatus 1 does not exceed P_{CMAX, CG} of the CG in any overlapping portion.

In this manner, even in a case where the dual connectivity is configured, control of the transmit power can be efficiently performed among the cell groups.

The case where the request power for every channel is first calculated, next the maximum output power is calculated for every CG, and lastly, the power scaling is performed within the CG is described above. At this point, the guarantee power and a priority level rule are used for the calculation of the maximum output power for every CG Furthermore, the power scaling within the CG applies in a case where the calculated maximum output power for every CG is exceeded.

In contrast, a case where the request power for every channel is first calculated, next the power scaling is performed within the CG, and lastly, allocation of the residual power between the CGs is performed is described below. At this point, when it comes to the power scaling within the CG, the power scaling method described above applies in a case where the calculated guarantee power for every CG is exceeded. Furthermore, the same priority level rule as described above is used for the allocation of the residual power between the CGs.

First, the power scaling in the MCG in a case where the dual connectivity is configured is described. In a case where it is thought that the total request power in the MCG exceeds P_{pre, MeNB}, the power scaling applies. Calculation for the power scaling in the MCG is performed in a case where a subframe that is a power calculation target is a subframe in the MCG, in case where the subframe that is the power calculation target is a subframe in the SCG and the subframe in the MCG and the subframe in the SCG are synchronized to each other (in a case where reception timing between subframes is at or below a value that is determined in advance (or is below the value)), or in a case where the subframe that is the power calculation target is the subframe in the SCG and, in an MCG subframe (a subframe that overlaps the front half and a subframe that overlaps the rear half) that overlaps the subframe in the SCG which is the power calculation target, the request power can be calculated (that is, in a case where the terminal apparatus 1 knows a power value that is requested for the uplink transmission in the MCG subframe).

At this point, P_{pre, MeNB} is a provisional (in the previous step) total power value for the MCG, which is allocated in the step. In a case where the terminal apparatus 1 knows (can calculate) the total request power (a sum of the request power values for every channel/signal, which are calculated P_{CMAX, c}, the TPC command, or the resource assignment, for example, a value of a sum of P_{PUCCH}, P_{PUSCH}, and P_{SRS}) in the subframe in the MCG, P_{pre, MeNB} can take the smaller (a minimum value) of values, that is, the total request value and guarantee power P_{MeNB}, or can take a minimum value. Alternatively, in a case where the subframe in the MCG and the subframe in the SCG are synchronized with each other, P_{pre, MeNB} can take the smaller of the values, that is, the total request value and guarantee power P_{MeNB}. On the other hand, in a case where the terminal apparatus 1 does not know (has difficulty in calculating) the total request power in the subframe in the MCG, P_{pre, MeNB} can take guarantee power P_{MeNB}. Alternatively, in a case where the subframe in the MCG and the subframe in the SCG are synchronized with each other, if the subframe in the MCG is transmitted at a later point in time than the subframe in the SCG, P_{pre, MeNB} can take a value, guarantee power P_{MeNB}.

If it is thought that the total transmit power in the MCG in the terminal apparatus 1 exceeds P_{pre, MeNB} (or P_{MeNB}), the terminal apparatus 1 scales P_{PUSCH, c} in the serving cell c in such a manner that the condition that Σ(wP_{PUSCH, c})≦(P_{pre, MeNB}−P_{PUCCH}) (or the condition that Σ(wP_{PUSCH, c})≦(P_{MeNB}−P_{PUCCH})) is satisfied. At this point, w is a scaling factor (a coefficient by which the power value is multiplied) for the serving cell c, and is a value that is equal to or greater than 0 and equal to or smaller than 1. P_{PUSCH, c} is a power that is requested for the PUSCH transmission in the serving cell c. P_{PUCCH} is a power that is requested for the PUCCH transmission in the CG (more precisely, the MCG), and in a case where there is no PUCCH transmission the CG, it is assumed that P_{PUCCH}=0. At this point, as long as Σ(wP_{PUSCH, c})=0 and the total transmit power of the terminal apparatus 1 still does not exceed P_{pre, MeNB} (or P_{MeNB}), the power scaling does not apply to the PUCCH. Conversely, in a case where Σ(wP_{PUSCH, c})=0 and the total transmit power of the terminal apparatus 1 still exceeds P_{MeNB}, the power scaling applies to the PUCCH.

In a case where the terminal apparatus 1 performs the PUSCH transmission that includes the UCI in the certain serving cell j and performs the PUSCH transmission that does not include the UCI in any one of the remaining serving cells, and in a case where it is thought that the total transmit power in the terminal apparatus 1 in the MCG exceeds P_{pre, MeNB} (or P_{MeNB}), the terminal apparatus 1 scales P_{PUSCH, c} in the serving cell c that does not include the UCI, in such a manner that the condition that Σ(wP_{PUSCH, c})≦(P_{pre, MeNB}−P_{PUSCH, j}) (or the condition that Σ(wP_{PUSCH, c})≦(P_{MeNB}−P_{PUSCH, j})) is satisfied. However, the left side is a total in the serving cell c other than the serving cell j. At this point, w is the scaling factor for the serving cell c that does not include the UCI. At this point, as long as Σ(wP_{PUSCH, c})=0 and the total transmit power of the terminal apparatus 1 still does not exceed P_{pre, MeNB} (or P_{MeNB}), the power scaling does not apply to the PUSCH that includes the UCI. Conversely, in a case where Σ(wP_{PUSCH, c})=0 and the total transmit power of the terminal apparatus 1 still exceeds P_{pre, MeNB} (or P_{MeNB}), the power scaling applies to the PUSCH that includes the UCI. However, w is a value that is common to each of the serving cells when w>0, but w may be 0 for a certain serving cell. At this time, this means that channel transmission in this serving cell is dropped.

In a case where the terminal apparatus 1 performs the concurrent transmission of the PUCCH and the PUSCH that includes the UCI in the certain serving cell j and performs the PUSCH transmission that does not include the UCI in any one of the remaining serving cells and in a case where it is thought that the total transmit power in the terminal apparatus 1 in the MCG exceeds P_{pre, MeNB} (or P_{MeNB}), the terminal apparatus 1 obtains P_{PUSCH, c} based on P_{PUSCH, j}=min(P_{PUSCH, j}, (P_{pre, MeNB}−P_{PUCCH})) and Σ(wP_{PUSCH, c})≦(P_{pre, MeNB}−P_{PUCCH}−P_{PUSCH, j}) (or based on P_{PUSCH, j}=min(P_{PUSCH, j}, (P_{MeNB}−P_{PUCCH})) and Σ(wP_{PUSCH, c})≦(P_{MeNB}−P_{PUCCH}−P_{PUSCH, j})). That is, the power for the PUCCH is first reserved, and then the power for the PUSCH that includes the UCI is calculated from the remaining power. At this time, in a case where P_{pre, MeNB} (or P_{MeNB}) is smaller than or equal to the request power for the PUCCH, all P_{pre, MeNB}′s (or P_{MeNB}′s) are assumed to be the powers for the PUCCH. In the case where the remaining power is greater than the request power (P_{PUSCH,j} on the right side of the first equation) for the PUSCH that includes the UCI, the request power for the PUSCH that includes the UCI is assumed to be the power (P_{PUSCH, j} on the left side of the first equation, that is, the actual power value of the PUSCH that includes the UCI) for the PUSCH that includes the UCI, and in the case where the remaining power is smaller than or equal to the request power for the PUSCH that includes the UCI, the entire remaining power is assumed to be the power for the PUSCH that includes the UCI. The remaining power that results from deducting the power for the PUCCH and the power for the PUSCH that includes the UCI is allocated to the PUSCH that does not include the UCI. At this time, the scaling is performed if need arises.

If multiple Timing Advance Groups (TAGs) in the MCG are configured for the terminal apparatus 1 and the PUCCH/PUSCH transmission by the terminal apparatus 1 in the subframe i for a certain serving cell in one TAG overlaps some of the initial symbols for the PUSCH transmission in the subframe i+1 for a different serving cell in another TAG, the terminal apparatus 1 adjusts the total transmit power in the terminal apparatus 1 in the MCH in such a manner that P_{pre, MeNB} (or P_{MeNB}) is not exceeded in any overlapping portion. At this point, the TAG is a group of serving cells for adjustment of an uplink transmission timing with respect to a downlink reception timing. One or more serving cells belong to one TAG, and a common adjustment is made to the one or more serving cells in the one TAG

If multiple TAGs in the MCG are configured for the terminal apparatus 1 and the PUSCH transmission by the terminal apparatus 1 in the subframe i for a certain serving cell in one TAG overlaps some of the initial symbols for the PUCCH transmission in the subframe i+1 for a different serving cell in another TAG, the terminal apparatus 1 adjusts the total transmit power in the terminal apparatus 1 in the MCG in such a manner that P_{pre, MeNB} (or P_{MeNB}) is not exceeded in any overlapping portion.

If multiple TAGs in the MCG are configured for the terminal apparatus 1 and SRS transmission by the terminal apparatus 1 in one symbol in the subframe i for a certain serving cell in one TAG overlaps the PUCCH/PUSCH transmission in the subframe i or the subframe i+1 for a different serving cell in another TAG, the terminal apparatus 1 drops the SRS transmission if the total transmit power in the terminal apparatus 1 in the MCG exceeds P_{pre, MeNB} (or P_{MeNB}) in any overlapping portion of the symbol.

If multiple TAGs in the MCG and more than two serving cells are configured for the terminal apparatus 1 and the SRS transmission by the terminal apparatus 1 in one symbol in the subframe i for a certain serving cell overlaps the SRS transmission in the subframe i for a different serving cell and the PUCCH/PUSCH transmission in the subframe i or the subframe i+1 for a different serving cell, the terminal apparatus 1 drops the SRS transmission if the total transmit power in the terminal apparatus 1 in the MCG exceeds P_{pre, MeNB} (or P_{MeNB}) in any overlapping portion of the symbol.

If multiple TAGs in the MCG are configured for terminal apparatus 1, when performance of the PRACH transmission in the secondary serving cell concurrently with the SRS transmission in a symbol in a subframe in a different serving cell that belongs to a different TAG is requested by the higher layer, the terminal apparatus 1 drops the SRS transmission if the total transmit power in the terminal apparatus 1 in the MCG exceeds P_{pre, MeNB} (or P_{MeNB}) in any overlapping portion of the symbol.

If multiple TAGs in the MCG are configured for terminal apparatus 1, when the performance of the PRACH transmission in the secondary serving cell concurrently with the PUSCH/PUCCH transmission in a subframe in a different serving cell that belongs to a different TAG is requested by the higher layer, the terminal apparatus 1 adjusts the transmit power for the PUSCH/PUCCH in such a manner that the total transmit power in the terminal apparatus 1 in the MCG does not exceed P_{pre, MeNB} (or P_{MeNB}) in any overlapping portion.

Next, the power scaling in the SCG is described. In a case where it is thought that the total request power in the SCG exceeds P_{pre, SeNB} (or P_{SeNB}), the power scaling applies. Calculation for the power scaling in the SCG is performed in a case where a subframe that is a power calculation target is a subframe in the SCG, in case where the subframe that is the power calculation target is a subframe in the MCG and the subframe in the MCG and the subframe in the SCG are synchronized to each other (in the case where the reception timing between subframes is at or below the value that is determined in advance (or is below the value)), or in a case where the subframe that is the power calculation target is the subframe in the MCG and, in an SCG subframe (the subframe that overlaps the front half and the subframe that overlaps the rear half) that overlaps the subframe in the MCG which is the power calculation target, the request power can be calculated (that is, in a case where the terminal apparatus 1 knows a power value that is requested for the uplink transmission in the SCG subframe).

At this point, P_{pre, SeNB} is a provisional (in the previous step) total power value for the SCG, which is allocated in the step. In a case where the terminal apparatus 1 knows (can calculate) the total request power (a sum of the request power values for every channel/signal, which are calculated P_{CMAX, c}, the TPC command, or the resource assignment, for example, a value of a sum of P_{PUCCH}, P_{PUSCH}, and P_{SRS}) in the subframe in the SCG, P_{pre, SeNB} can take the smaller of values, that is, the total request value and guarantee power P_{SeNB}, or can take a minimum value. Alternatively, in a case where the subframe in the MCG and the subframe in the SCG are synchronized with each other, P_{pre, SeNB} can take the smaller of the values, that is, the total request value and guarantee power P_{MeNB}. On the other hand, in a case where the terminal apparatus 1 does not know (has difficulty in calculating) the total request power in the subframe in the SCG, P_{pre, SeNB} can take guarantee power PSeNB. Alternatively, in the case where the subframe in the MCG and the subframe in the SCG are synchronized with each other, if the subframe in the SCG is transmitted at a later point in time than the subframe in the MCG, P_{pre, SeNB} can take a value, guarantee power P_{SeNB}.

If it is thought that the total transmit power in the SCG in the terminal apparatus 1 exceeds P_{pre, SeNB} (or P_{SeNB}) the terminal apparatus 1 scales P_{PUSCH, c} in the serving cell c in such a manner that the condition that Σ(wP_{PUSCH, c})≦(P_{pre, SeNB}−P_{PUCCH}) (or a condition that Σ(wP_{PUSCH, c})≦(P_{SeNB}−P_{PUCCH})) is satisfied. At this point, w is a scaling factor (a coefficient by which the power value is multiplied) for the serving cell c, and is a value that is equal to or greater than 0 and equal to or smaller than 1. P_{PUSCH, c} is a power that is requested for the PUSCH transmission in the serving cell c. P_{PUCCH} is a power that is requested for the PUCCH transmission in the CG (more precisely, the SCG), and in a case where there is no PUCCH transmission the CG, it is assumed that P_{PUCCH}=0. At this point, as long as Σ(wP_{PUSCH, c})=0 and the total transmit power of the terminal apparatus 1 in the SCG still does not exceed P_{pre, SeNB} (or P_{SeNB}), the power scaling does not apply to the PUCCH. Conversely, in a case where Σ(wP_{PUSCH, c})=0 and the total transmit power of the terminal apparatus 1 in the SCG still exceeds P_{pre, SeNB} (or P_{SeNB}), the power scaling applies to the PUCCH.

In the case where the terminal apparatus 1 performs the PUSCH transmission that includes the UCI in the certain serving cell j and performs the PUSCH transmission that does not include the UCI in any one of the remaining serving cells, and in a case where it is thought that the total transmit power in the terminal apparatus 1 in the SCG exceeds P_{pre, SeNB} (or P_{SeNB}), the terminal apparatus 1 scales P_{PUSCH, c} in the serving cell c that does not include the UCI, in such a manner that the condition that Σ(wP_{PUSCH, c})≦(P_{pre, SeNB}−P_{PUSCH, j}) (or the condition that Σ(wP_{PUSCH, c})≦(P_{SeNB}−P_{PUSCH, j})) is satisfied. However, the left side is a total in the serving cell c other than the serving cell j. At this point, w is the scaling factor for the serving cell c that does not include the UCI. At this point, as long as Σ(wP_{PUSCH, c})=0 and the total transmit power of the terminal apparatus 1 in the SCG still does not exceed P_{pre, SeNB} (or P_{SeNB}), the power scaling does not apply to the PUSCH that includes the UCI. Conversely, in the case where Σ(wP_{PUSCH, c})=0 and the total transmit power of the terminal apparatus 1 in the SCG still exceeds P_{pre, SeNB} (or P_{SeNB}), the power scaling applies to the PUSCH that includes the UCI. However, w is a value that is common to each of the serving cells when w>0, but w may be 0 for a certain serving cell. At this time, this means that channel transmission in this serving cell is dropped.

In the case where the terminal apparatus 1 performs the concurrent transmission of the PUCCH and the PUSCH that includes the UCI in the certain serving cell j and performs the PUSCH transmission that does not include the UCI in any one of the remaining serving cells and in a case where it is thought that the total transmit power in the terminal apparatus 1 in the SCG exceeds P_{pre, SeNB} (or P_{SeNB}), the terminal apparatus 1 obtains P_{PUSCH, c} based on P_{PUSCH, j}=min(P_{PUSCH, j}, (P_{pre, SeNB}−P_{PUCCH})) and Σ(wP_{PUSCH, c})≦(P_{pre, SeNB} P_{PUCCH}−P_{PUSCH, j}) (or based on P_{PUSCH, j}=min(P_{PUSCH,j}, (P_{SeNB}−P_{PUCCH})) and Σ(wP_{PUSCH, c})≦(P_{SeNB}−P_{PUCCH}−P_{PUSCH, j})). That is, the power for the PUCCH is first reserved, and then the power for the PUSCH that includes the UCI is calculated from the remaining power. At this time, in a case where P_{pre, SeNB} (or P_{SeNB}) is smaller than or equal to the request power for the PUCCH, all P_{pre, SeNB}′S (or P_{SeNB}'s) are assumed to be the powers for the PUCCH. In the case where the remaining power is greater than the request power (P_{PUSCH, j} on the right side of the first equation) for the PUSCH that includes the UCI, the request power for the PUSCH that includes the UCI is assumed to be the power (P_{PUSCH, j} on the left side of the first equation, that is, the actual power value of the PUSCH that includes the UCI) for the PUSCH that includes the UCI, and in the case where the remaining power is smaller than or equal to the request power for the PUSCH that includes the UCI, the entire remaining power is assumed to be the power for the PUSCH that includes the UCI. The remaining power that results from deducting the power for the PUCCH and the power for the PUSCH that includes the UCI is allocated to the PUSCH that does not include the UCI. At this time, the scaling is performed if need arises.

If multiple Timing Advance Groups (TAGs) in the SCG are configured for the terminal apparatus 1 and the PUCCH/PUSCH transmission by the terminal apparatus 1 in the subframe i for a certain serving cell in one TAG overlaps some of the initial symbols for the PUSCH transmission in the subframe i+1 for a different serving cell in another TAG, the terminal apparatus 1 adjusts the total transmit power in the terminal apparatus 1 in the SCG in such a manner that P_{pre, SeNB} (or P_{SeNB}) is not exceeded in any overlapping portion. At this point, the TAG is a group of serving cells for adjustment of an uplink transmission timing with respect to a downlink reception timing. One or more serving cells belong to one TAG, and a common adjustment is made to the one or more serving cells in the one TAG

If multiple TAGs in the SCG are configured for the terminal apparatus 1 and the PUSCH transmission by the terminal apparatus 1 in the subframe i for a certain serving cell in one TAG overlaps some of the initial symbols for the PUCCH transmission in the subframe i+1 for a different serving cell in another TAG, the terminal apparatus 1 adjusts the total transmit power in the terminal apparatus 1 in the SCG in such a manner that P_{pre, SeNB} (or P_{SeNB}) is not exceeded in any overlapping portion.

If multiple TAGs in the SCG are configured for the terminal apparatus 1 and SRS transmission by the terminal apparatus 1 in one symbol in the subframe i for a certain serving cell in one TAG overlaps the PUCCH/PUSCH transmission in the subframe i or the subframe i+1 for a different serving cell in another TAG, the terminal apparatus 1 drops the SRS transmission if the total transmit power in the terminal apparatus 1 in the SCG exceeds P_{pre, SeNB} (or P_{SeNB}) in any overlapping portion of the symbol.

If multiple TAGs in the SCG and more than two serving cells are configured for the terminal apparatus 1 and the SRS transmission by the terminal apparatus 1 in one symbol in the subframe i for a certain serving cell overlaps the SRS transmission in the subframe i for a different serving cell and the PUCCH/PUSCH transmission in the subframe i or the subframe i+1 for a different serving cell, the terminal apparatus 1 drops the SRS transmission if the total transmit power in the terminal apparatus 1 in the SCG exceeds P_{pre, SeNB} (or P_{SeNB}) in any overlapping portion of the symbol.

If multiple TAGs in the SCG are configured for terminal apparatus 1, when performance of the PRACH transmission in the secondary serving cell concurrently with the SRS transmission in a symbol in a subframe in a different serving cell that belongs to a different TAG is requested by the higher layer, the terminal apparatus 1 drops the SRS transmission if the total transmit power in the terminal apparatus 1 in the SCG exceeds P_{pre, SeNB} (or P_{SeNB}) in any overlapping portion of the symbol.

If multiple TAGs in the SCG are configured for terminal apparatus 1, when the performance of the PRACH transmission in the secondary serving cell concurrently with the PUSCH/PUCCH transmission in a subframe in a different serving cell that belongs to a different TAG is requested by the higher layer, the terminal apparatus 1 adjusts the transmit power for the PUSCH/PUCCH in such a manner that the total transmit power in the terminal apparatus 1 in the SCG does not exceed P_{pre, SeNB} (or P_{SeNB}) in any overlapping portion.

In a subsequent step, the residual power (for example, the remaining power that results from subtracting P_{pre, MeNB} and P_{pre, SeNB} from P_{CMAX}) in the previous step is distributed among the CGS. At this time, in the previous step, in the prescribed order of priority levels, the distribution is made to a channel/signal on which the power scaling is performed. At this time, in the previous step, the power scaling does not apply (the request power is not known (is difficult to calculate), or the total request power is equal to or is higher than the guarantee power), and the distribution is not made to the channel/signal in the CG.

In a case where, in power calculation in a subframe in one CG, the terminal apparatus 1 does not know (has difficulty in calculating) the request power in a subframe in the other CG that overlaps the rear portion of the subframe in the one CG, all residual powers in this step is allocated to a CG that is the power calculation target, as long as a total output power of the terminal apparatus 1 does not exceed P_{CMAX}, in any portion of the subframe in the one CG (in any portion that overlaps a subframe which is earlier in time in the other CG). In a case where the residual power is allocated in the order of the PUCCH, the PUSCH that includes the UCI, and the PUSCH that does not include the UCI, a result of allocating the residual power is consistent with a result of performing the power scaling that is the same as the power scaling in the previous step, except that P_{pre, MeNB} or P_{pre, SeNB} is replaced with a value that results from adding the residual power to P_{pre, MeNB} or P_{pre, SeNB}. However, in a case where, in the previous step, the power scaling does not apply in the CG that is the power calculation target, that is, in a case where all the request powers are allocated to all the uplink channels/signal within the CG, the allocation of the residual power may not be performed. In this case, the power scaling may not be performed in this step.

In a case where, in the power calculation in the subframe in one CG, the terminal apparatus 1 knows (can calculate) the request power (or the TPC command, resource assignment information, or the like that is information for calculating the request power) in the subframe in the other CG that overlaps the rear portion of the subframe in the one CG, the residual power in this step is allocated to the channel/signal to which the power scaling applies, over the CG, according to the order of the priority levels, as long as the total output power of the terminal apparatus 1 does not exceed P_{CMAX}, in any portion of the subframe in the one CG However, in the case where, in the previous step, the power scaling does not apply in the CG that is the power calculation target, that is, in the case where all the request powers are allocated to all the uplink channels/signal within the CG, the allocation of the residual power may not be performed. At this point, as the order of the priority levels, the order of the priority level (the order of the priority levels that is based on the CG, the channel/signal, or content, or the like), which is described above, can be used.

In any of the cases described above, scaling factor w in the previous step is replaced with a value that is greater (that is close to 1), but alternatively, by replacing the scaling factor with 1 (more precisely, this is equivalent to not being multiplied by the scaling factor), a power is allocated that is higher than the power that is allocated in the previous step. Furthermore, for a channel/signal (a channel/signal that is dropped) for which scaling factor w is set to 0 in the previous step, replacement with a scaling factor that is greater than 0 (also including 1) can be made. Accordingly, when it comes to the uplink transmission that is dropped in the previous step, the dropping can be cancelled (the uplink transmission can be performed). Alternatively, for simplicity, the residual power can be made to not be allocated to the channel/signal for which scaling factor w is set to 0 in the previous step. At this time, the residual power is allocated only to the channel/signal for which scaling factor w is a value that is greater than 0 in the previous step.

For example, the residual power is sequentially allocated to each CG, in this sequence: the PUCCH for the MCG, the PUCCH for the SCG, the PUSCH that includes the UCI in the MCG, the PUSCH that does not include the UCI in the MCG, the PUSCH that does not include the UCI in the SCG More specifically, the allocation of the residual power is performed in the following procedure.

First, as a step (x1), the residual power is initialized. More specifically, it is assumed that P_{Remaining}=P_{CMAX}−P_{pre, MeNB}−P_{pre, SeNB}. Moreover, in a case where the power calculation target is the subframe in the MCG, P_{pre, SeNB} a value in the SCG subframe that overlaps the rear portion of the subframe. At this time, it may be assumed that P_{Remaining}=P_{CMAX}−P_{pre, MeNB}−max (P_{SCG}(i−1), P_{pre, SeNB}). At this point, P_{SCG} (i−1) is the actual total transmit power in the SCG subframe that overlaps the front portion of the MCG subframe that is the power calculation target. Furthermore, in a case where the power calculation target is the subframe in the SCG, P_{pre, MeNB} is a value in the MCG subframe that overlaps the rear portion of the subframe in the SCG. At this time, it may be assumed that P_{Remaining}=P_{CMAX}−max (P_{MCG}(i−1), P_{pre, MeNB})−P_{pre, SeNB}. At this point, P_{MCG} (i−1) is the actual total transmit power in the MCG subframe that overlaps the rear portion of the SCG subframe that is the power calculation target.

As a step (x2), the following arithmetic operation is performed. If there is the PUCCH transmission in the MCG, scaling of scaling factor w applies to the PUCCH, and P_{Remaining}>0 (more precisely, there is the residual power), new scaling factor w′ is determined in such a manner that (w′−w) P_{PUCCH} does not exceed P_{Remaining}. At this point, w<w′≦1 and P_{PUCCH} is the request power for the PUCCH for the MCG It is assumed that P_{Remaining}=P_{Remaining} (w′−w) P_{PUCCH}, and thus the residual power value is updated in such a manner that the residual power value is reduced as much as the power is allocated.

As a step (x3), the following arithmetic operation is performed. If there is the PUCCH transmission in the SCG, the scaling of scaling factor w applies to the PUCCH, and P_{Remaining}>0 (more precisely, there is the residual power), new scaling factor w′ is determined in such a manner that (w′−w) P_{PUCCH} does not exceed P_{Remaining}. At this point, w<w′≦1 and P_{PUCCH} is the request power for the PUCCH for the SCG It is assumed that P_{Remaining}=P_{Remaining} (w′−w) P_{PUCCH}, and thus the residual power value is updated in such a manner that the residual power value is reduced as much as the power is allocated.

As a step (x4), the following arithmetic operation is performed. If in the MCG, there is the PUSCH transmission that includes the UCI, scaling of scaling factor w applies to the PUSCH, and P_{Remaining}>0 (more precisely, there is the residual power), new scaling factor w′ is determined in such a manner that (w′−w) P_{PUSCH, j} does not exceed P_{Remaining}. At this point, w<w′≦1 and PPUSCH, j is the request power for the PUSCH that includes the UCI, in the MCG It is assumed that P_{Remaining}=P_{Remaining}−(w′−w) P_{PUSCH, j}, and thus the residual power value is updated in such a manner that the residual power value is reduced as much as the power is allocated.

As a step (x5), the following arithmetic operation is performed. If in the SCG, there is the PUSCH transmission that includes the UCI, the scaling of scaling factor w applies to the PUSCH, and P_{Remaining}>0 (more precisely, there is the residual power), new scaling factor w′ is determined in such a manner that (w′−w) P_{PUSCH, j} does not exceed P_{Remaining}. At this point, w<w′≦1 and P_{PUSCH, j} is the request power for the PUSCH that includes the UCI, in the SCG It is assumed that P_{Remaining}=P_{Remaining}−(w′−w) P_{PUSCH, j}, and thus the residual power value is updated in such a manner that the residual power value is reduced as much as the power is allocated.

As a step (x6), the following arithmetic operation is performed. If in the MCG, there is the PUSCH transmission that does not include the UCI, the scaling of scaling factor w applies to the PUSCH, and P_{Remaining}>0 (more precisely, there is the residual power), new scaling factor w′ is determined in such a manner that (w′−w)ΣP_{PUSCH, c} does not exceed P_{Remaining}. At this point, w<w′≦1 and P_{PUSCH, c} is the request power for the PUSCH for the serving cell c, in the MCG It is assumed that P_{Remaining}=P_{Remaining}−(w′−w)ΣP_{PUSCH, c}, and thus the residual power value is updated in such a manner that the residual power value is reduced as much as the power is allocated.

As a step (x7), the following arithmetic operation is performed. If in the SCG, there is the PUSCH transmission that does not include the UCI, the scaling of scaling factor w applies to the PUSCH, and P_{Remaining}>0 (more precisely, there is the residual power), new scaling factor w′ is determined in such a manner that (w′−w)ΣP_{PUSCH, c} does not exceed P_{Remaining}. At this point, w<w′≦1 and P_{PUSCH, c} is the request power for the PUSCH for the serving cell c, in the SCG It is assumed that P_{Remaining}=P_{Remaining}−(w′−w)ΣP_{PUSCH, c}, and thus the residual power value is updated in such a manner that the residual power value is reduced as much as the power is allocated.

As another example, the residual power is sequentially allocated to each CG, in this sequence: a channel that includes the HARQ-ACK, in the MCG, a channel that includes the HARQ-ACK, in the SCG, the PUSCH that does not include the HARQ-ACK, in the MCG, the PUSCH that does not include the HARQ-ACK, in the SCG More specifically, the allocation of the residual power is performed in the following procedure.

First, as a step (y1), the residual power is initialized. Moreover, the step (y1) is realized with the same processing with which the step (x1) is realized.

As a step (y2), the following arithmetic operation is performed. If in the MCG, there is the PUCCH transmission that carries the HARQ-ACK, the scaling of scaling factor w applies to the PUCCH, and P_{Remaining}>0 (more precisely, there is the residual power), new scaling factor w′ is determined in such a manner that (w′−w) P_{PUCCH} does not exceed P_{Remaining}. At this point, w<w′≦1 and P_{PUCCH} is the request power for the PUCCH for the MCG It is assumed that P_{Remaining}=P_{Remaining} (w′−w) P_{PUCCH}, and thus the residual power value is updated in such a manner that the residual power value is reduced as much as the power is allocated.

As a step (y3), the following arithmetic operation is performed. If in the MCG, there is the PUSCH transmission that carries the HARQ-ACK, the scaling of scaling factor w applies to the PUSCH, and P_{Remaining}>0 (more precisely, there is the residual power), new scaling factor w′ is determined in such a manner that (w′−w) P_{PUSCH, j} does not exceed P_{Remaining}. At this point, w<w′≦1 and P_{PUSCH, j} is the request power for the PUSCH that carries the HARQ-ACK, in the MCG It is assumed that P_{Remaining}=P_{Remaining} (w′−w) P_{PUSCH, j}, and thus the residual power value is updated in such a manner that the residual power value is reduced as much as the power is allocated.

As a step (y4), the following arithmetic operation is performed. If in the SCG, there is the PUCCH transmission that carries the HARQ-ACK, the scaling of scaling factor w applies to the PUCCH, and P_{Remaining}>0 (more precisely, there is the residual power), new scaling factor w′ is determined in such a manner that (w′−w) P_{PUCCH} does not exceed P_{Remaining}. At this point, w<w′≦1 and P_{PUCCH} is the request power for the PUCCH for the SCG It is assumed that P_{Remaining}=P_{Remaining} (w′−w) P_{PUCCH}, and thus the residual power value is updated in such a manner that the residual power value is reduced as much as the power is allocated.

As a step (y5), the following arithmetic operation is performed. If in the SCG, there is the PUSCH transmission that carries the HARQ-ACK, the scaling of scaling factor w applies to the PUSCH, and P_{Remaining}>0 (more precisely, there is the residual power), new scaling factor w′ is determined in such a manner that (w′−w) P_{PUSCH, j} does not exceed P_{Remaining}. At this point, w<w′≦1 and P_{PUSCH,j} is the request power for the PUSCH that carries the HARQ-ACK, in the SCG It is assumed that P_{Remaining}=P_{Remaining} (w′−w) P_{PUSCH, j}, and thus the residual power value is updated in such a manner that the residual power value is reduced as much as the power is allocated.

As a step (y6), the following arithmetic operation is performed. If in the MCG, there is the PUSCH transmission that does not include the HARQ-ACK, the scaling of scaling factor w applies to the PUSCH, and P_{Remaining}>0 (more precisely, there is the residual power), new scaling factor w′ is determined in such a manner that (w′−w)ΣP_{PUSCH, c} does not exceed P_{Remaining}. At this point, w<w′≦1 and P_{PUSCH, c} is the request power for the PUSCH for the serving cell c, in the MCG It is assumed that P_{Remaining}=P_{Remaining}−(w′−w)ΣP_{PUSCH, c}, and thus the residual power value is updated in such a manner that the residual power value is reduced as much as the power is allocated.

As a step (y7), the following arithmetic operation is performed. If in the SCG, there is the PUSCH transmission that does not include the HARQ-ACK, the scaling of scaling factor w applies to the PUSCH, and P_{Remaining}>0 (more precisely, there is the residual power), new scaling factor w′ is determined in such a manner that (w′−w)ΣP_{PUSCH, c} does not exceed P_{Remaining}. At this point, w<w′≦1 and P_{PUSCH, c} is the request power for the PUSCH for the serving cell c, in the SCG It is assumed that P_{Remaining}=P_{Remaining}−(w′−w)ΣP_{PUSCH, c}, and thus the residual power value is updated in such a manner that the residual power value is reduced as much as the power is allocated.

In this manner, first, the request power for each of the channels/signals of both CGs is calculated, and next, provisional power scaling is performed for every CG if need arises (in a case where the total request power for the CG exceeds the guarantee power for the CG). Lastly, the residual power is sequentially allocated to the channel/signal that is multiplied by the scaling factor in the previous step. Accordingly, the transmit power in the uplink can be efficiently used.

The case where the request power for every channel is first calculated, next the power scaling is performed within the CG, and lastly, the allocation of the residual power between the CGs is performed is described above.

In contrast, one example of a case where the request power for every channel is first calculated and the residual power is allocated while performing the power scaling is described below. At this point, the same priority level rule as described above can be used for the allocation of the residual power between the CGs. The residual power is sequentially allocated to the channel in the order that is based on the priority level rule. At this time, in a case where the total transmit power at a point in time at which the CG is a target exceeds a power value that results from deducting from P_{CMAX} the total power that is already allocated to the other CG, the power scaling applies. Regardless of whether or not the power scaling is performed, in a case where a power is allocated to a channel that is a target, as much power as is allocated is subtracted from the residual power. These are repeatedly performed until the residual power is used up.

First, the allocation of the power for the PUCCH in the serving cell (for example, the PCell) that belong to the MCG is performed. At this point, the power for the PUCCH in the serving cell that belongs to the MCG may be referred to as P_{PUCCH, MCG}. Because the total transmit power (a power that is requested for the PUCCH) for the MCG at this point in time exceeds neither P_{CMAX} nor P_{CMAX, c}, P_{PUCCH} for the MCG is allocated. Moreover, in a case where there is no PUCCH transmission in the MCG, it is assumed that P_{PUCCH, MCG}=0.

In a case where the MCG and the SCG are configured, more precisely, multiple CGs are configured, the power for the PUCCH in the serving cell that belongs to the MCG is configured in such a manner as not to exceed an upper limit value (P_{CMAX} or P_{CMAX, c}) of the power for the PUCCH for the MCG In other words, P_{PUCCH, MCG} is configured based on a minimum value between the power that is requested for the PUCCH and the upper limit value of the power (on the smaller of the power and the upper limit value of the power).

In a case where the power that is requested for the PUCCH for the MCG is higher than P_{CMAX}, the scaling factor is calculated in such a manner that the power which is requested for PUCCH does not exceed the upper limit value of the power for the PUCCH for the MCG, and the calculated scaling factor applies to the power that is requested for the PUCCH. In a case where the power that is requested for the PUCCH for the MCG is scaled, more precisely, the scaling factor applies to the power that is requested for the PUCCH for the MCG, the power may not be allocated to another Physical Uplink Channel (for example, the PUSCH that includes the UCI, or the PUSCH that does not include the UCI).

Next, the allocation of the power for the PUCCH in the serving cell (for example, the pSCell) that belong to the SCG is performed. At this point, the power for the PUCCH in the serving cell (for example, the pSCell) that belongs to the SCG may be referred to as P_{PUCCH, SCG}. Moreover, the PCell and the pSCell are different serving cells. As long as the total transmit power (the power that is requested for the PUCCH) for the SCG at this point in time does not exceed a value that results from subtracting from P_{CMAX} the power that has been already allocated to the MCG, P_{PUCCH} for the SCG is allocated. Conversely, in a case where the total transmit power exceeds such a value, the scaling is performed or the dropping is performed. Moreover, in a case where there is no PUCCH transmission in the SCG, it is assumed that P_{PUCCH, SCG}=0. Furthermore, the power that has been already allocated to the MCG may be referred to as P_{CMAX, MCG}. P_{CMAX, MCG} may be constituted from P_{PUCCH, MCG} and/or P_{PUSCH, j, MCG} and/or P_{PUSCH, c, MCG}. More precisely, P_{CMAX, MCG} may be constituted using any one of P_{PUCCH, MCG}, P_{PUSCH, j, MCG}, and P_{PUSCH, c, MCG}, be constituted using any two of them, and be constituted using all of them. For example, P_{CMAX, MCG} may be P_{PUCCH, MCG}+P_{PUSCH, j, MCG}, be P_{PUCCH, MCG}+P_{PUSCH, j, MCG}+P_{PUSCH, c, MCG}, and, in a case where there is no power that has been already allocated to the MCG, be 0.

In the case where the MCG and the SCG are configured, more precisely, multiple CGs are configured, the power P_{PUCCH, SCG} for the PUCCH in the serving cell that belongs to the SCG is configured in such a manner as not to exceed an upper limit value (P_{CMAX}, or P_{CMAX}−P_{CMAX, MCG}) of the power for the PUCCH for the SCG In other words, P_{PUCCH, SCG} is configured based on a minimum value between the power that is requested for the PUCCH and the upper limit value of the power. Furthermore, in a case where the residual power that is available for the allocation to the power for the PUCCH in the serving cell that belongs to the SCG is lower than a prescribed value (or threshold) for the power that is requested for the PUCCH, the PUCCH transmission in the serving cell that belongs to the SCG may be dropped. Moreover, the prescribed value may be configured as the higher layer parameter and be configured in advance, as a default value, for the terminal apparatus. In a case where the prescribed value is not configured by the higher layer parameter, the default value may be used.

In a case where the power that is requested for the PUCCH for the SCG is higher than P_{CMAX} and P_{CMAX}−P_{CMAX, MCG}, the scaling factor is calculated in such a manner that the power which is requested for PUCCH for the SCG does not exceed the upper limit value of the power for the PUCCH for the SCG, and the calculated scaling factor applies to the power that is requested for the PUCCH for the SCG In a case where the power that is requested for the PUCCH for the SCG is scaled, more precisely, the scaling factor applies to the power that is requested for the PUCCH for the SCG, the power may not be allocated to another Physical Uplink Channel (for example, the PUSCH that includes the UCI, or the PUSCH that does not include the UCI).

Next, the allocation of the power for the PUSCH that includes the UCI, in the serving cell j that belongs to the MCG is performed. At this point, the power for the PUSCH that includes the UCI, in the certain serving cell j that belongs to the MCG may be referred to as P_{PUSCH, j, MCG}. Moreover, the certain serving cell j that belongs to the MCG is different at least from the pSCell. More precisely, the serving cell j is a serving cell that is different from the serving cell that belongs to the SCG As long as a total of the total transmit powers (a total of P_{PUCCH} and P_{PUSCH, j}, more precisely, a total of P_{PUCCH, MCG} and P_{PUSCH, j, MCG}) in the MCG at this point in time does not exceed a value that results from subtracting from P_{CMAX} the power that has been already allocated to the SCG, P_{PUSCH, j, MCG} is allocated. Conversely, in a case where the total transmit power exceeds such a value, the scaling is performed or the dropping is performed. Moreover, in a case where, in the MCG, there is no PUSCH transmission that includes the UCI, it is assumed that P_{PUSCH, j, MCG}=0. Furthermore, the power that has been already allocated to the SCG may be referred to as P_{CMAX, SCG}. P_{CMAX, SCG} may be constituted from P_{PUSCH, SCG} and/or P_{PUSCH, k, SCG} and/or P_{PUSCH, d, SCG}. More precisely, P_{CMAX, SCG} may be and P_{PUSCH, d, SCG} be using any one of P_{PUCCH, SCG}, P_{PUSCH, k, SCG}, be constituted using any two of them, and be constituted using all of them. For example, P_{CMAX, SCG} may be P_{PUCCH, SCG}+P_{PUSCH, k, SCG}, be P_{PUCCH, SCG}+P_{PUSCH, k, SCG}+P_{PUSCH, d, SCG}, and, in a case where there is no power that has been already allocated to the SCG, be 0.

In the case where the MCG and the SCG are configured, more precisely, multiple CGs are configured, the power P_{PUSCH, j, MCG} for the PUSCH that includes the UCI, in the certain serving cell j that belongs to the MCG is configured in such a manner as not to exceed an upper limit value (P_{CMAX}, P_{CMAX}−P_{PUCCH, MCG}, P_{CMAX}−_{PCMAX, SCG}, or P_{CMAX}−P_{PUCCH, MCG}−P_{CMAX, SCG}) of the power for the PUSCH that includes the UCI, in the certain serving cell j that belongs to the MCG In other words, P_{PUSCH, j, MCG} is configured based on a minimum value between a power that is requested for the PUSCH and the upper limit value of the power for the PUSCH that includes the UCI, in the certain serving cell j that belongs to the MCG Furthermore, in a case where the residual power that is available for the allocation to the power for the PUSCH that includes the UCI, in the certain serving cell j that belongs to the MCG is lower than a prescribed value (or threshold) for the power that is requested for the PUSCH, the PUSCH transmission that includes the UCI, in the certain serving cell j that belongs to the MCG may be dropped.

In a case where the power that is requested for the PUSCH that includes the UCI, in the certain serving cell j that belongs to the MCG is greater than the upper limit value of the power for the PUSCH that includes the UCI, in the serving cell j, the scaling factor is calculated in such a manner that the power that is requested for the PUSCH that includes the UCI, in the serving cell j, does not exceed the upper limit value of the power for the PUSCH that includes the UCI, in the serving cell j, and the calculated scaling factor applies to the power that is requested for the PUSCH that includes the UCI, in the serving cell j. In a case where the power that is requested for the PUSCH that includes the UCI, in the serving cell j, is scaled, more precisely, the scaling factor applies to the power that is requested for the PUSCH that includes the UCI, in the serving cell j, the power may not be allocated to another Physical Uplink Channel (for example, the PUSCH that does not include the UCI).

Next, the allocation of the power for the PUSCH that includes the UCI, in a serving cell k that belongs to the SCG is performed. At this point, the power for the PUSCH that includes the UCI, in a certain serving cell k that belongs to the SCG may be referred to as P_{PUSCH, k, SCG}. Moreover, the certain serving cell k that belongs to the SCG is different from the PCell and the serving cell j. More precisely, the serving cell k is a serving cell that is different from the serving cell that belongs to the MCG As long as a total of the total transmit powers (a total of P_{PUCCH} and P_{PUSCH, k}, more precisely, a total of P_{PUCCH, SCG} and P_{PUSCH, k, SCG}, in the SCG) in the SCG at this point in time does not exceed a value that results from subtracting from P_{CMAX} the power that has been already allocated to the MCG, P_{PUSCH, j, SCG} is allocated. Conversely, in a case where the total transmit power exceeds such a value, the scaling is performed or the dropping is performed. Moreover, in a case where, in the SCG, there is no PUSCH transmission that includes the UCI, it is assumed that P_{PUSCH, k, SCG}=0.

In the case where the MCG and the SCG are configured, more precisely, multiple CGs are configured, the power P_{PUSCH, k, SCG} for the PUSCH that includes the UCI, in the certain serving cell k that belongs to the SCG is configured in such a manner as not to exceed an upper limit value (P_{CMAX}, P_{CMAX}−P_{PUCCH, SCG}, P_{CMAX}−_{PCMAX, MCG}, or P_{CMAX}−P_{PUCCH, SCG}−P_{CMAX, MCG}) of the power for the PUSCH that includes the UCI, in the certain serving cell k that belongs to the SCG In other words, P_{PUSCH, k, SCG} is configured based on a minimum value between the power that is requested for the PUSCH and the upper limit value of the power for the PUSCH that includes the UCI, in the certain serving cell k that belongs to the SCG Furthermore, in a case where the residual power that is available for the allocation to the power for the PUSCH that includes the UCI, in the certain serving cell k that belongs to the SCG is lower than the prescribed value (or threshold) for the power that is requested for the PUSCH, the PUSCH transmission that includes the UCI, in the certain serving cell k that belongs to the SCG may be dropped.

In a case where the power that is requested for the PUSCH that includes the UCI, in the certain serving cell k that belongs to the SCG is greater than the upper limit value of the power for the PUSCH that includes the UCI, in the serving cell k, the scaling factor is calculated in such a manner that the power that is requested for the PUSCH that includes the UCI, in the serving cell k, does not exceed the upper limit value of the power for the PUSCH that includes the UCI, in the serving cell k, and the calculated scaling factor applies to the power that is requested for the PUSCH that includes the UCI, in the serving cell k. In a case where the power that is requested for the PUSCH that includes the UCI, in the serving cell k, is scaled, more precisely, the scaling factor applies to the power that is requested for the PUSCH that includes the UCI, in the serving cell k, the power may not be allocated to another Physical Uplink Channel (for example, the PUSCH that does not include the UCI).

Next, the allocation of the power for the PUSCH that does not include the UCI, in the certain serving cell c that belongs to the MCG is performed, more precisely, that includes only UL-SCH data, is performed. At this point, the power for the PUSCH that does not include the UCI, in the certain serving cell c that belongs to the MCG may be referred to as P_{PUSCH, c, MCG}. Moreover, the certain serving cell c that belongs to the MCG is different from the pSCell and the serving cell k. More precisely, the serving cell c is a serving cell that is different from the serving cell that belongs to the SCG and is also different from the serving cell j described above. As long as a total of the total transmit powers (a total of P_{PUCCH}, P_{PUSCH, j}, and the P_{PUSCH, c}, more precisely, a total of P_{PUCCH, MCG}, P_{PUCCH, j, MCG}, and P_{PUSCH, c, MCG}, in the MCG) in the MCG at this point in time does not exceed the value that results from subtracting from P_{CMAX} the power that has been already allocated to the SCG, P_{PUSCH, c, MCG} is allocated. Conversely, in a case where the total transmit power exceeds such a value, the scaling is performed or the dropping is performed. Moreover, in a case where, in the MCG, there is no PUSCH transmission that does not include the UCI, it is assumed that P_{PUSCH, c, MCG}=0. Moreover, the UL-SCH data may be referred to as the transport block.

In the case where the MCG and the SCG are configured, more precisely, multiple CGs are configured, the power P_{PUSCH, c, MCG} for the PUSCH that does not include the UCI, in the certain serving cell c that belongs to the MCG is configured in such a manner as not to exceed an upper limit value (P_{CMAX}, P_{CMAX}−P_{PUCCH, MCG}, P_{CMAX}−P_{PUSCH, j, MCG}, P_{CMAX}−P_{PUCCH, MCG}−P_{PUSCH, j, MCG}, P_{CMAX}−P_{CMAX, SCG}, P_{CMAX}−P_{PUCCH, MCG}−P_{CMAX, SCG}, or P_{CMAX}−P_{PUCCH, MCG}−P_{PUSCH, j, MCG}−P_{CMAX, SCG}) of the power for the PUSCH that does not include the UCI, in the certain serving cell c that belongs to the MCG In other words, P_{PUSCH, c, MCG} is configured based on a minimum value between the power that is requested for the PUSCH and the upper limit value of the power for the PUSCH that does not include the UCI, in the certain serving cell c that belongs to the MCG Moreover, the transmission of the PUSCH that does not include the UCI occurs at the same time in multiple serving cells, configuration is performed in such a manner that the minimum value is not exceeded, by using a scaling factor having the same value. Furthermore, in a case where the residual power that is available for the allocation to the power for the PUSCH that does not include the UCI, in the certain serving cell c that belongs to the MCG is lower than the prescribed value (or threshold) for the power that is requested for the PUSCH, the PUSCH transmission that does not include the UCI, in the certain serving cell c that belongs to the MCG may be dropped. In a case where the power that is requested for the PUSCH that does not include the UCI, in the certain serving cell c that belongs to the MCG is greater than the upper limit value of the power for the PUSCH that does not include the UCI, in the serving cell c, the scaling factor is calculated in such a manner that the power that is requested for the PUSCH that does not include the UCI, in the serving cell c, does not exceed the upper limit value of the power for the PUSCH that does not include the UCI, in the serving cell c, and the calculated scaling factor applies to the power that is requested for the PUSCH that does not include the UCI, in the serving cell c. In a case where the power that is requested for the PUSCH that does not include the UCI, in the serving cell c, is scaled, more precisely, the scaling factor applies to the power that is requested for the PUSCH that does not include the UCI, in the serving cell c, the power may not be allocated to another Physical Uplink Channel (for example, the SRS).

Next, the allocation of the power for the PUSCH that does not include the UCI, in a certain serving cell d that belongs to the SCG is performed, more precisely, that includes only the UL-SCH data, is performed. At this point, the power for the PUSCH that does not include the UCI, in the certain serving cell d that belongs to the SCG may be referred to as P_{PUSCH, d, SCG}. Moreover, the certain serving cell d that belongs to the SCG is different from the PCell, the serving cell j, and the serving cell c. More precisely, the serving cell d is a serving cell that is different from the serving cell that belongs to the MCG and is also different from the serving cell k described above. As long as a total of the total transmit powers (a total of P_{PUCCH}, P_{PUSCH, k}, and the P_{PUSCH, d}, more precisely, a total of P_{PUCCH, SCG}, P_{PUSCH, k, SCG} and P_{PUSCH, d, SCG}, in the SCG) in the SCG at this point in time does not exceed the value that results from subtracting from P_{CMAX} the power that has been already allocated to the SCG, P_{PUSCH, d, SCG} is allocated. Conversely, in a case where the total transmit power exceeds such a value, the scaling is performed or the dropping is performed. Moreover, in a case where, in the SCG, there is no PUSCH transmission that does not include the UCI, it is assumed that P_{PUSCH, d, SCG}=0.

In the case where the MCG and the SCG are configured, more precisely, multiple CGs are configured, the power P_{PUSCH, d, SCG} for the PUSCH that does not include the UCI, in the certain serving cell d that belongs to the SCG is configured in such a manner as not to exceed an upper limit value (P_{CMAX}, P_{CMAX}−P_{PUCCH, SCG}, P_{CMAX}−_{PPUSCH, k, SCG}, P_{CMAX}−P_{PUCCH, SCG}−P_{PUSCH, k, SCG}, P_{CMAX}−P_{CMAX, MCG}, P_{CMAX}−P_{PUCCH, SCG}−P_{CMAX, MCG}, or P_{CMAX}−P_{PUCCH, SCG}−P_{PUSCH, k, SCG}−P_{CMAX, MCG}) of the power for the PUSCH that does not include the UCI, in the certain serving cell d that belongs to the SCG In other words, P_{PUSCH, d, SCG} is configured based on a minimum value between the power that is requested for the PUSCH and the upper limit value of the power for the PUSCH that does not include the UCI, in the certain serving cell d that belongs to the SCG Furthermore, in a case where the residual power that is available for the allocation to the power for the PUSCH that does not include the UCI, in the certain serving cell d that belongs to the SCG is lower than the prescribed value (or threshold) for the power that is requested for the PUSCH, the PUSCH transmission that does not include the UCI, in the certain serving cell d that belongs to the SCG may be dropped.

In a case where the power that is requested for the PUSCH that does not include the UCI, in the certain serving cell d that belongs to the SCG is greater than the upper limit value of the power for the PUSCH that does not include the UCI, in the serving cell d, the scaling factor is calculated in such a manner that the power that is requested for the PUSCH that does not include the UCI, in the serving cell d, does not exceed the upper limit value of the power for the PUSCH that does not include the UCI, in the serving cell d, and the calculated scaling factor applies to the power that is requested for the PUSCH that does not include the UCI, in the serving cell d. In a case where the power that is requested for the PUSCH that does not include the UCI, in the serving cell d, is scaled, more precisely, the scaling factor applies to the power that is requested for the PUSCH that does not include the UCI, in the serving cell d, the power may not be allocated to another Physical Uplink Channel (for example, the SRS).

In a case where minimum guarantee powers P_{MCG} and P_{SCG} are configured for the MCG and the SCG, respectively, when the power is allocated to P_{PUCCH, SCG}, P_{PUSCH, j, MCG}, P_{PUSCH, k, SCG}, P_{PUSCH, c, MCG}, or P_{PUSCH, d, SCG}, if the residual power is assumed to fall greatly below the minimum guarantee power, subsequent power allocation may not be performed. For example, if most of the power is assumed to be allocated to the transmit power for the PUCCH for each CG, the power may not be allocated to the transmit power for the PUSCH for the MCG or the SCG More precisely, in a case where P_{MCG} (or P_{SCG})>>P_{CMAX}−P_{CMAX, MCG}−P_{CMAX, SCG} (P_{CMAX}−P_{CMAX, MCG}, P_{CMAX}−P_{CMAX, SCG}, or an upper limit value of the power for each Physical Uplink Channel) is satisfied, the power may not be allocated to the Physical Uplink Channel for the MCG or the SCG That is, the transmission of the Physical Uplink Channel to which the power is not allocated may be dropped.

In the case where the minimum guarantee powers P_{MCG} and P_{SCG} are configured for the MCG and the SCG, respectively, when the power is allocated to P_{PUCCH, SCG}, P_{PUSCH, j, MCG}, P_{PUSCH, k, SCG}, P_{PUSCH, c, MCG}, or P_{PUSCH, d, SCG}, if the residual power is assumed to fall greatly below the minimum guarantee power, subsequent power allocation may not be performed. For example, if most of the power is assumed to be allocated to the transmit power for the PUCCH for each CG, the power may not be allocated to the transmit power for the PUSCH for the MCG or the SCG More precisely, in a case where the power that is requested for the Physical Uplink Channel (the PUSCH or the PUCCH)>>P_{CMAX}−P_{CMAX, MCG}−P_{CMAX, SCG} (P_{CMAX}−P_{CMAX, MCG}, P_{CMAX}−P_{CMAX, SCG}, or the upper limit value of the power for each Physical Uplink Channel) is satisfied, the power may not be allocated to the Physical Uplink Channel for the MCG or the SCG That is, the transmission of the Physical Uplink Channel to which the power is not allocated may be dropped.

In the case where the minimum guarantee powers P_{MCG} and P_{SCG} are configured for the MCG and the SCG, respectively, and a power that is requested for a Physical Uplink Channel for a serving cell that belongs to a certain CG falls below a minimum guarantee power for a certain CG, when the power is allocated to P_{PUCCH, SCG}, P_{PUSCH,j, MCG}, P_{PUSCH k, SCG}, P_{PUSCH, c, MCG}, or P_{PUSCH, d, SCG}, if the residual power is assumed to fall greatly below the minimum guarantee power, subsequent power allocation may not be performed. For example, if most of the power is assumed to be allocated to the transmit power for the PUCCH for each CG, more precisely, of the residual power is assumed to be very low, the power may not be allocated to the transmit power for the PUSCH for the MCG or the SCG More precisely, in the case where P_{MCG} (or P_{SCG})>>P_{CMAX}−P_{CMAX, MCG}−P_{CMAX, SCG} (P_{CMAX}−P_{CMAX, MCG}, P_{CMAX}−P_{CMAX, SCG}, or the upper limit value of the power for each Physical Uplink Channel) is satisfied, the power may not be allocated to the Physical Uplink Channel for the MCG or the SCG That is, the transmission of the Physical Uplink Channel to which the power is not allocated may be dropped.

In a case where multiple CGs are configured and multiple Physical Uplink Channels are repeatedly transmitted between the CGs and/or within the CG, the upper limit value of the power for the Physical Uplink Channel changes according to a priority level of the CG and a priority level of the Physical Uplink Channel.

Moreover, P_{CMAX}, P_{CMAX, MCG}, P_{CMAX, SCG}, P_{PUCCH, SCG}, P_{PUSCH, SCG}, P_{PUSCH, j, MCG}, P_{PUSCH, k, SCG}, P_{PUSCH, c, MCG}, and P_{PUSCH, d, SCG}, which are described above, may be indicated as a linear value, not as a relative value or a ratio. For example, a unit of linear value (which is also referred to as a dimension) may be dBM, W, or mW.

As one example, the case is described as above in which, in the allocation of the power for a channel, in a case where the total transmit power at a point in time at which the CG is a target exceeds the power value that results from deducting from P_{CMAX} the total power that has been already allocated to the other CG, the power scaling applies to the allocation power for the channel. As a different example, in a case where the request power for the channel that is a target exceeds a power value that results from deducting from P_{CMAX} a sum of the total power that is already allocated to the CG that is a target and the total power that is already allocated to the other CG, the power scaling may apply to the allocation power for the channel.

Furthermore, as a different example, in the method described above, the allocation of the power to the channel that is a target can be determined considering the guarantee power that is configured for each of the CGs. For example, in a case where the request power for the channel that is a target exceeds a power value that results from deducting from P_{CMAX} a sum of a power relating to the CG that is a target and a power relating to the other CG, the power scaling may apply to the allocation power for the channel. The power relating to the CG that is a target is a maximum value between the total power that is already allocated to the CG that is the target and the guarantee power in the CG that is the target. The power relating to the other CG is a maximum value between the total power that is already allocated to the other CG and the guarantee power in the other CG.

The details are as follows. A different example of the case where the request power for every channel is first calculated and the residual power is allocated while performing the power scaling will be described below. Moreover, in the following description, one portion of the contents that overlap with those in the examples described above is omitted. At this point, the same priority level rule as described above can be used for the allocation of the residual power between the CGs. The residual power is sequentially allocated to the channel in the order that is based on the priority level rule. At this time, in the case where the request power for the channel that is a target exceeds the power value that results from deducting from P_{CMAX} the sum of the power relating to the CG that is a target and the power relating to the other CG, the power scaling may apply. Regardless of whether or not the power scaling is performed, in a case where a power is allocated to a channel that is a target, as much power as is allocated is subtracted from the residual power. These are repeatedly performed until the residual power is used up.

Moreover, as described above, the power relating to the MCG is a maximum value between the total power that is already allocated to the MCG and the guarantee power in the MCG The power relating to the SCG is a maximum value between the total power that is already allocated to the SCG and the guarantee power in the SCG

The base station apparatus assumes the maximum output power P_{CMAX} that is configured by the terminal apparatus, from a power headroom report, and, based on the Physical Uplink Channel that is received from the terminal apparatus, assumes the upper limit value of the power for each Physical Uplink Channel. The base station apparatus determines a value of the transmit power control command for the Physical Uplink Channel, based on these assumptions, and transmits the determined value to the terminal apparatus, using the PDCCH that is accompanied by a downlink control information format. By doing this, the power adjustment of the transmit power for the Physical Uplink Channel that is transmitted from the terminal apparatus is performed.

### Second Embodiment

Next, a second embodiment of the present invention will be described below.

According to the second embodiment, a transmission timing of the PRACH in a case where multiple CGs are configured, and the transmit power control by the terminal apparatus when the PRACH transmission and the PUSCH/PUCCH/PRACH transmission overlap among multiple CGs are described.

In a case where the PRACH transmission and the PUSCH/PUCCH transmission overlap among multiple CGs that are synchronous/asynchronous, the power is preferentially allocated to the transmission of the Physical Uplink Channel that is allocated in advance. For example, in a case where the PRACH transmission and the PUSCH transmission overlap, if the PUSCH transmission is assumed to be allocated in advance, regardless of priority levels of the Physical Uplink Channels, the power is preferentially allocated to the PUSCH transmission, and the remaining power is allocated to the PRACH transmission. If the remaining power is assumed not to be sufficient for the PRACH transmission, the PRACH transmission is not received in the base station apparatus. Thus, in some cases, communication efficiency is degraded.

Because a channel or a signal that is used in the present embodiment, and a schematic constitution or the like of each of the terminal apparatus and the base station apparatus are the same as those which is described in the first embodiment, detailed descriptions thereof are omitted.

A random access procedure is described. Before executing the random access procedure (an asynchronous physical random access procedure or an L1 random access procedure) in the physical layer, a layer 1 (a physical layer of the terminal apparatus) receives information (a PRACH configuration and a frequency position) relating to a parameter of a Random Access Channel and information (an index for a local route sequence index table, a cyclic shift (N_{CS}), and a set type (a non-restricted or restricted set)) relating to a parameter for determining a route sequence or a cyclic shift in a preamble sequence set for the primary cell, from the higher layer.

The random access procedure is started by a PDCCH order or a MAC layer. The random access procedure in the SCell is started only by the PDCCH order. If the terminal apparatus is assumed to receive the PDCCH transmission that is consistent with the PDCCH order that is masked for a specific serving cell and with the C-RNTI, the terminal apparatus starts the random access procedure for the specific serving cell. The PDCCH order or the RRC layer designates a random access preamble index (ra-Preamblelndex) and a random access PRACH master index (ra-PRACH-Masklndex) for the random access procedure in the PCell. The PDCCH order designates the random access procedure index that is a value different from “000000” and the random access PRACH master index for the random access procedure in the SCell. pTAG preamble communication and PDCCH order transmission in the PRACH are supported only for the PCell.

For the perspective of the physical layer, the L1 random access procedure includes transmission of the random access preamble and of a random access response. A remaining message is scheduled for transmission on a Shared Data Channel by the higher layer, and is not regarded as one portion of the L1 random access procedure. The Random Access Channel (the PRACH here) is reserved for the random access preamble transmission, and occupies six resource blocks in one certain subframe or in a set of continuous (multiple) subframes. Moreover, one subframe is used for preamble formats 0 and 4, and the set of continuous (multiple) subframes is used for preamble formats 1, 2, and 3. The base station apparatus does not prohibit data (the UL-SCH data) from being scheduled, in a resource block that is reserved for the random access preamble transmission (or random access channel preamble transmission). More precisely, for the terminal apparatus, the base station apparatus may schedule the PUSCH that uses the resource block which is reserved for the random access preamble transmission. The terminal apparatus may transmit the UL-SCH data (more precisely, a UL-SCH transport block or the PUSCH) using the resource block that is reserved for the random access preamble transmission.

The L1 random access procedure is executed with the following steps.

(H1) The L1 random access procedure is triggered in a case where there is a request for the preamble communication by the higher layer.

(H2) As one portion of the request for the preamble transmission, a value of a parameter that is indispensable for the random access procedure is designated by the higher layer. At this point, the indispensable parameters are a parameter (a target preamble reception power (PREAMBLE_RECEIVED_TARGET_POWER) indispensable for transmit power configuration for the PRACH, an initial power value, a ramp-up value, or the like), an RNTI (RA-RNTI) that corresponds to random access, a parameter (a preamble index, a mask index, a route sequence index, a zero correlation zone configuration (a cyclic shift), a high speed flag, a frequency offset, or the like) that is indispensable for resource configuration of the random access and sequence generation, and the like.

(H3) A transmit power P_{PRACH} for a preamble is determined. P_{PRACH} is indicated as min{P_{CMAX, c}(i), PREAMBLE_TARGET_RECEIVED_POWER+PL_{C}}. P_{CMAX, c}(i) is a transmit power (a maximum output power) of the terminal apparatus, which is configured in the subframe i in the serving cell c. The target preamble reception power is set based on the initial power value, the ramp-up value, and the number of times that the preamble is transmitted. PL_{c} is an estimation value of the downlink path loss, which is calculated in the terminal apparatus for the serving cell c.

(H4) The preamble sequence is selected from the preamble sequence set that uses the preamble index.

(H5) A single preamble is transmitted using the preamble sequence that is selected in the step (H4), with the transmit power P_{PRACH} that is set in the step (H2), with a PRACH resource that is designated.

(H6) Detection of the PDCCH that is accompanied by the RA-RNTI which is designated is performed within a window that is controlled in the higher layer. In a case where the PDCCH is detected, the corresponding DL-SCH transport block is delivered to the higher layer. The higher layer analyzes that transport block, and notifies the physical layer of a 20-bit uplink grant.

Next, the uplink transmission timing of the terminal apparatus after the random access preamble transmission (more precisely, the PRACH transmission or the preamble sequence transmission) for the L1 random access procedure is described.

If the PDCCH that is accompanied by the RA-RNTI that is associated in the subframe n is assumed to be detected and the corresponding DL-SCH transport block is assumed to include a response (more precisely, the random access response) to the transmitted preamble sequence, the terminal apparatus transmits the UL-SCH transport block in a first subframe n+k₁ (k₁≧6). At this point, if a UL delay field is set to “0”, a first subframe is an uplink subframe that is first applicable to the PUSCH transmission. For a TDD serving cell, the first uplink subframe (a subframe that is first applicable) for the PUSCH transmission is determined based on a UL/DL configuration (more precisely, subframe assignment of the higher parameter that is designated by the higher layer). If the UL delay field is assumed to be set to “1”, the terminal apparatus delays the PUSCH transmission until an uplink subframe that is next applicable after a subframe n+k₁.

If the random access response is assumed to be received in the subframe n and the corresponding DL-SCH transport block is assumed not to include the response to the transmitted preamble sequence, the terminal apparatus makes preparations in such a manner that a new preamble sequence can be transmitted without delay in a subframe n+5, when requested by the higher layer to do so.

If the random access response is assumed not to be received in the subframe n, the terminal apparatus makes preparations in such a manner that a new preamble sequence can be transmitted without delay in a subframe n+4, when requested by the higher layer to do so. At this point, the subframe n is regarded as being a rearmost subframe of a random access response window.

In a case where the random access procedure is performed by the “PDCCH order” in the subframe n, the terminal apparatus transmits the random access preamble in a first subframe n+k₂(k₂≧6) to which the PRACH resource is applicable (allocable), when requested to do so. At this point, the PDCCH order is the downlink control information format (more precisely, the PDCCH that is accompanied by the downlink control information format) in which a prescribed field is set to a prescribed value in order to perform scheduling of the random access preamble transmission. The PDCCH order performs the scheduling of the random access preamble transmission based on the downlink control information that is included in the PDCCH.

If multiple TAGs are assumed to be configured for the terminal apparatus and a carrier indicator field is assumed to be configured for a certain serving cell, the terminal apparatus uses the carrier indicator field that is included in the detected “PDCCH order”, in order to determine a serving cell for the corresponding random access preamble transmission. More precisely, the serving cell that performs the random access preamble transmission is determined based on a value of the carrier indicator field that is included in the “PDCCH order”.

Next, the uplink transmission timing of the terminal apparatus after the random access preamble transmission (more precisely, the PRACH transmission) for the L1 random access procedure in a case where multiple CGs are configured for the terminal apparatus is described.

If the PDCCH that is accompanied by the RA-RNTI that is associated in the subframe n is assumed to be detected and the corresponding DL-SCH transport block is assumed to include the response to the transmitted preamble sequence, the terminal apparatus transmits the UL-SCH transport block in a first subframe n+k₃ (k₃≧X₁ (X₁ is a prescribed value)). At this point, if the UL delay field is set to “0”, the first subframe is an uplink subframe that is first applicable to the PUSCH transmission. For the TDD serving cell, the first uplink subframe (the subframe that is first applicable) for the PUSCH transmission is determined based on the UL/DL configuration (more precisely, subframe assignment of the higher layer parameter that is designated by the higher layer). If the UL delay field is assumed to be set to “1”, the terminal apparatus delays the PUSCH transmission until an uplink subframe that is next applicable after a subframe n+k₃. However, if a value of k₃ is sufficiently great, the terminal apparatus for which multiple CGs are configured may transmit the UL-SCH transport block in a first subframe n+k₃, without depending on a value of the UL delay field.

In a case where multiple CGs are configured for the terminal apparatus, if the random access response is assumed to be received in the subframe n and the corresponding DL-SCH transport block is assumed not to include the response to the transmitted preamble sequence, the terminal apparatus makes preparations in such a manner that a new preamble sequence can be transmitted without delay in a subframe n+k₄ (k₄≧X₂ (X₂ is a prescribed value)), when requested by the higher layer to do so. k₃ or X may be configured considering a timing of the PUSCH/PUCCH transmission in a serving cell that belongs to another CG that is asynchronous. For example, in a case where the scheduling information for the PUSCH in the serving cell that belongs to another CG is received in the subframe i, the PUSCH is transmitted in the uplink subframe that appears first after a subframe i+4. In a case where the PRACH transmission in a serving cell that belongs to a certain CG and the PUSCH transmission in the subframe i+4 overlap, in order to allocate a suitable transmit power to the PRACH, it is better to be determine whether or not there is a need to transmit a new preamble sequence at a timing that is the same as the subframe i, or in a subframe that is earlier than such a timing. For example, if it is known that the corresponding DL-SCH transport block in the subframe i−1 does not include the response to the transmitted preamble sequence, the power can be preferentially allocated to the PRACH transmission. In other words, if the random access response is assumed to be received in the subframe n and the corresponding DL-SCH transport block is assumed not to include the response to the transmitted preamble sequence, when preparations are made in such a manner that a new preamble sequence can be transmitted without delay in a subframe n+6, the power can be preferentially allocated to the PRACH transmission.

If the random access response is assumed not to be received in the subframe n, the terminal apparatus makes preparations in such a manner that a new preamble sequence can be transmitted without delay in a subframe n+k₅ (k₅≧X₃ (X₃ is a prescribed value)), when requested by the higher layer to do so. k₄ or Y may be configured considering the timing of the PUSCH/PUCCH transmission in a serving cell that belongs to another CG that is asynchronous. For example, in the case where the scheduling information for the PUSCH in the serving cell that belongs to another CG is received in the subframe i, the PUSCH is transmitted in the uplink subframe that appears first after the subframe i+4. In the case where the PRACH transmission in a serving cell that belongs to a certain CG and the PUSCH transmission in the subframe i+4 overlap, in order to allocate a suitable transmit power to the PRACH, it is better to be determine whether or not there is a need to transmit a new preamble sequence at a timing that is the same as the subframe i, or in a subframe that is earlier than such a timing. For example, if it is known that the random access response is not received in the subframe i−1, the power can be preferentially allocated to the PRACH transmission. In other words, if the random access response is assumed not to be received in the subframe n, when preparations are made in such a manner that a new preamble sequence can be transmitted without delay in a subframe n+5, the power can be preferentially allocated to the PRACH transmission.

In the case where the random access procedure is performed by the “PDCCH order” in the subframe n, the terminal apparatus transmits the random access preamble in a first subframe n+k₆ (k₆≧X₄ (X₄ is a prescribed value)) to which the PRACH resource is applicable (allocable), when requested by the higher layer to do so. At this point, the PDCCH order is the downlink control information format (more precisely, the PDCCH that is accompanied by the downlink control information format) in which a prescribed field is set to a prescribed value in order to perform the scheduling of the random access preamble transmission.

In a case where multiple CGs are configured, if overlapping occurs between the transmission of the UL-SCH transport block or the PRACH transmission (the preamble sequence transmission or the random access preamble transmission) for the random access response or the “PDCCH order” in the subframe n+k₃, the subframe n+k₄, the subframe n+k₅, and the subframe n+k₆, which are described above, and the transmission of the uplink signal (for example, the PUSCH or PUCCH) in a subframe in a serving cell that belongs to another CG, the random access response or the “PDCCH order” may be received in the subframe n in a serving cell that belongs to a certain CG and the random access response or the PDCCH order may be demodulated or decoded. Then, based on the time that it takes to correspondingly generate and transmit the UL-SCH transport block or the preamble sequence and on the number of subframes, k₃, (or X₁), k₄ (or X₂), k₅ (or X₃), and k₆ (or X₄), which are described above, may be determined. For example, in a case where a PUSCH grant (the uplink grant) or the PDSCH is received in a subframe m in a serving cell that belongs to another CG, which overlaps the subframe n, although the PRACH transmission and the PUSCH/PUCCH transmission overlap in the subframe n+k and a subframe m+k, a value of k may be determined in such a manner that the power is preferentially allocated to the PRACH transmission. For example, all values from k₃ to k₆ may be all configured as a common value (the same value).

Furthermore, when a certain serving cell that belongs to a certain CG is assumed to be a first serving cell and a serving cell that belongs to another CG is assumed to be a second serving cell, in a case where overlapping does not occur between the subframe n in which the random access response or the PDCCH order for the first serving cell is received and the subframe m in which the DL-SCH transport block for the second serving cell is received and overlapping occurs correspondingly between the PRACH transmission and the PUSCH/PUCCH transmission, the time sufficient for the preamble sequence generation and the transmit power configuration or the number of subframes may be configured when it comes to the subframe n+k for the PRACH transmission. More precisely, the value of k is the time that it takes to generate the preamble sequence, and may be the time that it takes to preferentially allocate the power to the PRACH transmission. For example, it is preferable that the value of k for the PRACH transmission in a serving cell (more precisely, a cell that is served by a base station itself) that belongs to a certain CG is 4 or great, considering a reception timing of the PUSCH grant (the uplink grant) for a serving cell that belongs to another CG, the time that it takes to demodulate/decode a RAR grant (a random access responses grant) for the cell that is served by the base station itself or the “PDCCH order”, or the time that it takes from modulation/decoding of the RAR grant or the like to completion of preparation for the transmission. In a case where, according to whether or not multiple CGs are configured, the time taken varies, the value of k is changed according to whether or not the multiple CGs are configured, and, based on the changed value of k, the random access procedure is performed. Moreover, the value of k may be configured for every CG and may be configured for every serving cell. For example, the values of k in the PCell and the pSCell may be different values.

In a case where the preamble sequence is difficult to extract, the base station apparatus may transmit the DL-SCH transport block without the response corresponding to the preamble sequence being included in the DL-SCH transport block. Furthermore, in a case where the DL-SCH transport block including the random access response that corresponds to the preamble sequence of a certain terminal apparatus is transmitted in the subframe n, a new preamble sequence may be made to be able to be received in a subframe n+t (t is a prescribed value that is described above) on the assumption that detection of the response fails in the terminal apparatus. Furthermore, the base station apparatus may be made to be able to receive the UL-SCH transport block for the response in the subframe n+t (t is the prescribed value that is described above), on the assumption that the detection of the response succeeds in the terminal apparatus.

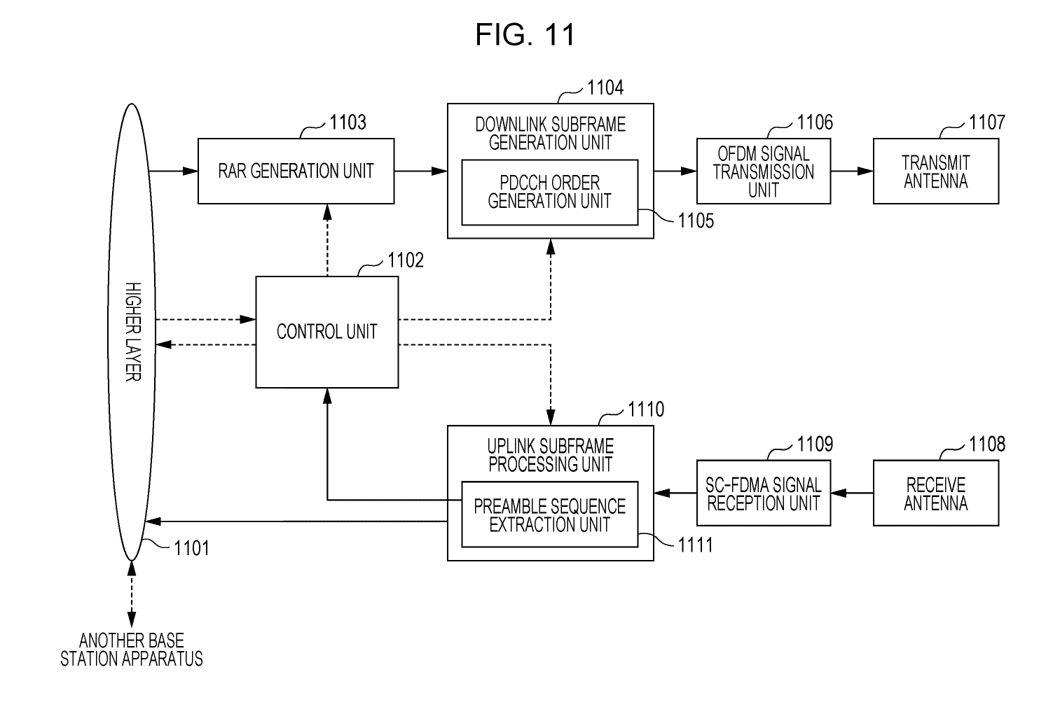

FIG. 11 is a schematic diagram illustrating an example of block constitutions of the base station apparatus 2-1 and the base station apparatus 2-2 according to the present embodiment. The base station apparatus 2-1 and the base station apparatus 2-2 each have a higher layer (a higher layer control information notification unit) 1101, a control unit (a base station control unit) 1102, a random access response (RAR) generation unit (a random access procedure processing unit) 1103, a downlink subframe generation unit 1104, an OFDM signal transmission unit (a downlink transmission unit) 1106, a transmit antenna (a base station transmit antenna) 1107, a receive antenna (a base station receive antenna) 1108, an SC-FDMA signal reception unit (a preamble reception unit) 1109, and an uplink subframe processing unit 1110. Although not illustrated in FIG. 11, the base station apparatus 2-1 and the base station apparatus 2-2 in FIG. 11 each have a downlink reference signal generation unit and an uplink control information extraction unit. The downlink subframe generation unit 1104 has a PDCCH order generation unit 1105. Furthermore, the uplink subframe processing unit 1110 has a preamble sequence extraction unit 1111. Furthermore, the control unit 1102, although not illustrated in FIG. 11, has a transmission control unit and a transmit power control unit for a downlink signal and/or downlink transmission. The transmit power control unit performs configuration of the transmit power for the downlink transmission (more precisely, the transmission of the PDSCH/PDCCH/CRS/DM-RS/URS/CSI-RS and the like). The transmission control unit performs transmission control of the downlink signal based on the transmit power that is configured in the transmit power control unit and on information relating to the transmission control, which is output by the higher layer 1101. Based on the control information that is output from the transmission control unit and the transmit power control unit, the downlink subframe generation unit 1104 performs mapping to a resource for the downlink signal and performs transmission. Moreover, at this point, a constitution that includes one OFDM signal transmission unit 1106 and one transmit antenna 1107 is illustrated, but in a case where the downlink subframe is transmitted using multiple antenna ports, a constitution that includes multiple OFDM signal transmission units 1106 and multiple transmit antennas 1107 may be employed. Moreover, in a case where the uplink subframe is received using multiple antenna ports, a constitution that includes multiple SC-FDMA signal reception units 1109 and multiple receive antennas 1108 may be employed.

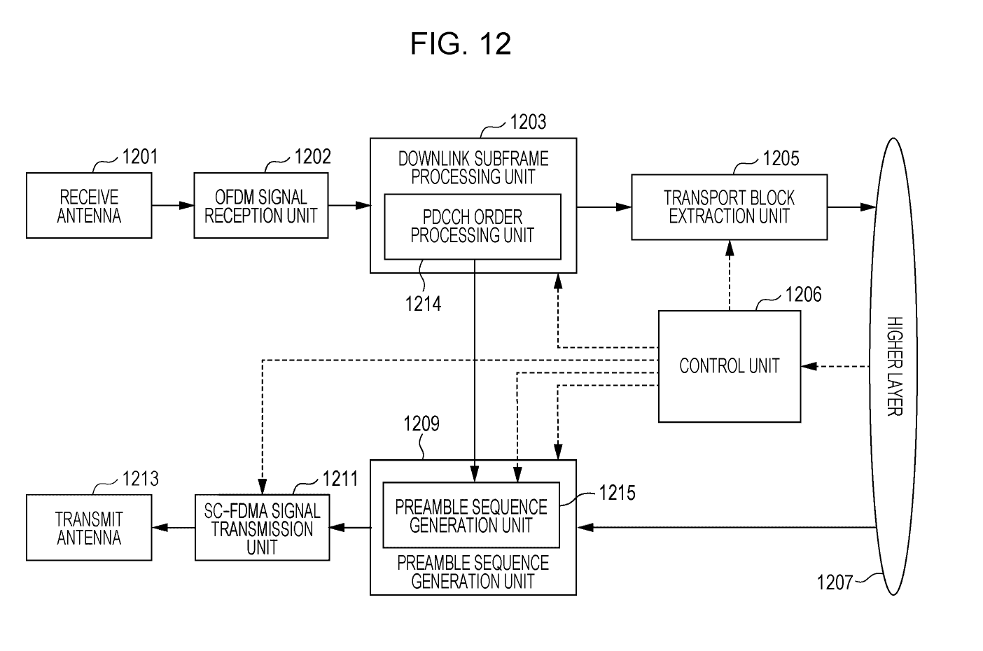

FIG. 12 is a schematic diagram illustrating an example of a block constitution of the terminal apparatus 1 according to the present embodiment. The terminal apparatus 1 has a receive antenna (a terminal receive antenna) 1201, an OFDM signal reception unit (a downlink reception unit) 1202, a downlink subframe processing unit 1203, a transport block extraction unit (a DL-SCH transport block extraction unit or a DL-SCH data extraction unit) 1205, a control unit (a terminal control unit) 1206, a higher layer (a higher layer control information acquisition unit) 1207, an uplink subframe generation unit 1209, an SC-FDMA signal transmission unit (a preamble transmission unit) 1211, and a transmit antenna (a terminal transmission antenna) 1213. The downlink subframe processing unit 1203 has a PDCCH order processing unit 1214. Furthermore, the uplink subframe generation unit 1209 has a preamble sequence generation unit (a random access procedure processing unit) 1215. Because each apparatus, such as a receive antenna is the same as that which is described with reference to FIG. 6, a detailed description thereof is omitted. Furthermore, although not illustrated in FIG. 12, a terminal apparatus in FIG. 12 has a downlink reference signal extraction unit or a channel state measurement unit, and an uplink control information generation unit. Furthermore, the control unit 1206, although not illustrated in FIG. 12, has a transmission control unit and a transmit power control unit for an uplink signal and/or uplink transmission. The transmit power control unit performs configuration of the transmit power for the uplink transmission (more precisely, the transmission of the PUSCH/PUCCH/DM-RS/SRS/PRACH and the like). The transmission control unit performs transmission control of the uplink signal based on the transmit power that is configured in the transmit power control unit and on information relating to the transmission control, which is included in the DL-SCH transport block. Based on the control information that is output from the transmission control unit and the transmit power control unit, the uplink subframe generation unit 1209 performs mapping to a resource for the uplink signal and performs transmission. Moreover, at this point, a constitution that includes one SC-FDMA signal transmission unit 1211 and one transmit antenna 1213 is illustrated, but in a case where the uplink subframe is transmitted using multiple antenna ports, a constitution that includes multiple SC-FDMA signal transmission units 1211 and multiple transmit antennas 1213 may be employed. Moreover, in a case where the downlink subframe is received using multiple antenna ports, a constitution that includes multiple OFDM signal reception units 1202 and multiple receive antennas 1201 may be employed.

An interaction mode between a physical layer (an L1 layer) and a higher layer (an L2/L3 layer or a MAC/RRC layer) of the terminal apparatus 1 pertaining to the random access procedure is described. Through the control unit 1206, the higher layer 1207 instructs the physical layers (more precisely, the uplink subframe generation unit 1209, the preamble sequence generation unit 1215, the SC-FDMA signal transmission unit 1211, and the transmit antenna 1213) to perform the random access preamble. The preamble sequence generation unit 1215, when instructed to do so, generates the preamble sequence and maps the preamble sequence to a PRACH resource, based on the higher layer parameter, and transmits the random access preamble through the SC-FDMA signal transmission unit 1211 and the transmit antenna 1213. After the random access preamble is transmitted, in a case where the random access preamble is received from the received DL-SCH transport block in the transport block extraction unit 1205, this is regarded as the ACK (the random access preamble is regarded as succeeding), and information to that effect (a result of the determination) is output from the transport block extraction unit 1205 to the higher layer 1207. In a case where such information is received, the higher layer 1207 provides an instruction to instruct an RRC connection request. In a case where the random access response is not received in the transport block extraction unit 1205, this is regarded as DTX reception, and information to that effect (a result of the determination) is output to the higher layer 1207. When receiving such information, the higher layer 1207 instructs the physical layer to transmit the random access preamble.

A flow in the random access procedure is described with reference to FIGS. 11 and 12. Through the control unit 1102, the higher layer 1101 of the base station apparatus instructs the physical layers (the downlink subframe generation unit 1104, the OFDM signal transmission unit 1106, and the transmit antenna 1107) to transmit system information including information relating to a parameter indispensable for the PRACH transmission, or a higher layer signal such as a dedicated signal. In a case where the random access procedure is started, through the control unit 1206, the higher layer 1207 of the terminal apparatus provides an instruction to transmit the random access procedure. At that time, the preamble sequence is generated in the preamble sequence generation unit 1215, based on the received parameter. The preamble sequence is mapped to the PRACH resource, the transmit power for the PRACH is set, and the PRACH is transmitted. In a case where the detection of the preamble sequence succeeds in the preamble sequence extraction unit 1111, a result of the determination (for example, the ACK) is output to the higher layer 1101 through the control unit 1102. The higher layer 1101 receives the result of the determination, and instructs the RAR generation unit 1103 to generate the random access response corresponding to the random sequence. The random access response is generated in the RAR generation unit 1103, the response is allocated to the DL-SCH transport block, and the PDSCH to which the DL-SCH transport block is mapped is transmitted. In a case where the detection of the preamble sequence does not succeed in the preamble sequence extraction unit 1111, subsequent processing is not performed. More precisely, processing that allocates the random access response to the DL-SCH transport block is not performed. In a case where the random access procedure is started by the PDCCH order, through the control unit 1102, the higher layer 1101 instructs the PDCCH order generation unit 1105 to generate the downlink control information format of the PDCCH order. Additionally, in a case where the downlink control information format of the PDCCH order, mapping to a resource for the PDCCH is performed and transmission is performed. In a case where the downlink control information format of the PDCCH order is received in the downlink subframe processing unit 1203, the terminal apparatus outputs information to that effect to the PDCCH order processing unit 1214. The preamble sequence is generated based on the control information that is included in the PDCCH order and on the higher layer parameter, the mapping to the PRACH resource, and the PRACH is transmitted.

In the case where multiple CGs are configured, through the control unit 1206, the higher layer 1207 provides an instruction to change a timing at which the PRACH is transmitted after receiving the PDCCH order, a timing at which the PRACH in a new preamble sequence is transmitted after the reception of the random access response succeeds/fails, and/or a timing at which the UL-SCH transport block is transmitted after the reception of the random access response succeeds/fails.

In a case where multiple CGs are configured as in the second embodiment, although, due to a change from transmission timing of the PRACH in the related art, the overlapping with the PUSCH/PUCCH transmission occurs in different CGs that are synchronous and asynchronous, the power can be preferentially allocated to the PRACH transmission.

### Third Embodiment

Next, a third embodiment is described. According to a third embodiment, in a case where the transmission of the PRACH (the preamble) is requested by the higher layer, if a request for the PRACH transmission is assumed to be triggered by the higher layer signal or the PDCCH order, the terminal apparatus for which multiple CGs are configured allocates the transmit power to the PRACH transmission in the subframe i in a certain serving cell (here, the first serving cell that belongs to the first CG) that belongs to a certain CG. At that time, if sufficient time (the sufficient number of subframes) is available between triggering and transmitting the request for the PRACH transmission, although the transmission of the uplink signal (for example, the PUSCH or the PUCCH) for a serving cell (here, the second serving cell that belongs to the second CG) that belongs to another CG occurs, the power is preferentially allocated to the PRACH. When the transmit power for the PRACH at that time is assumed to be P_{PRACH}(i), P_{PRACH}(i) is a minimum value between the power that is requested for the PRACH and P_{CMAX, c} (c is the first serving cell). In a case where, in the second serving cell, the PUSCH/PUCCH transmission that overlaps the PRACH transmission occurs, the power that is available for the allocation to the PUSCH/PUCCH transmission is P_{CMAX}−P_{PRACH}(i). In a case where P_{CMAX}−P_{PRACH}(i) is sufficiently smaller than a minimum guarantee power for the second CG, transmission processing for uplink signal transmission may not be performed in a serving cell that belongs to the second CG In a case where, for the subframe i, overlapping occurs between a subframe j and a subframe j+1 in the serving cell that belongs to the second CG, the power (the residual power) available for the allocation to the PUSCH/PUCCH transmission in each subframe is P_{CMAX}−P_{PRACH}(i). In a case where a transmit power P_{PRACH}(i) for the PRACH transmission in the subframe i in the first serving cell in the first CG is smaller a minimum guarantee power P_{MCG}, P_{SCG} that is configured for each CG, the power (the residual power) that is available for the PUSCH/PUCCH transmission may be assumed to be P_{CMAX}−P_{SCG} for the serving cell that belongs to the MCG to PUSCH/PUCCH transmission, and may be assumed to be P_{CMAX}−P_{MCG} for the serving cell that belongs to the SCG For example, in a case where a value of the transmit power P_{PRACH}(i) for the PRACH in the serving cell that belongs to the MCG is smaller than a value of P_{MCG}, the residual power that is available for the allocation to the PUSCH/PUCCH in the serving cell that belongs to the SCG, which overlaps the PRACH transmission is P_{CMAX}−P_{MCG}. More precisely, the transmit power for the PUSCH/PUCCH as that time is configured based on a minimum value between the power that is requested for the PUSCH/PUCCH transmission and P_{CMAX}−P_{MCG}. It can be said that this is true in a case where the MCG and the SCG are reversed.

At this point, it can be said that the subframe j in the second serving cell that belongs to the second CG also overlaps the subframe i−1 in the first serving cell that belongs to the first CG Furthermore, it can be said that the subframe j+1 in the second serving cell that belongs to the second CG also overlaps the subframe i+1 in the first serving cell that belongs to the first CG In a case where the PUSCH/PUCCH transmission for the first serving cell occurs in the subframe i−1 and the subframe i+1, if a maximum value of the power that is available for the transmission to the PUSCH/PUCCH transmission is assumed to be P_{PRACH}(i), the power for the PUSCH/PUCCH transmission can be allocated without considering the power allocation to another CG More precisely, in a case where multiple CGs are configured and the PRACH transmission (the preamble transmission) is triggered in the subframe i, a maximum value of the transmit power for the PUSCH/PUCCH transmission in the subframe i−1 and/or the subframe i+1 is changed from P_{CMAX, c} (more precisely, P_{CMAX, c} (i−1) or P_{CMAX, c} (i+1)) to P_{PRACH}(i). At that time, when it comes to a maximum value of the transmit power for the SRS transmission in the subframe i+1, in a case where the PUSCH/PUCCH transmission occurs in the same subframe, the maximum value may be changed from P_{CMAX, c} to P_{PRACH}(i).

When it comes to the SRS for the same serving cell as in the case of the PRACH transmission, in a case where the communication is available in the same subframe as in the case of the PRACH, if a maximum value P_{PRACH}(i) of the power that is available for the transmission to the SRS transmission, the SRS transmission is possible.

According to the third embodiment, in a case where the PRACH transmission occurs in the subframe i in a serving cell that belongs to a certain CG and the PRACH transmission does not occur in the subframe j and the subframe j+1 (a subframe that overlaps the subframe i) in a serving cell that belongs to at least another CG, the transmit power for the PUSCH/PUCCH/SRS transmission in the subframe i−1, the subframe i, and the subframe i+1 is assumed to be a minimum value between the power that is requested for the PUSCH/PUCCH/SRS transmission and P_{PRACH}(i), and thus the power can be allocated to the PUSCH/PUCCH/SRS transmission without depending on whether or not the transmission of the uplink signal for a serving cell that belongs to another CG overlaps, more precisely, without depending on priority levels of the CGs and/or the Physical Uplink Channels.

According to the third embodiment, in a case where the power is preferentially allocated to the PRACH transmission in a certain CG, the power in another CG is configured for the different CG, considering the power for the PRACH transmission. In a case where, when it comes to subframes for the PRACH transmission, two subframes overlap, it is possible that the power which is preferentially allocated to the PRACH transmission is configured, as the residual power, for subframes in a certain CG, among which the two subframes overlap. If P_{CMAX} is not exceeded, because it is possible that the terminal apparatus transmits multiple Physical Uplink Channels at the same time, in a case where the PRACH transmission occurs in a certain subframe in a certain CG, it is preferable that, for the transmission of another Physical Uplink Channel in subframes that immediately precede and immediately follow the certain subframe, configuration is performed in such a manner that the transmit power for the PRACH is not exceeded.

According to the third embodiment, in a case where the PRACH transmission occurs in the subframe i in a serving cell that belongs to a certain CG and the PRACH transmission occurs in the subframe j and/or the subframe j+1 (a subframe that overlaps the subframe i) in a serving cell that belongs to another CG, it is determined which PRACH transmission the power is preferentially allocated to, according to the priority levels of the CGs. According to a result of the determination, the power allocation to Physical Uplink Channels (for example, the PUSCH, PUCCH, and the SRS) other than the PRACH for subframes that immediately precede and immediately follow a PRACH transmission subframe in the same serving cell that belongs to the same CG, and for the same subframe may also be determined. At this point, if the PRACH transmission subframe is assumed to be the subframe i, the preceding and following subframes are the subframe i−1 and the subframe i+1.

In a case where the PUSCH/PUCCH transmission occurs for the same serving cell in the same subframe, it is possible that P_{PRACH}(i) is configured for the SRS transmission in the subframe i+1, as the power that is available for the allocation. If in the case of only the SRS transmission, the power that is available for the SRS transmission is configured according to a priority level of the uplink signal in the subframe j+2 in a serving cell that belongs to another CG.

According to the third embodiment, in a case where, for the terminal apparatus, the minimum guarantee power for each CG is not configured and/or multiple CGs are not configured, a maximum value or a threshold of a transmit power for the transmission of each Physical Uplink Channel is configured without being based on the transmit power for the PRACH. More precisely, in the case where, for the terminal apparatus, the minimum guarantee power for each CG is not configured and/or multiple CGs are not configured, the maximum value or the threshold of the transmit power for the transmission of each Physical Uplink Channel is configured to be P_{CMAX} or P_{CMAX, c} in each subframe. The terminal apparatus according to the third embodiment replaces the maximum value of the threshold of the transmit power for the transmission of each Physical Uplink Channel, according to a condition.

According to the third embodiment, with a value of the transmit power P_{PRACH}(i) for the PRACH transmission in the subframe i in the first serving cell that belongs to the first CG, the transmit power for the second serving cell that belongs to the second CG, which overlaps the subframe i, is configured based on any one of P_{CMAX}−P_{CG#1} and P_{CMAX}−P_{PRACH}(i). At this point, P_{CG#1} is a minimum guarantee power for the first CG.

In a case where the PRACH transmission is requested using the higher layer signal, a base station apparatus according to the third embodiment may perform reception processing in such a manner that P_{PRACH}(i) is not exceeded, with respect to the PUSCH/PUCCH transmission and/or the SRS transmission in subframes (for example, the subframe i−1 and the subframe i+1) that immediately precede and immediately follow a subframe (for example, the subframe i) in which the PRACH is transmitted. In a CG that is different from a CG in which the PRACH is transmitted, the reception processing may be performed in such a manner that P_{CMAX}−P_{PRACH}(i) is not exceeded.

According to the third embodiment, in a case where the power is preferentially allocated to the PRACH transmission, the power for the PUSCH/PUCCH transmission and the SRS transmission that occur in subframes that immediately precede and immediately follow the same serving cell in the same CG can be secured.

Moreover, according to the embodiments described above, the power value that is requested for each PUSCH transmission is described as being calculated based on the parameter that is configured by the higher layer, the adjustment value that is determined by the number of PRBs which are allocated, by the resource assignment, for the PUSCH transmission, the downlink path loss and the coefficient by which the downlink path loss is multiplied, the adjustment value that is determined by the parameter which indicates the offset of the MCS, which is applied to the UCI, the value that is based on the TPC command, or the like. Furthermore, the power value that is requested for each PUCCH transmission is described as being calculated based on the parameter that is configured by the higher layer, the downlink path loss, the adjustment value that is determined by the UCI which is transmitted on the PUCCH, the adjustment value that is determined by the PUCCH format, the adjustment value that is determined by the number of antenna ports which are used for the PUCCH transmission, the value that is based on the TPC command, or the like. However, no limitation to this is imposed. An upper limit value can be provided to the power value that is requested, the smaller of values, that is, a value that is based on the parameter described above and an upper limit value (for example, P_{CMAX, c} that is the maximum output power value in the serving cell c) can be used as the power value that is requested.

Moreover, according to the embodiments described above, the case where the serving cells are grouped in the connectivity groups is described, but no limitation to this is imposed. For example, in multiple serving cells, only downlink signals can be grouped, and only uplink signals can be grouped. In this case, the connectivity identifier is configured for the downlink signal or the uplink signal. Furthermore, the downlink signals and the uplink signals can be grouped in a dedicated manner. In this case, the connectivity identifiers are configured for the downlink signal or the uplink signal, respectively, in a dedicated manner. Alternatively, the downlink component carriers can be grouped, and the uplink component carriers can be grouped. In this case, the connectivity identifiers are configured for the component carriers, respectively, in a dedicated manner.

Furthermore, according to each embodiment described above, the descriptions are provided using the connectivity group, but there is no need to necessarily stipulate a set of serving cells that are provided by the same base station apparatus (transmission points), with the connectivity group. Instead of the connectivity group, the set of serving cells can be stipulated using the connectivity identifier or the cell index. For example, in a case where the set of serving cells is stipulated with the connectivity identifier, in other words, the connectivity group according to each embodiment described above can be said to be a set of serving cells that have a value of the same connectivity identifier. Alternatively, in a case where the set of serving cells is stipulated with the cell index, in other words, the connectivity group according to each embodiment described above can be said to be a set of serving cells, whose cell index values are prescribed values (fall within a prescribed range).

Furthermore, according to each embodiment described above, the descriptions are provided using the term “primary cell” or “PS cell” but these terms do not necessarily need to be used. For example, the primary cell according to each embodiment described above can be referred to as a master cell, and the PS cell according to each embodiment described above can be referred to as a primary cell.

A program running on the base station apparatus 2-1 or the base station apparatus 2-2, and the terminal apparatus 1 according to the present invention may be a program (a program for causing a computer to operate) that controls a Central Processing Unit (CPU) and the like in such a manner as to realize the functions according to the embodiments of the present invention, which is described above. Then, pieces of information that are handled in the apparatuses are temporarily accumulated in a Random Access Memory (RAM) while being processed. Thereafter, the pieces of information are stored in various types of ROMs such as a Flash Read Only Memory (ROM), or a Hard Disk Drive (HDD) and, if need arises, are read by the CPU to be modified or rewritten.

Moreover, a portion of each of the terminal apparatus 1 and the base station apparatus 2-1 or the base station apparatus 2-2 according to the embodiments, which are described above, may be realized by the computer. In that case, this one portion may be realized by recording a program for realizing such control functions on a computer-readable recording medium and causing a computer system to read the program stored on the recording medium for execution.

Moreover, the “computer system” here is assumed to be a computer system that is built into the terminal apparatus 1, or the base station apparatus 2-1 or the base station apparatus 2-2 and to include an OS or hardware components such as a peripheral apparatus. Furthermore, the “computer-readable recording medium” refers to a portable medium, such as a flexible disk, a magneto-optical disk, a ROM, and a CD-ROM, and a storage apparatus, such as a hard disk, that is built into the computer system.

Moreover, the “computer-readable recording media” may include a medium that dynamically retains the program for a short period of time, such as a communication line that is available when transmitting the program over a network such as the Internet or over a communication network such as a telephone network, and a medium that retains the program for a fixed period of time, such as a volatile memory within the computer system, which functions as a server or a client in a case where the program is retained dynamically for a short period of time. Furthermore, the program may be one for realizing some of the functions described above and additionally may be one that can realize the functions described above in combination with a program that is already recorded on the computer system.

Furthermore, the base station apparatus 2-1 or the base station apparatus 2-2 according to the embodiments, which are described above, can be realized as an aggregation (an apparatus group) that is constituted from multiple apparatuses. Each of the apparatuses that constitute the apparatus group may be equipped with some portions or all portions of each function of, or some portions or all portions of each functional block of the base station apparatus 2-1 or the base station apparatus 2-2 according to the embodiments, which are described above. The apparatus group itself may have each general function of or each general functional block of the base station apparatus 2-1 or the base station apparatus 2-2. Furthermore, the terminal apparatus 1 according to the embodiments, which are described above, is also capable of communicating with the base station apparatus as an aggregation.

Furthermore, the base station apparatus 2-1 or the base station apparatus 2-2 according to the embodiments, which are described above, may be Evolved Universal Terrestrial Radio Access Network (EUTRAN). Furthermore, the base station apparatus 2-1 or the base station apparatus 2-2 according to the embodiments, which are described above, may have some portions or all portions of a function of a node that is at a higher level than an eNodeB.

Furthermore, some portions or all portions of each of the terminal apparatus 1, and the base station apparatus 2-1 or the base station apparatus 2-2 according to the embodiments, which are described above, may be realized as an LSI that is a typical integrated circuit and may be realized as a chip set. Each functional block of the terminal apparatus 1, and the base station apparatus 2-1 or the base station apparatus 2-2 may be individually realized into a chip, and some or all of the functional blocks may be integrated into a chip. Furthermore, a circuit integration technique is not limited to the LSI, and an integrated circuit for the functional block may be realized as a dedicated circuit or a general-purpose processor. Furthermore, if with advances in semiconductor technology, a circuit integration technology for a circuit with which an LSI is replaced will appear, it is also possible that an integrated circuit to which such a technology applies is used.

Furthermore, according to the embodiments, as described above, a cellular mobile station apparatus is described as one example of a terminal apparatus or a communication apparatus, but the present invention is not limited to this, and can be applied also to a terminal apparatus or a communication apparatus, such as a fixed-type electronic apparatus that is installed indoors or outdoors, or a stationary-type electronic apparatus, for example, an AV apparatus, a kitchen apparatus, a cleaning or washing machine, an air conditioner, office equipment, a vending machine, and other household apparatuses.

The embodiments of the invention are described in detail above referring to the drawings, but the specific constitution is not limited to the embodiments and also includes an amendment to a design and the like that fall within the scope that does not depart from the gist of the present invention. Furthermore, various modifications are possible within the scope of the present invention defined by claims, and embodiments that are implemented by suitably combining technical means that are disclosed according to different embodiments also fall within the technical scope of the present invention. Furthermore, a constitution in which a constituent element that achieves the same effect is substituted for the one that is described above according to each embodiment described above also falls within the technical scope of the present invention.

Moreover, the following invention has the following features.

(1) According to an aspect of the present invention, there is provided a terminal apparatus that communicates with a base station apparatus, includes a control unit that determines a transmit power that is available for application in a first Cell Group (CG), by performing comparison with a first upper limit value and based on the smaller of the transmit power and the first upper limit value, in a case where transmission in a subframe i₁ in the first CG overlaps transmission in subframes i₂−1 and i₂ in a second CG, in which the first upper limit value includes a maximum output power among at least subframes that overlap.

(2) In the terminal apparatus according to the aspect of the present invention, which is the terminal apparatus described above, the first upper limit value is configured based on a transmit power for a Physical Random Access Channel (PRACH), in a case where transmission of the PRACH overlaps in the subframe i₁.

(3) In the terminal apparatus according to the aspect of the present invention, which is the terminal apparatus described above, the first upper limit value is configured based on a transmit power for the PRACH, in a case where the transmission of the PRACH overlaps in the subframe i₂ and preparation for the transmission of the PRACH is completed in a subframe that at least immediately precedes the subframe i₂.

(4) According to an aspect of the present invention, there is provided a method in a terminal apparatus that communicates with a base station apparatus, includes a step of determining a transmit power that is available for application in a first Cell Group (CG), by performing comparison with a first upper limit value and based on the smaller of the transmit power and the first upper limit value, in a case where transmission in the subframe i₁ in the first CG overlaps transmission in subframes i₂−1 and i₂ in a second CG, in which the first upper limit value includes a maximum output power among at least subframes that overlap.

(5) The method according to the aspect of the present invention, which is the method described above, further includes a step of configuring the first upper limit value based on a transmit power for a Physical Random Access Channel (PRACH), in a case where transmission of the PRACH overlaps in the subframe i₁.

(6) The method according to the aspect of the present invention, which is the method described above, further includes a step of configuring the first upper limit value based on a transmit power for the PRACH, in a case where the transmission of the PRACH overlaps in the subframe i₂ and preparation for the transmission of the PRACH is completed in a subframe that at least immediately precedes the subframe i₂.

(7) According to an aspect of the present invention, there is provided a base station apparatus that communicates with a terminal apparatus, includes a transmission unit that transmits a configuration of a second Cell Group (CG) using a higher layer signal, in which the configuration includes a parameter relating to a maximum output power for the second CG.

(8) According to an aspect of the present invention, there is provided a method in a base station apparatus that communicates with a terminal apparatus, includes a step of transmitting a configuration of a second Cell Group (CG) using a higher layer signal, in which the configuration includes a parameter relating to a maximum output power for the second CG.

(9) According to an aspect of the present invention, there is provided a terminal apparatus that communicates with a base station apparatus, includes a transmit power control unit that configures a transmit power for a Physical Random Access Channel based on a minimum value between a power that is requested for the Physical Random Access Channel and a maximum output power, if the Physical Random Access Channel is assumed to be transmitted in a subframe n, in which the transmit power control unit configures a transmit power for a Physical Uplink Shared Channel based on a minimum value between a power that is requested for the Physical Uplink Shared Channel and a transmit power for the Physical Random Access Channel in the subframe n, if transmission of the Physical Uplink Shared Channel occurs in a subframe n−1 in a serving cell that belongs to the same cell group as in the case of the Physical Random Access Channel, in a case where multiple cell groups are configured, and in which the transmit power control unit configures the transmit power for the Physical Uplink Shared Channel based on a minimum value between the power that is requested for the Physical Uplink Shared Channel and a maximum output power for the serving cell in the subframe n−1, if the transmission of the Physical Uplink Shared Channel occurs in the subframe n−1 in the same serving cell as in the case of the Physical Random Access Channel, in a case where the multiple cell groups are not configured.

(10) In the terminal apparatus according to the aspect of the present invention, which is the method described above, the transmit power control unit configures a transmit power for a Physical Uplink Shared Channel based on a minimum value between a power that is requested for the Physical Uplink Shared Channel and a transmit power for the Physical Random Access Channel in the subframe n, if transmission of the Physical Uplink Shared Channel occurs in a subframe n+1 in a serving cell that belongs to the same cell group as in the case of the Physical Random Access Channel, in a case where multiple cell groups are configured, and the transmit power control unit configures the transmit power for the Physical Uplink Shared Channel based on a minimum value between the power that is requested for the Physical Uplink Shared Channel and a maximum output power for the serving cell in the subframe n+1, if the transmission of the Physical Uplink Shared Channel occurs in the subframe n+1 in the same serving cell as in the case of the Physical Random Access Channel, in a case where the multiple cell groups are not configured.

(11) According to an aspect of the present invention, there is provided a method in a terminal apparatus that communicates with a base station apparatus, includes a step of configuring a transmit power for a Physical Random Access Channel based on a minimum value between a power that is requested for the Physical Random Access Channel and a maximum output power, if the Physical Random Access Channel is assumed to be transmitted in a subframe n; a step of configuring a transmit power for a Physical Uplink Shared Channel based on a minimum value between a power that is requested for the Physical Uplink Shared Channel and a transmit power for the Physical Random Access Channel in the subframe n, if transmission of the Physical Uplink Shared Channel occurs in a subframe n−1 in a serving cell that belongs to the same cell group as in the case of the Physical Random Access Channel, in a case where multiple cell groups are configured; and a step of configuring the transmit power for the Physical Uplink Shared Channel based on a minimum value between the power that is requested for the Physical Uplink Shared Channel and a maximum output power for the serving cell in the subframe n−1, if the transmission of the Physical Uplink Shared Channel occurs in the subframe n−1 in the same serving cell as in the case of the Physical Random Access Channel, in a case where the multiple cell groups are not configured.

(12) The method according to the aspect of the present invention, which is the method described above, further including: a step of configuring a transmit power for a Physical Uplink Shared Channel based on a minimum value between a power that is requested for the Physical Uplink Shared Channel and a transmit power for the Physical Random Access Channel in the subframe n, if transmission of the Physical Uplink Shared Channel occurs in a subframe n+1 in a serving cell that belongs to the same cell group as in the case of the Physical Random Access Channel, in a case where multiple cell groups are configured; and a step of configuring the transmit power for the Physical Uplink Shared Channel based on a minimum value between the power that is requested for the Physical Uplink Shared Channel and a maximum output power for the serving cell in the subframe n+1, if the transmission of the Physical Uplink Shared Channel occurs in the subframe n+1 in the same serving cell as in the case of the Physical Random Access Channel, in a case where the multiple cell groups are not configured.

(13) The base station apparatus according to the aspect of the present invention, which is the base station apparatus that communicates with a terminal apparatus, includes a reception unit that performs reception processing in such a manner that the transmit power for the Physical Uplink Share Channel in subframes that at least immediately precedes and immediately follows a subframe in which the Physical Random Access Channel in the same serving cell that belongs to the same cell group is transmitted does not exceed the transmit power for the Physical Random Access Channel in a case where multiple cell groups are configured for the terminal apparatus and a request for transmission for the Physical Random Access Channel is instructed by a higher layer signal.

(14) The method according to the aspect of the present invention, which is the method in a base station apparatus that communicates with a terminal apparatus, further includes a step of performing reception processing in such a manner that the transmit power for the Physical Uplink Share Channel in subframes that at least immediately precedes and immediately follows a subframe in which the Physical Random Access Channel in the same serving cell that belongs to the same cell group is transmitted does not exceed the transmit power for the Physical Random Access Channel in a case where multiple cell groups are configured for the terminal apparatus and a request for transmission for the Physical Random Access Channel is instructed by a higher layer signal.

### INDUSTRIAL APPLICABILITY

As described above, a terminal apparatus, a base station apparatus, and a method according to the present invention are useful in improving transfer efficiency in a wireless communication system.

### DESCRIPTION OF REFERENCE NUMERALS

501, 1101 HIGHER LAYER
502, 1102 CONTROL UNIT
503 CODEWORD GENERATION UNIT
504, 1104 DOWNLINK SUBFRAME GENERATION UNIT
505 DOWNLINK REFERENCE SIGNAL GENERATION UNIT
506, 1106 OFDM SIGNAL TRANSMISSION UNIT
507, 1107 TRANSMIT ANTENNA
508, 1108 RECEIVE ANTENNA
509, 1109 SC-FDMA SIGNAL RECEPTION UNIT
510, 1110 UPLINK SUBFRAME PROCESSING UNIT
511 UPLINK CONTROL INFORMATION EXTRACTION UNIT
601, 1201 RECEIVE ANTENNA
602, 1202 OFDM SIGNAL RECEPTION UNIT
603, 1203 DOWNLINK SUBFRAME PROCESSING UNIT
604 DOWNLINK REFERENCE SIGNAL EXTRACTION UNIT
605, 1205 TRANSPORT BLOCK EXTRACTION UNIT
606, 1206 CONTROL UNIT
607, 1207 HIGHER LAYER
608 CHANNEL STATE MEASUREMENT UNIT
609, 1209 UPLINK SUBFRAME GENERATION UNIT
610 UPLINK CONTROL INFORMATION GENERATION UNIT
611, 612, 1211 SC-FDMA SIGNAL TRANSMISSION UNIT
613, 614, 1213 TRANSMIT ANTENNA
1103 RAR GENERATION UNIT
1105 PDCCH ORDER GENERATION UNIT
1111 PREAMBLE SEQUENCE EXTRACTION UNIT
1214 PDCCH ORDER PROCESSING UNIT
1215 PREAMBLE SEQUENCE GENERATION UNIT

1. A terminal apparatus configured to communicate with a base station apparatus, the terminal apparatus comprising:
control circuitry configured to determine a transmit power that is available for application in a first Cell Group (CG), by performing comparison with a first upper limit value and based on the smaller of the transmit power and the first upper limit value, in a case where transmission in a subframe i₁ in the first CG overlaps transmission in subframes i₂−1 and i₂ in a second CG,
wherein the first upper limit value includes a maximum output power among at least subframes that overlap.

2. The terminal apparatus according to claim 1,
wherein the first upper limit value is configured based on a transmit power for a Physical Random Access Channel (PRACH), in a case where transmission of the PRACH overlaps in the subframe i₁.

3. The terminal apparatus according to claim 1,
wherein the first upper limit value is configured based on a transmit power for the PRACH, in a case where the transmission of the PRACH overlaps in the subframe i₂ and preparation for the transmission of the PRACH is completed in a subframe that at least immediately precedes the subframe i₂.

4. A method for a terminal apparatus configured to communicate with a base station apparatus, the method comprising:
determining a transmit power that is available for application in a first Cell Group (CG), by performing comparison with a first upper limit value and based on the smaller of the transmit power and the first upper limit value, in a case where transmission in the subframe i₁ in the first CG overlaps transmission in subframes i₂−1 and i₂ in a second CG,
wherein the first upper limit value includes a maximum output power among at least subframes that overlap.

5. The method according to claim 4, further comprising:
configuring the first upper limit value based on a transmit power for a Physical Random Access Channel (PRACH), in a case where transmission of the PRACH overlaps in the subframe i₁.

6. The method according to claim 4, further comprising:
configuring the first upper limit value based on a transmit power for the PRACH, in a case where the transmission of the PRACH overlaps in the subframe i₂ and preparation for the transmission of the PRACH is completed in a subframe that at least immediately precedes the subframe i₂.

7. A base station apparatus configured to communicate with a terminal apparatus, the base station apparatus comprising:
transmission circuitry configured to transmit a configuration of a second Cell Group (CG) using a higher layer signal,
wherein the configuration includes a parameter relating to a maximum output power for the second CG.

8. A method for a base station apparatus configured to communicate with a terminal apparatus, the method comprising:
transmitting a configuration of a second Cell Group (CG) using a higher layer signal,
wherein the configuration includes a parameter relating to a maximum output power for the second CG.
